(19) United States
(12) Patent Application Publication
(10) Pub. No.: US 2024/0049235 A1
(43) Pub. Date: Feb. 8, 2024

(54) METHOD AND DEVICE FOR TRANSMITTING UPLINK CONTROL INFORMATION VIA MULTI-PANEL IN WIRELESS COMMUNICATION SYSTEM

(71) Applicant: Samsung Electronics Co., Ltd., Gyeonggi-do (KR)

(72) Inventors: Seongmok LIM, Gyeonggi-do (KR); Kyoungmin PARK, Gyeonggi-do (KR); Ameha Tsegaye ABEBE, Gyeonggi-do (KR); Youngrok JANG, Gyeonggi-do (KR); Hyoungju JI, Gyeonggi-do (KR); Kyungjun CHOI, Gyeonggi-do (KR)

(21) Appl. No.: 18/361,210

(22) Filed: Jul. 28, 2023

(30) Foreign Application Priority Data
Jul. 29, 2022 (KR) 10-2022-0094660
Dec. 20, 2022 (KR) 10-2022-0179564

(51) Int. Cl. H04W 72/21; H04L 5/00; H04L 1/1867

(52) U.S. Cl. CPC H04W 72/21; H04L 5/0053; H04L 1/1887

(57) ABSTRACT

The disclosure relates to a 5G or 6G communication system for supporting a higher data transmission rate. Specifically, the disclosure provides a method and a device for an uplink transmission procedure in consideration of simultaneous transmission via multiple panels. Methods and devices are provided in which first downlink control information (DCI) scheduling a first physical uplink shared channel (PUSCH) and second DCI scheduling a second PUSCH, are received. The first PUSCH and the second PUSCH are simultaneous transmissions across multi panels (STxMP). Third DCI is received that indicates a physical uplink control channel (PUCCH) that overlaps the first PUSCH and the second PUSCH. A PUSCH is identified, from among the first PUSCH and the second PUSCH, that is associated with a control resource set (CORESET) pool index for the third DCI. Uplink control information (UCI) is transmitted by multiplexing the UCI in the identified PUSCH.

### CROSS-REFERENCE TO RELATED APPLICATION(S)

This application is based on and claims priority under 35 U.S.C. § 119 to Korean Patent Application Nos. 10-2022-0094660 and 10-2022-0179564, filed on Jul. 29, 2022, and Dec. 20, 2022, respectively, in the Korean Intellectual Property Office, the disclosures of which are incorporated herein by reference in their entirety.

### BACKGROUND

### 1. Field

The disclosure relates generally to operations of a terminal and a base station in a wireless communication system (or mobile communication system), and more particularly, to a method for performing simultaneous uplink transmission using multiple panels in a wireless communication system, a method for transmitting uplink control information accordingly, and a device capable of performing the same.

### 2. Description of Related Art

5^{th} Generation (5G) mobile communication technologies define broad frequency bands such that high transmission rates and new services are possible, and can be implemented not only in “Sub 6 GigaHertz (GHz)” bands such as 3.5 GHz, but also in “Above 6 GHz” bands referred to as mmWave, including 28 GHz and 39 GHz. In addition, it has been considered to implement 6^{th} Generation (6G) mobile communication technologies (also referred to as Beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

When 5G mobile communication technologies were being developed, in order to support services and to satisfy performance requirements in connection with enhanced mobile broadband (eIBB), ultra reliable low latency communications (URLLC), and massive machine-type communications (mMTC), there was ongoing standardization regarding beamforming and massive multiple input-multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer-2 (L2) pre-processing, and network slicing for providing a dedicated network specialized to a specific service.

Improvement and performance enhancement of initial 5G mobile communication technologies is ongoing in view of services to be supported by 5G mobile communication technologies. There has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, new radio (NR) user equipment (UE) power saving, non-terrestrial network (NTN), which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is expected that enhanced functions and performances of 5G mobile communication systems and integrated operations of connected devices will be necessary. To this end, new research is expected in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

With the development of communication systems, research on uplink transmission or reception using multiple panels is being conducted and, in particular, a demand for improving uplink control information transmission using multiple panels is increasing.

### SUMMARY

Embodiments provide a device and a method capable of efficiently providing services in a mobile communication system. Embodiments provide a method for simultaneously transmitting multiple uplink channels by using multiple panels in a wireless communication system, and a device for performing the same.

According to an embodiment, a method performed by a terminal in a wireless communication system is provided. The method includes: receiving first downlink control information (DCI); identifying a first physical uplink shared channel (PUSCH) based on the first DCI; receiving a second DCI; identifying a second PUSCH based on the second DCI; receiving a third DCI; identifying a physical uplink control channel (PUCCH) for hybrid automatic repeat request acknowledgement (HARQ-ACK) information based on the third DCI, wherein the PUCCH overlap with the first PUSCH and the second PUSCH; and in case that simultaneous transmissions across multi panels (STxMP) are enabled, identifying a PUSCH, among the first PUSCH and the second PUSCH, for multiplexing uplink control information (UCI) including the HARQ-ACK information, wherein the PUSCH and the PUCCH are associated with same control resource set (CORESET).

According to an embodiment, a method performed by a base station in a wireless communication system is provided. The method includes: transmitting first DCI for a first PUSCH; transmitting a second DCI for a second PUSCH; transmitting a third DCI for a PUCCH for HARQ-ACK information, wherein the PUCCH overlap with the first PUSCH and the second PUSCH; and in case that STxMP are enabled, receiving a PUSCH, among the first PUSCH and the second PUSCH, to which UCI including the HARQ-ACK information is multiplexed, wherein the PUSCH and the PUCCH are associated with same CORESET.

According to an embodiment, a terminal in a wireless communication system is provided. The terminal includes a transceiver and a controller coupled with the transceiver. The controller is configured to: receive first DCI, identify a first PUSCH based on the first DCI, receive a second DCI, identify a second PUSCH based on the second DCI, receive a third DCI, identify a PUCCH for HARQ-ACK information based on the third DCI, wherein the PUCCH overlap with the first PUSCH and the second PUSCH, and in case that STxMP are enabled, identify a PUSCH, among the first PUSCH and the second PUSCH, for multiplexing UCI including the HARQ-ACK information, wherein the PUSCH and the PUCCH are associated with same CORESET.

According to an embodiment, a base station in a wireless communication system is provided. The base station includes a transceiver and a controller coupled with the transceiver. The controller is configured to: transmit first DCI for a first PUSCH, transmit a second DCI for a second PUSCH, transmit a third DCI for a PUCCH for HARQ-ACK information, wherein the PUCCH overlap with the first PUSCH and the second PUSCH, and in case that STxMP are enabled, receive a PUSCH, among the first PUSCH and the second PUSCH, to which UCI including the HARQ-ACK information is multiplexed, wherein the PUSCH and the PUCCH are associated with same CORESET.

### BRIEF DESCRIPTION OF THE DRAWINGS

The above and other aspects, features, and advantages of the disclosure will be more apparent from the following description taken in conjunction with the accompanying drawings, in which:

FIG. 1 is a diagram illustrating a basic structure of a time-frequency domain in a wireless communication system, according to an embodiment;

FIG. 2 is a diagram illustrating a frame, a subframe, and a slot structure in the wireless communication system, according to an embodiment;

FIG. 3 is a diagram illustrating an example of a BWP configuration in the wireless communication system, according to an embodiment;

FIG. 4 shows diagrams illustrating examples of base station beam assignment according to a transmission configuration indicator (TCI) state configuration in the wireless communication system, according to an embodiment;

FIG. 5 shows diagrams illustrating examples of frequency axis resource allocation of a physical downlink shared channel (PDSCH) in the wireless communication system, according to an embodiment;

FIG. 6 is a diagram illustrating an example of time axis resource allocation of a PDSCH in the wireless communication system, according to an embodiment;

FIG. 7 illustrates a procedure for beam configuration and activation of a PDSCH;

FIG. 8 is a diagram illustrating an example of a medium access control (MAC) control element (CE) for PUCCH resource group-based spatial relation activation in the wireless communication system, according to an embodiment;

FIG. 9 is a diagram illustrating an example of PUSCH repetition transmission type B in the wireless communication system, according to an embodiment;

FIG. 10 is a diagram illustrating radio protocol structures of a terminal and a base station in single cell, carrier aggregation, and dual connectivity situations in the wireless communication system, according to an embodiment;

FIG. 11 shows diagrams illustrating examples of an antenna port configuration and resource allocation for cooperative communication in the wireless communication system, according to an embodiment;

FIG. 12 shows diagrams illustrating examples of a DCI configuration for cooperative communication in the wireless communication system, according to an embodiment;

FIG. 13 is a diagram illustrating an Enhanced PDSCH TCI state activation/deactivation MAC-CE structure;

FIG. 14 is a diagram illustrating a radio link monitoring (RLM) reference signal (RS) selection procedure, according to an embodiment;

FIG. 15 is a diagram illustrating a MAC-CE structure for activation and indication of joint TCI state in the wireless communication system, according to an embodiment;

FIG. 16 is a diagram illustrating another MAC-CE structure for activation and indication of a joint TCI state in the wireless communication system, according to an embodiment;

FIG. 17 is a diagram illustrating another MAC-CE structure for activation and indication of a joint TCI state in the wireless communication system, according to an embodiment;

FIG. 18 is a diagram illustrating a MAC-CE structure for activation and indication of a separate TCI state in the wireless communication system, according to an embodiment;

FIG. 19 is a diagram illustrating another MAC-CE structure for activation and indication of a separate TCI state in the wireless communication system, according to an embodiment;

FIG. 20 is a diagram illustrating another MAC-CE structure for activation and indication of a separate TCI state in the wireless communication system, according to an embodiment;

FIG. 21 is a diagram illustrating another MAC-CE structure for activation and indication of a separate TCI state in the wireless communication system, according to an embodiment;

FIG. 22 is a diagram illustrating a MAC-CE structure for joint and separate TCI state activation and indication in the wireless communication system, according to an embodiment;

FIG. 23 is a diagram illustrating another MAC-CE structure for joint and separate TCI state activation and indication in the wireless communication system, according to an embodiment;

FIG. 24 is a diagram for a beam application time that may be considered when an integrated TCI scheme is used in the wireless communication system, according to an embodiment;

FIG. 25 is a diagram illustrating a MAC-CE structure for activation and indication of multiple joint TCI states in the wireless communication system, according to an embodiment;

FIG. 26 is a diagram illustrating a MAC-CE structure for activation and indication of multiple separate TCI states in the wireless communication system, according to an embodiment;

FIG. 27 is a diagram illustrating another MAC-CE structure for activation and indication of multiple separate TCI states in the wireless communication system, according to an embodiment;

FIG. 28 shows diagrams illustrating panels for resource allocation and transmission for uplink transmission in frequency division multiplexing (FDM), spatial division multiplexing (SDM), and single frequency network (SFN) schemes for supporting simultaneous transmission with multiple panels or STxMPs;

FIG. 29 illustrates examples of multiplexing UCI in FDM-based and SDM-based STxMP transmission situations;

FIG. 30 shows diagrams illustrating an example of PUSCHs simultaneously transmitted through multiple panels scheduled via multi-DCI (mDCI) or single-DCI (sDCI) and an example of a scheduled PUSCH and a PUCCH overlapping in the time domain;

FIG. 31 is a diagram illustrating a structure of a terminal in the wireless communication system, according to an embodiment; and

FIG. 32 is a diagram illustrating a structure of a base station in the wireless communication system, according to an embodiment.

### DETAILED DESCRIPTION

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. The terms which will be described below are terms defined in consideration of the functions in the disclosure, and may be different according to users, intentions of the users, or customs. Therefore, the definitions of the terms should be made based on the contents throughout the specification.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. A unit may be constructed either to be stored in an addressable storage medium or to execute one or more processors. Therefore, a unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by a unit may be either combined into a smaller number of elements, or a unit, or divided into a larger number of elements, or a unit. Moreover, the elements and units may be implemented to reproduce one or more CPUs within a device or a security multimedia card. Furthermore, a unit may include one or more processors.

A wireless communication system is advancing to a broadband wireless communication system for providing high-speed and high-quality packet data services using communication standards, such as high-speed packet access (HSPA) of 3GPP, long-term evolution (LTE) (or evolved universal terrestrial radio access (E-UTRA)), LTE-advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a UE (or a mobile station (MS)) transmits data or control signals to a base station (BS) (eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include eMBB communication, mMTC, URLLC, and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things (IoT). Since the IoT provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three 5G services, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the above-described three services.

In the following description, a base station is an entity that allocates resources to terminals, and may be at least one of a gNode B, an eNode B, a Node B, a BS, a wireless access unit, a base station controller, and a node on a network. A terminal may include a UE, an MS, a cellular phone, a smartphone, a computer, or a multimedia system capable of performing communication functions. Herein, a “downlink (DL)” refers to a radio link via which a base station transmits a signal to a terminal, and an “uplink (UL)” refers to a radio link via which a terminal transmits a signal to a base station. Furthermore, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

NR Time-Frequency Resources

Hereinafter, a frame structure of a 5G system is described in more detail with reference to the drawings.

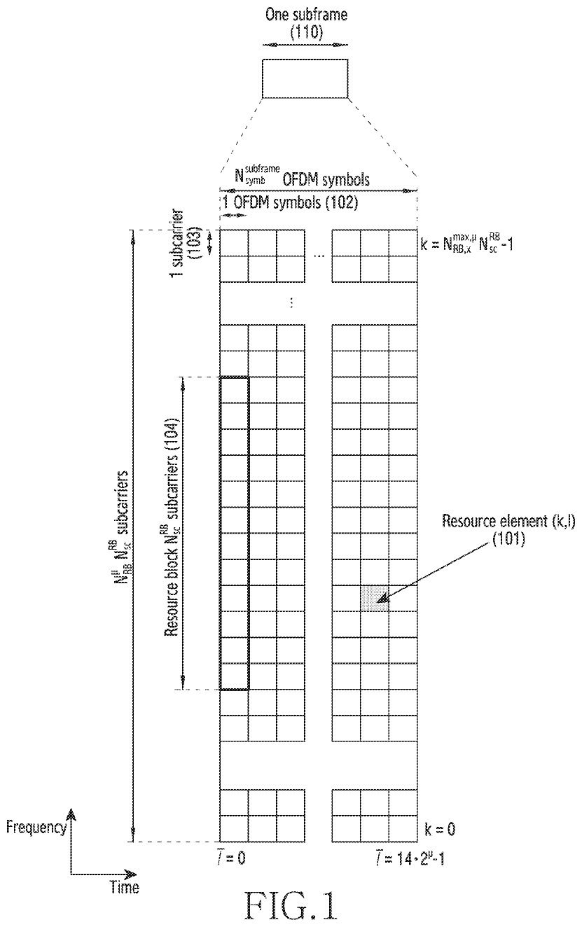

FIG. 1 is a diagram illustrating a basic structure of a time-frequency domain that is a radio resource region in which data or a control channel is transmitted in a 5G system.

In FIG. 1, a horizontal axis represents a time domain, and a vertical axis represents a frequency domain. A basic unit of a resource in the time and frequency domain is a resource element (RE) 101, and may be defined to be 1 OFDM symbol 102 on the time axis and 1 subcarrier 103 on the frequency axis. In the frequency domain, N_{SC}^{RB} (e.g., 12) consecutive REs may constitute one resource block (RB) 104. One subframe 110 on the time axis may include multiple OFDM symbols 102. For example, a length of one subframe may be 1 ms.

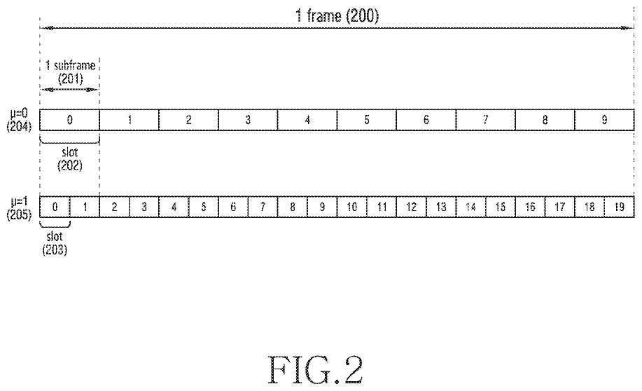

FIG. 2 is a diagram illustrating a frame, a subframe, and a slot structure in the wireless communication system, according to an embodiment.

FIG. 2 illustrates an example of a frame 200, a subframe 201, and a slot 202 structure. One frame 200 may be defined to be 10 ms. One subframe 201 may be defined to be 1 ms, and therefore one frame 200 may include a total of 10 subframes 201. One slot 202 or 203 may be slot defined to be 14 OFDM symbols (that is, the number of symbols per slot (N_{symb}^{slot}=14)). One subframe 201 may include one or multiple slots 202 and 203, the number of slots 202 and 203 per subframe 201 may vary according to a configuration value μ 204 or 205 for a subcarrier spacing. An example of FIG. 2 illustrates a case 204 in which μ=0 and a case 205 in which μ=1, where μ is a subcarrier spacing configuration value. In the case 204 where μ=0, one subframe 201 may include one slot 202, and in the case 205 where μ=1, one subframe 201 may include two slots 203. That is, the number (Nₛₗₒₜ^{subframe,μ}) of slots per subframe may vary according to configuration value μ for a subcarrier spacing, and accordingly, the number (Nₛₗₒₜ^{frame,μ}) of slots per frame may vary. Nₛₗₒₜ^{subframe,μ} And Nₛₗₒₜ^{frame,μ} according to respective subcarrier spacing configurations μ may be defined in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Bandwidth Part (BWP)

A BWP configuration in a 5G communication system is described in greater detail below with reference to the drawings.

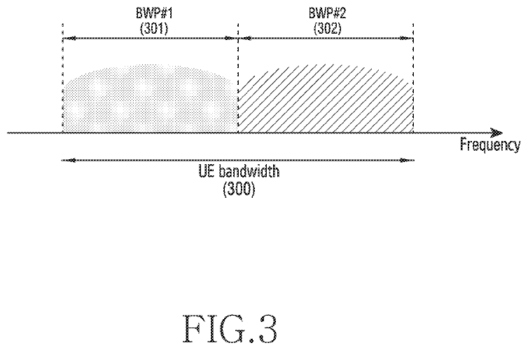

FIG. 3 is a diagram illustrating an example of a BWP configuration in the wireless communication system, according to an embodiment.

FIG. 3 shows an example in which a terminal bandwidth (UE bandwidth) 300 is configured to have two BWPs (i.e., BWP #1 301 and BWP #2 302). A base station may configure one or multiple BWPs for a terminal, and may configure the information for each BWP, as shown in Table 2 below.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, |
| n3, n4, n5}, | |
| cyclicPrefix | ENUMERATED { extended } |
| } | |

The disclosure is not limited to the above example, and in addition to the configuration information, various parameters related to a BWP may be configured for the terminal. The base station may transfer the information to the terminal via higher-layer signaling, for example, radio resource control (RRC) signaling. At least one BWP among the configured one or multiple BWPs may be activated. Whether the configured bandwidth is activated may be semi-statically transferred via RRC signaling or may be dynamically transmitted via DCI, from the base station to the terminal.

According to some embodiments, the base station may configure, for the terminal via a master information block (MIB), an initial BWP for initial access before an RRC connection. More specifically, during initial access, the terminal may receive configuration information for a search space and a control area (CORESET) in which a PDCCH for receiving system information (which may correspond to remaining system information (RMSI) or system information block 1 (SIB1)) required for the initial access may be transmitted via the MIB. Each of the search space and the control area configured via the MIB may be considered to be identifier (identity (ID)) 0. The base station may notify, via the MIB, the terminal of configuration information, such as frequency allocation information, time allocation information, and numerology for control area #0. In addition, the base station may notify, via the MIB, the terminal of configuration information for a monitoring periodicity and monitoring occasion for control area #0, that is, the configuration information for search space #0. The terminal may consider a frequency domain configured to be control area #0, which is acquired from the MIB, as an initial BWP for initial access. In this case, an identity (ID) of the initial BWP may be considered to be 0.

The BWP configuration supported by 5G may be used for various purposes.

If a bandwidth supported by the terminal is smaller than a system bandwidth, this may be supported via the BWP configuration. For example, the base station may configure, for the terminal, a frequency position (configuration information 2) of the BWP, and the terminal may thus transmit or receive data at a specific frequency position within the system bandwidth.

For the purpose of supporting different numerologies, the base station may configure multiple BWPs for the terminal. For example, in order to support data transmission or reception using both a subcarrier spacing of 15 kHz and a subcarrier spacing of 30 kHz for a certain terminal, the base station may configure two BWPs with the subcarrier spacings of 15 kHz and 30 kHz, respectively. Different BWPs may be FDMed, and when data is to be transmitted or received at a specific subcarrier spacing, a BWP configured with the subcarrier spacing may be activated.

For the purpose of reducing power consumption of the terminal, the base station may configure, for the terminal, BWPs having different bandwidth sizes. For example, if the terminal supports a very large bandwidth, for example, a bandwidth of 100 MHz, and always transmits or receives data via the corresponding bandwidth, very large power consumption may occur. In particular, in a situation where there is no traffic, it may be very inefficient, in terms of power consumption, to perform unnecessary monitoring for a downlink control channel with a large bandwidth of 100 MHz. For the purpose of reducing power consumption of the terminal, the base station may configure, for the terminal, a BWP of a relatively small bandwidth, for example, a BWP of 20 MHz. In the situation where there is no traffic, the terminal may perform monitoring in the BWP of 20 MHz, and when data is generated, the terminal may transmit or receive the data by using the BWP of 100 MHz according to an indication of the base station.

In the method of BWP configuration, terminals before an RRC connection may receive configuration information for an initial BWP via an MIB during initial access. More specifically, a terminal may be configured with a control area (i.e., CORESET) for a downlink control channel, through which DCI for scheduling of a SIB may be transmitted, from an MIB of a physical broadcast channel (PBCH). The bandwidth of the control area, which is configured via the MIB, may be considered to be the initial BWP, and the terminal may receive a PDSCH, through which the SIB is transmitted, via the configured initial BWP. In addition to reception of the SIB, the initial BWP may be used for other system information (OSI), paging, and random access.

Change of BWP

When one or more BWPs are configured for the terminal, the base station may indicate the terminal to change (or switch or shift) the BWP, by using a BWP indicator field in DCI. For example, in FIG. 3, if a currently active BWP of the terminal is BWP #1 301, the base station may indicate BWP #2 302 to the terminal by using the BWP indicator in the DCI, and the terminal may switch the BWP to BWP #2 302 indicated using the BWP indicator in the received DCI.

As described above, the DCI-based switching of the BWP may be indicated by the DCI for scheduling of a PDSCH or PUSCH, and therefore when a request for switching a BWP is received, the terminal may need to perform, with ease, transmission or reception of the PDSCH or PUSCH scheduled by the corresponding DCI in the switched BWP. To this end, in the standard, requirements for a delay time (TBWP) required when a BWP is switched are regulated, and may be defined as shown in Table 3 below, for example.

TABLE 3

BWP switch delay TBWP (slots)

| μ | NR Slot length (ms) | Type 1Note 1 | Type 2Note 1 |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for a BWP switch delay time support type 1 or type 2 according to capability of the terminal. The terminal may report a supportable BWP delay time type to the base station.

According to the aforementioned requirements for the BWP switch delay time, when the terminal receives DCI including the BWP switch indicator in slot n, the terminal may complete switching to a new BWP indicated by the BWP switch indicator at a time point no later than slot n+TBWP, and may perform transmission or reception for a data channel scheduled by the corresponding DCI in the switched new BWP. When the base station is to schedule a data channel with a new BWP, time domain resource allocation for the data channel may be determined by considering the BWP switch delay time (TBWP) of the terminal. That is, in a method of determining time domain resource allocation for a data channel when the base station schedules the data channel with a new BWP, scheduling of the data channel may be performed after a BWP switch delay time. Accordingly, the terminal may not expect that DCI indicating BWP switching indicates a slot offset (K0 or K2) value smaller than the TBWP.

If the terminal receives DCI (e.g., DCI format 1_1 or 0_1) indicating BWP switching, the terminal may not perform any transmission or reception during a time interval from a third symbol of a slot in which a PDCCH including the DCI is received to a start point of a slot indicated by a slot offset (K0 or K2) value indicated via a time domain resource allocation indicator field in the DCI. For example, when the terminal receives the DCI indicating BWP switching in slot n, and a slot offset value indicated by the DCI is K, the terminal may not perform any transmission or reception from a third symbol of slot n to a symbol before slot n+K (i.e., the last symbol in slot n+K−1).

PDCCH: Relating to DCI

DCI in the 5G system is described in detail below.

In the 5G system, scheduling information for uplink data (or physical uplink data channel (PUSCH) or downlink data (or physical downlink data channel (PDSCH) is transferred from the base station to the terminal via DCI. The terminal may monitor a fallback DCI format and a non-fallback DCI format for the PUSCH or PDSCH. The fallback DCI format may include a fixed field predefined between the base station and the terminal, and the non-fallback DCI format may include a configurable field.

The DCI may be transmitted on a physical downlink control channel (PDCCH) via channel coding and modulation. A cyclic redundancy check (CRC) is attached to a DCI message payload, and may be scrambled by a radio network temporary identifier (RNTI) corresponding to the identity of the terminal. Different RNTIs may be used according to the purpose of the DCI message, for example, terminal-specific (UE-specific) data transmission, a power control command, a random-access response, or the like. In other words, the RNTI is not transmitted explicitly, but is included in CRC calculation and transmitted. When the DCI message transmitted on the PDCCH is received, the terminal may check the CRC by using an assigned RNTI and may determine, if a CRC check result is correct, that the message is transmitted to the terminal.

For example, DCI for scheduling of a PDSCH for system information (SI) may be scrambled by an SI-RNTI. DCI for scheduling of a PDSCH for a random-access response (RAR) message may be scrambled by an RA-RNTI. DCI for scheduling of a PDSCH for a paging message may be scrambled by a P-RNTI. DCI for notification of a slot format indicator (SFI) may be scrambled by an SFI-RNTI. DCI for notification of a transmit power control (TPC) may be scrambled by a TPC-RNTI. DCI for scheduling of a UE-specific PDSCH or PUSCH may be scrambled by a cell RNTI (C-RNTI).

DCI format 0_0 may be used as fallback DCI for scheduling of a PUSCH, wherein a CRC is scrambled by a C-RNTI. DCI format 0_0 in which the CRC is scrambled by the C-RNTI may include, for example, the information of Table 4 below.

TABLE 4
- Identifier for DCI formats- [1] bit
- Frequency domain resource assignment-[┌log₂(N_{RB}^{UL,BWP}(N_{RB}^{UL,BWP} + 1)/2)┐ ] bits
- Time domain resource assignment- X bits
- Frequency hopping flag - 1 bit.
- Modulation and coding scheme - 5 bits
- New data indicator - 1 bit
- Redundancy version - 2 bits
- HARQ process number - 4 bits
- TPC(transmission power control) command for scheduled PUSCH - [2] bits
- UL/SUL (supplementary UL) indicator - 0 or 1 bit

DCI format 0_1 may be used as non-fallback DCI for scheduling of a PUSCH, wherein a CRC is scrambled by a C-RNTI. DCI format 0_1 in which the CRC is scrambled by the C-RNTI may include, for example, the information of Table 5 below.

```
TABLE 5
  - Carrier indicator-0 or 3 bits
  - UL/SUL indicator-0 or 1 bit
  - Identifier for DCI formats-[1] bits
  - BWP indicator-0, 1 or 2 bits
  - Frequency domain resource assignment
  For resource allocation type 0, ┌N_{RB}^{UL,BWP}/P┐ bits
  For resource allocation type 1, ┌log₂(N_{RB}^{UL,BWP}(N_{RB}^{UL,BWP} + 1)/2)┐ bits
  - Time domain resource assignment-1, 2, 3, or 4 bits
  - VRB(virtual resource block)-to-PRB(physical resource block)
mapping-0 or 1 bit, only for resource allocation type 1.
  0 bit if only resource allocation type 0 is configured;
  1 bit otherwise.
  - Frequency hopping flag-0 or 1 bit, only for resource allocation type 1.
  0 bit if only resource allocation type 0 is configured;
  1 bit otherwise.
  - Modulation and coding scheme-5 bits
  - New data indicator-1 bit
  - Redundancy version-2 bits
  - HARQ process number-4 bits
  - 1st downlink assignment index-1 or 2 bits
  1 bit for semi-static HARQ-ACK codebook;
  2 bits for dynamic HARQ-ACK codebook with single HARQ-ACK
codebook.
  - 2nd downlink assignment index-0 or 2 bits
  2 bits for dynamic HARQ-ACK codebook with two HARQ-ACK sub-
codebooks;
  0 bit otherwise.
  - TPC command for scheduled PUSCH-2 bits
  - SRS resource indicator-
  $⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉$
  bits
  $⌈ {log}_{2} ( {\sum }_{k = 1}^{{L}_{max}} ( \begin{matrix}{N}_{SRS} \\ k\end{matrix} ) ) ⌉$
  bits for non-codebook based PUSCH transmission;
  ┌log₂(N_{SRS})┐ bits for codebook based PUSCH transmission.
  - Precoding information and number of layers-up to 6 bits
  - Antenna ports-up to 5 bits
  - SRS request-2 bits
  - CSI request-0, 1, 2, 3, 4, 5, or 6 bits
  - CBG (code block group) transmission information-0, 2, 4, 6, or 8 bits
  - PTRS-DMRS association-0 or 2 bits.
  - beta_offset indicator-0 or 2 bits
  - DMRS sequence initialization-0 or 1 bit
```

DCI format 1_0 may be used as fallback DCI for scheduling of a PDSCH, where a CRC is scrambled by a C-RNTI. DCI format 1_0 in which the CRC is scrambled by the C-RNTI may include, for example, the information of Table 6 below.

TABLE 6
- Identifier for DCI formats - [1] bit
- Frequency domain resource assignment - [┌log₂(N_{RB}^{DL,BWP}(N_{RB}^{DL,BWP} + 1)/2)┐ ] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- PUCCH resource indicator- 3 bits
- PDSCH-to-HARQ feedback timing indicator- [3] bits

DCI format 1_1 may be used as non-fallback DCI for scheduling of a PDSCH, wherein a CRC is scrambled by a C-RNTI. DCI format 1_1 in which the CRC is scrambled by the C-RNTI may include, for example, the information of Table 7 below.

TABLE 7
- Carrier indicator - 0 or 3 bits
- Identifier for DCI formats - [1] bits
- BWP indicator - 0, 1 or 2 bits
- Frequency domain resource assignment
For resource allocation type 0, ┌N_{RB}^{DL,BWP} / P┐ bits
For resource allocation type 1, ┌log₂(N_{RB}^{DL,BWP}(N_{RB}^{DL,BWP} + 1)/2)┐ bits
- Time domain resource assignment -1, 2, 3, or 4 bits
- VRB-to-PRB mapping - 0 or 1 bit, only for resource allocation type 1.
0 bit if only resource allocation type 0 is configured;
1 bit otherwise.
- PRB bundling size indicator - 0 or 1 bit
- Rate matching indicator - 0, 1, or 2 bits
- ZP CSI-RS trigger - 0, 1, or 2 bits
For transport block 1:
- Modulation and coding scheme - 5 bits
- New data indicator - 1 bit
- Redundancy version - 2 bits
For transport block 2:
- Modulation and coding scheme - 5 bits
- New data indicator - 1 bit
- Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication- 0 or 3 bits
- SRS request - 2 bits
- CBG transmission information - 0, 2, 4, 6, or 8 bits
- CBG flushing out information - 0 or 1 bit
- DMRS sequence initialization - 1 bit

QCL and TCI state

In the wireless communication system, one or more different antenna ports may be associated with each other by a quasi-co-location (QCL) configuration as shown in Table 8 below, wherein the different antenna ports can be replaced with one or more channels, signals, and combinations thereof, but in the description of the disclosure below, for convenience, reference is made collectively to different antenna ports. The TCI state is for announcement of a QCL relationship between a PDCCH (or PDCCH DMRS) and another RS or channel, wherein certain reference antenna port A (reference RS #A) and another target antenna port B (target RS #B) being QCLed each other indicates that the terminal is allowed to apply some or all of large-scale channel parameters estimated at antenna port A to channel measurement from antenna port B. For QCL, it may be necessary to associate different parameters depending on situations, such as 1) time tracking affected by an average delay and a delay spread, 2) frequency tracking affected by a Doppler shift and a Doppler spread, 3) radio resource management (RRM) affected by average gain, and 4) beam management (BM) affected by a spatial parameter. Accordingly, NR supports four types of QCL relationships as shown in Table 8 below.

TABLE 8

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters, such as angle of arrival (AoA), power angular spectrum (PAS) of AoA, angle of departure (AoD), PAS of AoD, transmission/reception channel correlation, transmission/reception beamforming, and spatial channel correlation.

The QCL relationship is configurable for the terminal via RRC parameter TCI-State and QCL-Info, as shown in Table 9 below. Referring to Table 9, the base station may configure one or more TCI states for the terminal so as to inform about up to two QCL relationships (qcl-Type1 and qcl-Type2) for an RS, i.e., a target RS, referring to TDs of the TCI states. Each piece of QCL information (QCL-Info) included in each TCI state includes a serving cell index and a BWP index of a reference RS indicated by corresponding QCL information, a type and an ID of the reference RS, and a QCL type, as shown in Table 13.

TABLE 9

| TCI-State ::= | | SEQUENCE { |
|---|---|---|
| tci-StateId | | TCI- |
| StateId, | | |
| qcl-Type1 | | QCL- |
| Info, | | |
| qcl-Type2 | | QCL- |
| Info | OPTIONAL, -- Need R | |
| ... | | |
| } | | |
| QCL-Info ::= | | SEQUENCE { |
| cell | | |
| ServCellIndex | OPTIONAL, | -- Need R |

| | |
|---|---|
| bwp-Id | BWP- |

| | |
|---|---|
| Id | OPTIONAL, -- Cond CSI-RS- |

| Indicated | |
|---|---|
| referenceSignal | CHOICE { |

```
      csi-rs
    NZP-CSI-RS-ResourceId,
      ssb
      SSB-Index
    },
    qcl-Type
    ENUMERATED {typeA, typeB, typeC, typeD},
    ...
  }
```

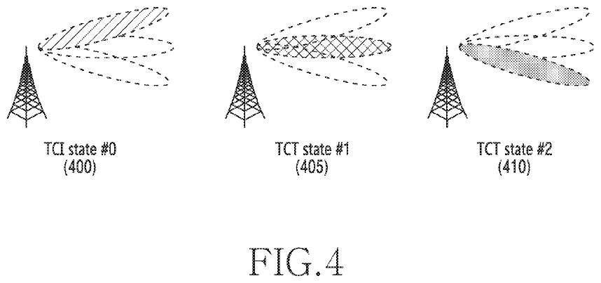

FIG. 4 shows diagrams illustrating examples of base station beam allocation according to a TCI state configuration.

Referring to FIG. 4 a base station may transfer information on N different beams to a terminal via N different TCI states. For example, if N=3 as shown in FIG. 4, the base station may cause the qcl-Type2 parameters included in three TCI states 400, 405, and 410 to be associated with CSI-RSs or SSBs corresponding to different beams and to be configured to be QCL type D, so as to announce that antenna ports referring to the different TCI states 400, 405, or 410 are associated with different spatial Rx parameters, i.e., different beams.

Table 10 to Table 14 below show valid TCI state configurations according to a target antenna port type.

Table 10 shows a valid TCI state configuration if the target antenna port is a CSI-RS for tracking (i.e., TRS). The TRS refers to an NZP CSI-RS, in which a repetition parameter is not configured and trs-Info is configured to be true, among CSI-RSs. Configuration No. 3 in Table 10 may be used for aperiodic TRS.

TABLE 10

| Valid TCI state | | | DL RS 2 | qcl-Type2 |
|---|---|---|---|---|
| Configuration | DL RS 1 | qcl-Type1 | (if configured) | (if configured) |
| 1 | SSB | QCL-TypeC | SSB | QCL-TypeD |
| 2 | SSB | QCL-TypeC | CSI-RS (BM) | QCL-TypeD |
| 3 | TRS (periodic) | QCL-TypeA | TRS (same as DL RS 1) | QCL-TypeD |

Table 11 shows a valid TCI state configuration when a target antenna port is a CSI-RS for CSI. The CSI-RS for CSI refers to an NZP CSI-RS, in which a parameter (e.g., repetition parameter) indicating repetition is not configured and trs-Info is not configured to be true either, from among CSI-RSs.

TABLE 11

| Valid TCI state | | | DL RS 2 | qcl-Type2 |
|---|---|---|---|---|
| Configuration | DL RS 1 | qcl-Type1 | (if configured) | (if configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as DL RS 1) | QCL-TypeD |
| 4 | TRS | QCL-TypeB | | |

Table 12 shows a valid TCI state configurations when a target antenna port is a CS-RS for beam management (BM) (same as a CSI-RS for L1 RSRP reporting). The CSI-RS for BM refers to an NZP CSI-RS, in which a repetition parameter is configured and has a value of On or Off, and trs-Info is not configured to be true, among CSI-RSs.

TABLE 12

| Valid TCI state | | | DL RS 2 | qcl-Type2 |
|---|---|---|---|---|
| Configuration | DL RS 1 | qcl-Type1 | (if configured) | (if configured) |
| 1 | TRS | QCL-TypeA | TRS (same as DL RS 1) | QCL-TypeD |
| 2 | TRS | QCL-TypeA | CSI-RS (BM) | QCL-TypeD |
| 3 | SS/PBCH Block | QCL-TypeC | SS/PBCH Block | QCL-TypeD |

Table 13 shows a valid TCI state configuration when a target antenna port is a PDCCH DMRS.

TABLE 13

| Valid TCI state | | | DL RS 2 | qcl-Type2 |
|---|---|---|---|---|
| Configuration | DL RS 1 | qcl-Type1 | (if configured) | (if configured) |
| 1 | TRS | QCL-TypeA | TRS (same as DL RS 1) | QCL-TypeD |
| 2 | TRS | QCL-TypeA | CSI-RS (BM) | QCL-TypeD |
| 3 | CSI-RS (CSI) | QCL-TypeA | CSI-RS (same as DL RS 1) | QCL-TypeD |

Table 14 shows a valid TCI state configuration when a target antenna port is a PDCCH DMRS.

TABLE 14

| Valid TCI state | | | DL RS 2 | qcl-Type2 |
|---|---|---|---|---|
| Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS (CSI) | QCL-TypeA | CSI-RS (CSI) | QCL-TypeD |

In the typical QCL configuration methods according to Table 10 to table 14, the target antenna port and the reference antenna port for each operation are configured and operated as in “SSB”->“TRS”->“CSI-RS for CSI, CSI-RS for BM, PDCCH DMRS, or PDSCH DMRS”. Based on this, it is possible to assist a reception operation of the terminal by associating, with respective antenna ports, statistical characteristics measurable from the SSB and the TRS.

PDSCH: Relating to Frequency Resource Allocation

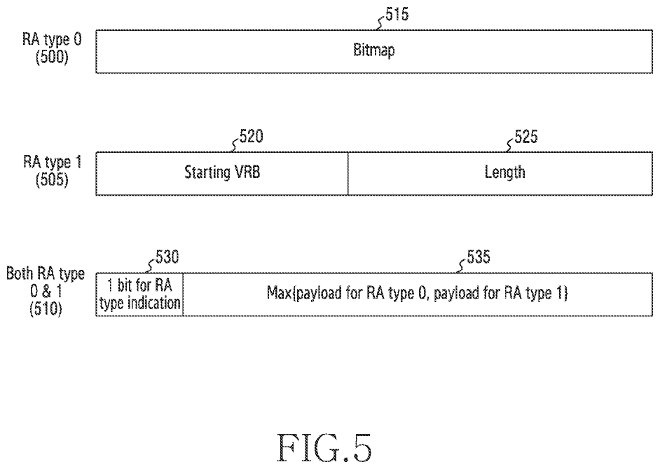

FIG. 5 is a diagram illustrating an example of frequency axis resource allocation of a PDSCH in the wireless communication system, according to an embodiment.

FIG. 5 is a diagram illustrating three frequency axis resource allocation methods of type 0 500, type 1 505, and a dynamic switch 510 which are configurable via a higher layer in the NR wireless communication system.

Referring to FIG. 5, if a terminal is configured 500, via higher-layer signaling, to use only resource type 0, DCI for allocation of a PDSCH to the terminal includes a bitmap including N_RBG bits. Conditions for this are described in greater detail below. In this case, N_RBG refers to the number of resource block groups (RBGs) determined as shown in Table 15 below according to a BWP size assigned by a BWP indicator and higher-layer parameter rbg-Size, and data is transmitted to the RBG indicated to be 1 by a bit map.

TABLE 15

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the terminal is configured 505, via higher-layer signaling, to use only resource type 1, some DCI for allocation of a PDSCH to the terminal includes frequency axis resource allocation information including ┌log₂(N_{RB}^{DL,BWP}(N_{RB}^{DL,BWP}+1)/2┐ bits. Conditions for this are described in greater detail below. Based on this, the base station may configure a starting VRB 520 and a length 525 of frequency axis resources continuously allocated therefrom.

If the terminal is configured 510, via higher-layer signaling, to use both resource type 0 and resource type 1, some DCI for assigning of a PDSCH to the terminal includes frequency axis resource allocation information including bits of a larger value 535 among payloads 520 and 525 for configuring resource type 1 and a payload 515 for configuring resource type 0. Conditions for this are described in greater detail below. In this case, one bit 530 may be added to the first part (MSB) of the frequency axis resource allocation information in the DCI, and if the bit 530 has a value of “0”, use of resource type 0 may be indicated, and if the bit has a value of “1”, use of resource type 1 may be indicated.

PDSCH/PUSCH: Relating to Time Resource Allocation

Hereinafter, a method of time domain resource allocation for a data channel in the next-generation mobile communication system (5G or NR system) is described.

The base station may configure, for the terminal via higher-layer signaling (e.g., RRC signaling), a table for time domain resource allocation information on a downlink data channel (PDSCH) and an uplink data channel (PUSCH). A table including up to 16 entries (maxNrofDL-Allocations=16) may be configured for the PDSCH, and a table including up to 16 entries (maxNrofUL-Allocations=16) may be configured for the PUSCH. The time domain resource allocation information may include a PDCCH-to-PDSCH slot timing (denoted as K0, and corresponding to a time interval in units of slots between a time point at which a PDCCH is received and a time point at which a PDSCH scheduled by the received PDCCH is transmitted), a PDCCH-to-PUSCH slot timing (denoted as K2, and corresponding to a time interval in units of slots between a time point at which a PDCCH is received and a time point at which a PUSCH scheduled by the received PDCCH is transmitted), information on a position and a length of a start symbol in which the PDSCH or PUSCH is scheduled within a slot, a mapping type of the PDSCH or PUSCH, or the like. For example, information as shown in Table 16 or Table 17 below may be transmitted from the base station to the terminal.

TABLE 16
PDSCH-TimeDomainResourceAllocationList information element

PDSCH-TimeDomainResourceAllocationList ::= SEQUENCE
(SIZE(1..maxNrofDL-Allocations)) OF PDSCH-
TimeDomainResourceAllocation

| | |
|---|---|
| PDSCH-TimeDomainResourceAllocation ::= | SEQUENCE { |

```
  k0 INTEGER(0..32)
OPTIONAL, -- Need S
  (PDCCH-to-PDSCH timing, slot unit)
mappingType ENUMERATED {typeA,
typeB},
  (PDSCH mapping type)
```

| | |
|---|---|
| startSymbolAndLength | INTEGER (0..127) |

(PDSCH start symbol and length)
}

TABLE 17
PUSCH-TimeDomainResourceAllocation information element

| | |
|---|---|
| PUSCH-TimeDomainResourceAllocationList ::= | SEQUENCE |

(SIZE(1..maxNrofUL-Allocations) OF PUSCH-
TimeDomainResourceAllocation

| | |
|---|---|
| PUSCH-TimeDomainResourceAllocation ::= | SEQUENCE { |

```
  k2 INTEGER(0..32)
OPTIONAL, -- Need S
  (PDCCH-to-PUSCH timing, slot unit)
  mappingType ENUMERATED
{typeA, typeB},
  (PUSCH mapping type)
```

| | |
|---|---|
| startSymbolAndLength | INTEGER (0..127) |

(PUSCH start symbol and length)
}

The base station may notify one of the entries in the tables relating to the time domain resource allocation information described above to the terminal via L1 signaling (e.g., DCI) (e.g., the entry may be indicated by a “time domain resource allocation” field in the DCI). The terminal may acquire the time domain resource allocation information for the PDSCH or PUSCH, based on the DCI received from the base station.

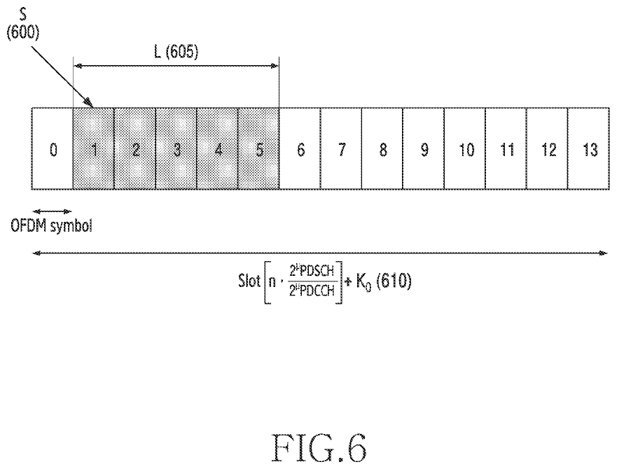

FIG. 6 is a diagram illustrating an example of time axis resource allocation of a PDSCH in the wireless communication system, according to an embodiment.

Referring to FIG. 6, a base station may indicate a time axis position of a PDSCH resource according to a start position 600 and a length 605 of an OFDM symbol in one slot dynamically indicated via DCI, a scheduling offset K0 value, and subcarrier spacings (SCSs) (μPDSCH, PDCCH) of a data channel and a control channel configured using a higher layer.

PDSCH: TCI State Activation MAC-CE

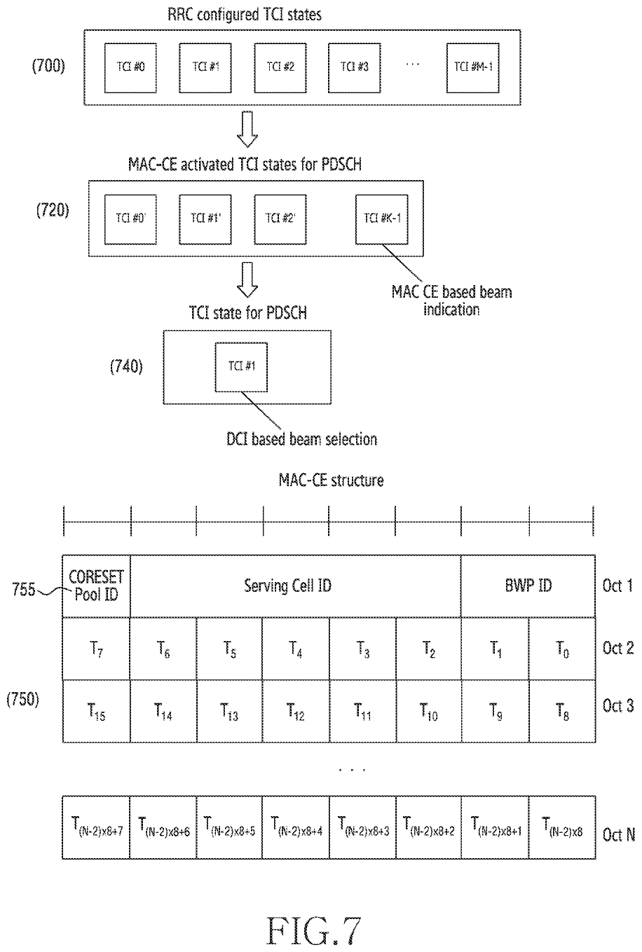

FIG. 7 illustrates a procedure for beam configuration and activation of a PDSCH. A list of TCI states for a PDSCH may be indicated via a higher layer list, such as RRC, at 700. The list of TCI states may be indicated, for example, by tci-State sToAddModLi st and/or tci-StatesToReleaseList in PDSCH-Config IE for each BWP. Next, some in the list of TCI states may be activated via a MAC-CE, at 720. Among the TCI states activated via the MAC-CE, a TCI state for a PDSCH may be indicated via DCI, at 740. The maximum number of the activated T states may be determined according to capabilities reported by the terminal. 750 illustrates an example of a MAC-CE structure for PDSCH T state activation/deactivation.

The meaning of each field in the MAC CE and values configurable for each field are shown as in Table 18 below.

TABLE 18
Serving Cell ID: This field indicates the identity of the Serving Cell for which
the MAC CE applies. The length of the field is 5 bits. If the indicated Serving Cell is
configured as part of a simultaneousTCI-UpdateList1 or simultaneousTCI-UpdateList2
as specified in TS 38.331 [5], this MAC CE applies to all the Serving Cells configured
in the set simultaneousTCI-UpdateList1 or simultaneousTCI-UpdateList2 respectively;
BWP ID: This field indicates a DL BWP for which the MAC CE applies as the
codepoint of the DCI bandwidth part indicator field as specified in TS 38.212 [9]. The length of
the BWP ID field is 2 bits. This field is ignored if this MAC CE applies to a set of Serving
Cells;
Ti: If there is a TCI state with TCI-StateId i as specified in TS 38.331 [5], this
field indicates the activation/deactivation status of the TCI state with TCI-StateId i,
otherwise MAC entity shall ignore the Ti field. The Ti field is set to 1 to indicate that the
TCI state with TCI-StateId i shall be activated and mapped to the codepoint of the DCI
Transmission Configuration Indication field, as specified in TS 38.214 [7]. The Ti field
is set to 0 to indicate that the TCI state with TCI-StateId i shall be deactivated and is not
mapped to the codepoint of the DCI Transmission Configuration Indication field. The
codepoint to which the TCI State is mapped is determined by its ordinal position among
all the TCI States with Ti field set to 1, i.e. the first TCI State with Ti field set to 1 shall
be mapped to the codepoint value 0, second TCI State with Ti field set to 1 shall be
mapped to the codepoint value 1 and so on. The maximum number of activated TCI
states is 8;
CORESET Pool ID: This field indicates that mapping between the activated TCI
states and the codepoint of the DCI Transmission Configuration Indication set by field
Ti is specific to the ControlResourceSetId configured with CORESET Pool ID as
specified in TS 38.331 [5]. This field set to 1 indicates that this MAC CE shall be applied
for the DL transmission scheduled by CORESET with the CORESET pool ID equal to
1, otherwise, this MAC CE shall be applied for the DL transmission scheduled by
CORESET pool ID equal to 0. If the coresetPoolIndex is not configured for any
CORESET, MAC entity shall ignore the CORESET Pool ID field in this MAC CE when
receiving the MAC CE. If the Serving Cell in the MAC CE is configured in a cell list
that contains more than one Serving Cell, the CORESET Pool ID field shall be ignored
when receiving the MAC CE.

PUCCH: Relating to Transmission

In the NR system, a terminal may transmit control information (UCI) to a base station through a PUCCH. The control information may include at least one of HARQ-ACK indicating success or failure of demodulation/decoding for a transport block (TB) received by the terminal via a PDSCH, a scheduling request (SR) for requesting resource allocation from a PUSCH base station by the terminal for uplink data transmission, and channel state information (CSI) that is information for reporting a channel state of the terminal.

PUCCH resources may be mainly divided into a long PUCCH and a short PUCCH according to a length of an assigned symbol. In the NR system, a long PUCCH has a length of 4 symbols or more in a slot, and a short PUCCH has a length of 2 symbols or fewer in a slot.

In more details about a long PUCCH, the long PUCCH may be used for the purpose of improving uplink cell coverage, and thus may be transmitted in a DFT-S-OFDM scheme, which is a single carrier transmission, rather than OFDM transmission. The long PUCCH supports transmission formats, such as PUCCH format 1, PUCCH format 3, and PUCCH format 4, depending on the number of supportable control information bits and whether terminal multiplexing via Pre-DFT OCC support at a previous stage of IFFT is supported.

First, PUCCH format 1 is a DFT-S-OFDM-based long PUCCH format capable of supporting control information of up to 2 bits, and uses a frequency resource of 1 RB. The control information may include each of or a combination of HARQ-ACK and SR. In PUCCH format 1, an OFDM symbol including a demodulation reference signal (DMRS) that is a demodulation reference signal (or reference signal) and an OFDM symbol including UCI are configured in a repetitive manner.

For example, if the number of transmission symbols of PUCCH format 1 is 8 symbols, starting from a first start symbol of the 8 symbols, a DMRS symbol, a UCI symbol, a DMRS symbol, a UCI symbol, a DMRS symbol, a UCI symbol, a DMRS symbol, and a UCI symbol may be included in sequence. A DMRS symbol may be spread using an orthogonal code (or orthogonal sequence or spreading code, wᵢ(m)) on the time axis to a sequence corresponding to a length of 1 RB on the frequency axis within one OFDM symbol, and is transmitted after IFFT is performed.

For a UCI symbol, the terminal generates d(0) by BPSK-modulating 1-bit control information and QPSK-modulating 2-bit control information, multiplies generated d(0) by a sequence corresponding to the length of 1 RB on the frequency axis so as to perform scrambling, performs spreading using the orthogonal code (or orthogonal sequence or spreading code, wᵢ(m)) on the time axis to the scrambled sequence, performs IFFT, and then performs transmission.

The terminal generates the sequence, based on a configured ID and a group hopping or sequence hopping configuration received via higher-layer signaling from the base station, and generates a sequence corresponding to a length of 1 RB by cyclic shifting the generated sequence with an initial cyclic shift (CS) value configured via a higher signal.

wᵢ(m) is determined as in

$${w}_{i} ( m ) = {e}^{\frac{j 2 π ϕ ( m )}{{N}_{SF}}}$$

when a length (NSF) of a spreading code is given, which is specifically shown as in Table 19 below. i indicates an index of the spreading code itself, and m indicates indexes of elements of the spreading code. Here, numbers within [ ] in [Table 19] refer to φ(m), for example, if the length of the spreading code is 2 and the index of the configured spreading code satisfies i=0, spreading code wᵢ(m) becomes wᵢ(0)=e^{j2π·0/N}^{_{SF}}=1 and wᵢ(1)=e^{j2π·0/N}^{_{SF}}=1 so as to satisfy wᵢ(m)=[1 1].

TABLE 19
Spreading codes for PUCCH format 1 wᵢ (m) = e^{j2πφ(m)/N}_{SF}

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 | [0 2 4 1 | [0 3 1 4 | [0 4 3 2 | — | — |
| | | 4] | 3] | 2] | 1] | | |
| 6 | [0 0 0 0 0 | [0 1 2 3 4 | [0 2 4 0 2 | [0 3 0 3 0 | [0 4 2 0 4 | [0 5 4 3 2 | — |
| | 0] | 5] | 4] | 3] | 2] | 1] | |
| 7 | [0 0 0 0 0 | [0 1 2 3 4 | [0 2 4 6 1 | [0 3 6 2 5 | [0 4 1 5 2 | [0 5 3 1 6 | [0 6 5 4 3 |
| | 0 0] | 5 6] | 3 5] | 1 4] | 6 3] | 4 2] | 2 1] |

Next, PUCCH format 3 is a DFT-S-OFDM-based long PUCCH format capable of supporting control information exceeding 2 bits, and the number of used RBs is configurable via a higher layer. The control information may include each of or a combination of HARQ-ACK, SR, and CSI. In PUCCH format 3, a DMRS symbol position is presented in Table 20 below according to whether an additional DMRS symbol is configured and whether frequency hopping is configured within a slot.

TABLE 20

| | DMRS position within PUCCH format 3/4 transmission | | | |
|---|---|---|---|---|
| | No additional DMRS | | Additional DMRS | |
| Transmission | configured | | configured | |
| length of | No frequency | Frequency | No frequency | Frequency |
| PUCCH | hopping | hopping | hopping | hopping |
| format 3/4 | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, if the number of transmission symbols of PUCCH format 3 is 8 symbols, starting with a first start symbol being 0 among the 8 symbols, DMRSs are transmitted via the first and fifth symbols. Table 20 is applied in the same way to a DMRS symbol position of PUCCH format 4.

Next, PUCCH format 4 is a DFT-S-OFDM-based long PUCCH format capable of supporting control information exceeding 2 bits, and uses a frequency resource of 1 RB. The control information may include each of or a combination of HARQ-ACK, SR, and CSI. A difference between PUCCH format 4 and PUCCH format 3 is that, for PUCCH format 4, PUCCH format 4 of multiple terminals may be multiplexed within one RB. Multiplexing of PUCCH format 4 of multiple terminals is possible via application of Pre-DFT orthogonal cover code (OCC) to control information at a previous stage of IFFT. However, the number of transmittable control information symbols of one terminal decreases according to the number of multiplexed terminals. The number of multiplexable terminals, that is, the number of different available OCCs, may be 2 or 4, and the number of OCCs and the OCC index to be applied may be configured via a higher layer.

A short PUCCH may be transmitted in both a downlink centric slot and an uplink centric slot and, in general, the short PUCCH may be transmitted at a last symbol of a slot or an OFDM symbol at the end (e.g., the last OFDM symbol, a second OFDM symbol from the last, or last 2 OFDM symbols at the end). Of course, transmission of the short PUCCH at a random position in the slot is also possible. The short PUCCH may be transmitted using one OFDM symbol or two OFDM symbols. The short PUCCH may be used to shorten a delay time compared to a long PUCCH in a situation where uplink cell coverage is good, and may be transmitted in a CP-OFDM scheme.

The short PUCCH may support transmission formats, such as PUCCH format 0 and PUCCH format 2, according to the number of supportable control information bits. First, PUCCH format 0 is a short PUCCH format capable of supporting control information of up to 2 bits, and uses a frequency resource of 1 RB. The control information may include each of or a combination of HARQ-ACK and SR. PUCCH format 0 has a structure of transmitting no DMRS and transmitting only a sequence mapped to 12 subcarriers in the frequency axis within one OFDM symbol. The terminal may generate a sequence, based on a configured ID and a group hopping or sequence hopping configuration received via a higher signal from the base station, cyclic-shifts the generated sequence by using a final cyclic shift (CS) value obtained by adding a different CS value to an indicated initial CS value depending on ACK or NACK, and maps the cyclic-shifted sequence to 12 subcarriers, so as to perform transmission.

For example, for HARQ-ACK of 1 bit, as shown in Table 21 below, if ACK, the terminal may generate the final CS by adding 6 to the initial CS value, and if NACK, the terminal may generate the final CS by adding 0 to the initial CS. The CS value of 0 for NACK and the CS value of 6 for ACK are defined in the standard, and the terminal may generate PUCCH format 0 according to the value defined in the standard so as to transmit 1-bit HARQ-ACK.

TABLE 21

| 1-bit HARQ-ACK | NACK | ACK |
|---|---|---|
| Final CS | (Initial CS + 0) mod | (Initial CS + 6) |
| | 12 = Initial CS | mod 12 |

For example, if HARQ-ACK is 2 bits, as shown in Table 22 below, the terminal adds 0 to the initial CS value for (NACK, NACK), adds 3 to the initial CS value for (NACK, ACK), adds 6 to the initial CS value for (ACK, ACK), and adds 9 to the initial CS value for (ACK, NACK). The CS value of 0 for (NACK, NACK), the CS value of 3 for (NACK, ACK), the CS value of 6 for (ACK, ACK), and the CS value of 9 for (ACK, NACK) are defined in the standard, and the terminal may generate PUCCH format 0 according to the value defined in the standard so as to transmit a 2-bit HARQ-ACK. If the final CS value exceeds 12 due to the CS value added to the initial CS value according to ACK or NACK, since a sequence length is 12, modulo 12 may be applied to the final CS value.

TABLE 22

| 2-bit | NACK, | NACK, | ACK, | ACK, |
|---|---|---|---|---|
| HARQ-ACK | NACK | ACK | ACK | NACK |
| Final CS | (Initial | (Initial | (Initial | (Initial |
| | CS + 0) | CS + 3) | CS + 6) | CS + 9) |
| | mod 12 = | mod 12 | mod 12 | mod 12 |
| | Initial CS | | | |

Next, PUCCH format 2 is a short PUCCH format supporting control information exceeding 2 bits, and the number of used RBs may be configured via a higher layer. The control information may include each of or a combination of HARQ-ACK, SR, and CSI. When an index of a first subcarrier is #0, in PUCCH format 2, positions of subcarriers in which a DMRS is transmitted may be fixed to subcarriers having indexes of #1, #4, #7, and #10 within one OFDM symbol. The control information may be mapped to subcarriers remaining after excluding the subcarriers, in which the DMRS is positioned, via modulation after channel coding.

In summary, values configurable for the aforementioned respective PUCCH formats and ranges of the values may be organized as shown in Table 23 below. In Table 23, a case where no value needs to be configured is indicated as N.A.

TABLE 23

| | | PUCCH | PUCCH | PUCCH | PUCCH | PUCCH |
|---|---|---|---|---|---|---|
| | | Format 0 | Format 1 | Format 2 | Format 3 | Format 4 |
| Starting | Configurability | √ | √ | √ | √ | √ |
| symbol | Value range | 0-13 | 0-10 | 0-13 | 0-10 | 0-10 |
| Number | Configurability | √ | √ | √ | √ | √ |
| of | Value range | 1, 2 | 4-14 | 1, 2 | 4-14 | 4-14 |
| symbols | | | | | | |
| in a slot | | | | | | |
| Index | Configurability | √ | √ | √ | √ | √ |
| for | Value range | 0-274 | 0-274 | 0-274 | 0-274 | 0-274 |
| identifying | | | | | | |
| starting | | | | | | |
| PRB | | | | | | |
| Number | Configurability | N.A. | N.A. | √ | √ | N.A. |
| of PRBs | Value range | N.A.(Default | N.A.(Default | 1-16 | 1-6, 8-10, | N.A. |
| | | is 1) | is 1) | | 12, 15, | (Default is |
| | | | | | 16 | 1) |
| Enabling | Configurability | √ | √ | √ | √ | √ |
| a FH | Value range | On/Off | On/Off | On/Off | On/Off | On/Off |
| | | (only for 2 | | (only for 2 | | |
| | | symbol) | | symbol) | | |
| Freq.cy | Configurability | √ | √ | √ | √ | √ |
| resource | Value range | 0-274 | 0-274 | 0-274 | 0-274 | 0-274 |
| of 2^{nd} | | | | | | |
| hop if | | | | | | |
| FH is | | | | | | |
| enabled | | | | | | |
| Index of | Configurability | √ | √ | N.A. | N.A. | N.A. |
| initial | Value range | 0-11 | 0-11 | N.A. | 0-11 | 0-11 |
| cyclic | | | | | | |
| shift | | | | | | |
| Index of | Configurability | N.A. | √ | N.A. | N.A. | N.A. |
| time- | Value range | N.A. | 0-6 | N.A. | N.A. | N.A. |
| domain | | | | | | |
| OCC | | | | | | |
| Length | Configurability | N.A. | N.A. | N.A. | N.A. | √ |
| of Pre- | Value range | N.A. | N.A. | N.A. | N.A. | 2, 4 |
| DFT | | | | | | |
| OCC | | | | | | |
| Index of | Configurability | N.A. | N.A. | N.A. | N.A. | √ |
| Pre- | Value range | N.A. | N.A. | N.A. | N.A. | 0, 1, 2, 3 |
| DFT | | | | | | |
| OCC | | | | | | |

In order to improve uplink coverage, multi-slot repetition may be supported for PUCCH formats 1, 3, and 4, and PUCCH repetition may be configured for each PUCCH format. The terminal may repeatedly transmit a PUCCH including UCI as many times as the number of slots configured via nrofSlots that is higher-layer signaling. For the repeated PUCCH transmission, PUCCH transmission in each slot may be performed using the same number of consecutive symbols, and the number of the consecutive symbols may be configured via nrofSymbols in PUCCH-format 1, PUCCH-format 3, or PUCCH-format 4, which is higher-layer signaling. For the repeated PUCCH transmission, PUCCH transmission in each slot may be performed using the same start symbol, and the start symbol may be configured via startingSymbolIndex in PUCCH-format 1, PUCCH-format 3, or PUCCH-format 4, which is higher-layer signaling. For the repeated PUCCH transmission, a single PUCCH-spatialRelationInfo may be configured for a single PUCCH resource. For the repeated PUCCH transmission, if the terminal is configured to perform frequency hopping in PUCCH transmission in different slots, the terminal may perform frequency hopping in units of slots. In addition, if the terminal is configured to perform frequency hopping in PUCCH transmission in different slots, the terminal may start, in an even-numbered slot, the PUCCH transmission from a first PRB index configured via startingPRB that is higher-layer signaling, and the terminal may start, in an odd-numbered slot, the PUCCH transmission from a second PRB index configured via secondHopPRB that is higher-layer signaling. Additionally, if the terminal is configured to perform frequency hopping in PUCCH transmission in different slots, an index of a slot indicated to the terminal for first PUCCH transmission is 0, and during the configured total number of repeated PUCCH transmissions, a value of the number of repeated PUCCH transmissions may be increased in each slot regardless of execution of the PUCCH transmission. If the terminal is configured to perform frequency hopping in PUCCH transmission in different slots, the terminal does not expect configuration of frequency hopping within the slot during PUCCH transmission. If the terminal is not configured to perform frequency hopping in PUCCH transmission in different slots, but is configured with frequency hopping within a slot, a first PRB index and a second PRB index are applied equally in the slot. If the number of uplink symbols available for PUCCH transmission is less than nrofSymbols configured via higher-layer signaling, the terminal may not transmit a PUCCH. Even if the terminal fails to transmit a PUCCH for some reason in a certain slot during repeated PUCCH transmission, the terminal may increase the number of repeated PUCCH transmissions.

PUCCH: PUCCH Resource Configuration

Next, a PUCCH resource configuration of the base station or the terminal is described. The base station may be able to configure a PUCCH resource for each BWP via a higher layer for a specific terminal. The PUCCH resource configuration may be as shown in Table 24 below.

TABLE 24

| | |
|---|---|
| PUCCH-Config ::= | SEQUENCE { |

```
    resourceSetToAddModList SEQUENCE (SIZE
(1..maxNrofPUCCH-ResourceSets)) OF PUCCH-ResourceSet OPTIONAL, -- Need
N
    resourceSetToReleaseList SEQUENCE (SIZE
(1..maxNrofPUCCH-ResourceSets)) OF PUCCH-ResourceSetId OPTIONAL, -- Need
N
    resourceToAddModList
(1..maxNrofPUCCH-Resources)) OF PUCCH-Resource OPTIONAL, --
Need N
    resourceToReleaseList SEQUENCE (SIZE
(1..maxNrofPUCCH-Resources)) OF PUCCH-ResourceId OPTIONAL, --
Need N
    format1 SetupRelease { PUCCH-FormatConfig }
OPTIONAL, -- Need M
    format2 SetupRelease { PUCCH-FormatConfig }
OPTIONAL, -- Need M
    format3 SetupRelease { PUCCH-FormatConfig }
OPTIONAL, -- Need M
    format4 SetupRelease { PUCCH-FormatConfig }
OPTIONAL, -- Need M
    schedulingRequestResourceToAddModList SEQUENCE (SIZE
(1..maxNrofSR-Resources)) OF SchedulingRequestResourceConfig
OPTIONAL, -- Need N
    schedulingRequestResourceToReleaseList SEQUENCE (SIZE
(1..maxNrofSR-Resources)) OF SchedulingRequestResourceId
OPTIONAL, -- Need N
    multi-CSI-PUCCH-ResourceList SEQUENCE (SIZE (1..2)) OF
```

| | |
|---|---|
| PUCCH-ResourceId | OPTIONAL, -- Need M |

dl-DataToUL-ACK SEQUENCE (SIZE (1..8)) OF

| | |
|---|---|
| INTEGER (0..15) | OPTIONAL, -- Need M |

```
    spatialRelationInfoToAddModList SEQUENCE (SIZE
(1..maxNrofSpatialRelationInfos)) OF PUCCH-SpatialRelationInfo
OPTIONAL, -- Need N
    spatialRelationInfoToReleaseList SEQUENCE (SIZE
(1..maxNrofSpatialRelationInfos)) OF PUCCH-SpatialRelationInfoId
OPTIONAL, -- Need N
    pucch-PowerControl PUCCH-PowerControl
OPTIONAL, -- Need M
    ...,
    [[
    resource ToAddModListExt-r16 SEQUENCE (SIZE
(1..maxNrofPUCCH-Resources)) OF PUCCH-ResourceExt-r16 OPTIONAL, -- Need
N
    dl-DataToUL-ACK-r16 SetupRelease { DL-DataToUL-ACK-
```

| | |
|---|---|
| r16 } | OPTIONAL, -- Need M |

ul-AccessConfigListDCI-1-1-r16 SetupRelease { UL-
AccessConfigListDCI-1-1-r16 } OPTIONAL, -- Need M

| | |
|---|---|
| subslotLengthForPUCCH-r16 | CHOICE { |

normalCP-r16 ENUMERATED

{n2,n7},

extendedCP-r16 ENUMERATED

```
{n2,n6}
    }
OPTIONAL, -- Need R
    dl-DataToUL-ACK-DCI-1-2-r16 SetupRelease { DL-DataToUL-ACK-
```

| | |
|---|---|
| DCI-1-2-r16} | OPTIONAL, -- Need M |

numberOfBitsForPUCCH-ResourceIndicatorDCI-1-2-r16 INTEGER

| | |
|---|---|
| (0..3) | OPTIONAL, -- Need R |

dmrs-UplinkTransformPrecodingPUCCH-r16 ENUMERATED

| | |
|---|---|
| {enabled} | OPTIONAL, -- Cond PI2-BPSK |

```
    spatialRelationInfoToAddModListSizeExt-v1610 SEQUENCE (SIZE
(1..maxNrofSpatialRelationInfosDiff-r16)) OF PUCCH-SpatialRelationInfo
OPTIONAL, -- Need N
    spatialRelationInfoToReleaseListSizeExt-v1610 SEQUENCE (SIZE
(1..maxNrofSpatialRelationInfosDiff-r16)) OF PUCCH-SpatialRelationInfoId
OPTIONAL, -- Need N
    spatialRelationInfoToAddModListExt-v1610 SEQUENCE (SIZE
(1..maxNrofSpatialRelationInfos-r16) OF PUCCH-SpatialRelationInfoExt-r16
OPTIONAL, -- Need N
    spatialRelationInfoToReleaseListExt-v1610 SEQUENCE (SIZE
(1..maxNrofSpatialRelationInfos-r16)) OF PUCCH-SpatialRelationInfoId-r16
OPTIONAL, -- Need N
    resourceGroupToAddModList-r16 SEQUENCE (SIZE
(1..maxNrofPUCCH-ResourceGroups-r16)) OF PUCCH-ResourceGroup-r16
OPTIONAL, -- Need N
    resourceGroup ToReleaseList-r16 SEQUENCE (SIZE
(1..maxNrofPUCCH-ResourceGroups-r16)) OF PUCCH-ResourceGroupId-r16
OPTIONAL, -- Need N
    sps-PUCCH-AN-List-r16 SetupRelease { SPS-PUCCH-AN-
```

| | |
|---|---|
| List-r16 } | OPTIONAL, -- Need M |

```
    schedulingRequestResourceToAddModListExt-v1610 SEQUENCE
(SIZE (1..maxNrofSR-Resources)) OF SchedulingRequestResourceConfigExt-v1610
OPTIONAL -- Need N
    ]]
  }
```

According to Table 24, one or multiple PUCCH resource sets in the PUCCH resource configuration for a specific BWP may be configured, and a maximum payload value for UCI transmission may be configured in some of the PUCCH resource sets. Each PUCCH resource set may include one or multiple PUCCH resources, and each of the PUCCH resources may belong to one of the aforementioned PUCCH formats.

With respect to the PUCCH resource sets, a maximum payload value of a first PUCCH resource set may be fixed to 2 bits. Accordingly, the value may not be separately configured via a higher layer or the like. If remaining PUCCH resource sets are configured, indexes of the PUCCH resource sets may be configured in ascending order according to maximum payload values, and a maximum payload value may not be configured for the last PUCCH resource set. Higher layer configurations for the PUCCH resource sets may be as shown in Table 25 below.

TABLE 25

| | |
|---|---|
| PUCCH-ResourceSet ::= | SEQUENCE { |
| pucch-ResourceSetId | PUCCH-ResourceSetId, |

```
    resourceList SEQUENCE (SIZE
(1..maxNrofPUCCH-ResourcesPerSet)) OF PUCCH-ResourceId,
    maxPayloadSize INTEGER (4..256)
OPTIONAL -- Need R
  }
```

Parameter resourceList in Table 25 may include TDs of PUCCH resources belonging to the PUCCH resource set.

During initial access or if no PUCCH resource set is configured, a PUCCH resource set as shown in Table 26, which includes multiple cell-specific PUCCH resources in an initial BWP, may be used. The PUCCH resource to be used for initial access in this PUCCH resource set may be indicated via SIB1.

TABLE 26

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}/4┘ | {0, 3, 6, 9} |

The maximum payload of each PUCCH resource included in the PUCCH resource set may be 2 bits for PUCCH format 0 or 1, and may be determined based on a symbol length, the number of PRBs, and a maximum code rate for the remaining formats. The symbol length and the number of PRBs may be configured for each PUCCH resource, and the maximum code rate may be configured for each PUCCH format.

Next, PUCCH resource selection for UCI transmission is described. For SR transmission, a PUCCH resource for an SR corresponding to schedulingRequestID may be configured via a higher layer, as shown in Table 27. The PUCCH resource may be a resource belonging to PUCCH format 0 or PUCCH format 1.

TABLE 27

| | |
|---|---|
| SchedulingRequestResourceConfig ::= | SEQUENCE { |

schedulingRequestResourceId
SchedulingRequestResourceId,

| | |
|---|---|
| schedulingRequestID | SchedulingRequestId, |
| periodicityAndOffset | CHOICE { |
| sym2 | NULL, |
| sym6or7 | NULL, |
| sl1 | NULL, |

-- Recurs in every slot

| | |
|---|---|
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

}
OPTIONAL, -- Need M

| | |
|---|---|
| resource | PUCCH-ResourceId |

OPTIONAL -- Need M
}

For the configured PUCCH resource, a transmission period and an offset may be configured via parameter periodicityAndOffset of Table 27. If there is uplink data to be transmitted by the terminal at atime point corresponding to the configured period and offset, the corresponding PUCCH resource may be transmitted, otherwise, the corresponding PUCCH resource may not be transmitted.

For CSI transmission, a PUCCH resource for transmission of a periodic or semi-persistent CSI report via a PUCCH may be configured in parameter pucch-CSI-ResourceList as shown in Table 28 below. Parameter pucch-CSI-ResourceList may include a list of PUCCH resources specific to each BWP for a cell or CC in which a corresponding CSI report is to be transmitted. The PUCCH resource may be a resource belonging to PUCCH format 2, PUCCH format 3, or PUCCH format 4. For the PUCCH resource, a transmission period and an offset may be configured via report SlotConfig of Table 28.

TABLE 28

| CSI-ReportConfig ::= | SEQUENCE { |
|---|---|
| reportConfigId | CSI-ReportConfigId, |
| carrier ServCellIndex | |
| OPTIONAL, -- Need S | |
| ... | |
| reportConfigType | CHOICE { |
| periodic | SEQUENCE { |
| reportSlotConfig CSI- | |
| ReportPeriodicityAndOffset, | |
| pucch-CSI-ResourceList SEQUENCE | |
| (SIZE (1..maxNrofBWPs)) OF PUCCH-CSI-Resource | |
| }, | |
| semiPersistentOnPUCCH | SEQUENCE { |
| reportSlotConfig CSI- | |
| ReportPeriodicityAndOffset, | |
| pucch-CSI-ResourceList SEQUENCE | |
| (SIZE (1..maxNrofBWPs)) OF PUCCH-CSI-Resource | |
| }, | |
| semiPersistentOnPUSCH | SEQUENCE { |
| reportSlotConfig | |
| ENUMERATED {sl5, sl10, sl20, sl40, sl80, sl160, sl320}, | |
| reportSlotOffsetList SEQUENCE (SIZE | |
| (1..maxNrofUL-Allocations)) OF INTEGER(0..32), | |
| p0alpha P0-PUSCH- | |
| AlphaSetId | |
| }, | |
| aperiodic | SEQUENCE { |

```
        reportSlotOffsetList SEQUENCE (SIZE
(1..maxNrofUL-Allocations)) OF INTEGER(0..32)
      }
    },
    ...
  }
```

For HARQ-ACK transmission, a resource set of PUCCH resources for transmission may be first selected according to a payload of UCI including corresponding HARQ-ACK. That is, a PUCCH resource set having a minimum payload that is not smaller than the UCI payload may be selected. Next, a PUCCH resource in the PUCCH resource set may be selected via a PUCCH resource indicator (PRI) in DCI for scheduling of a TB corresponding to the HARQ-ACK, and the PRI may be the PUCCH resource indicator specified in Table 6 or Table 7. A relationship between the PRI and the PUCCH resource selected from the PUCCH resource set may be as shown in Table 29 below.

TABLE 29

| PUCCH resource | |
|---|---|
| indicator | PUCCH resource |
| ‘000’ | 1^{st} PUCCH resource provided by pucch-ResourceId |
| | obtained from the 1^{st} value of resourceList |
| ‘001’ | 2^{nd} PUCCH resource provided by pucch-ResourceId |
| | obtained from the 2^{nd} value of resourceList |
| ‘010’ | 3^{rd} PUCCH resource provided by pucch-ResourceId |
| | obtained from the 3^{rd} value of resourceList |
| ‘011’ | 4^{th} PUCCH resource provided by pucch-ResourceId |
| | obtained from the 4^{th} value of resourceList |
| ‘100’ | 5^{th} PUCCH resource provided by pucch-ResourceId |
| | obtained from the 5^{th} value of resourceList |
| ‘101’ | 6^{th} PUCCH resource provided by pucch-ResourceId |
| | obtained from the 6^{th} value of resourceList |
| ‘110’ | 7^{th} PUCCH resource provided by pucch-ResourceId |
| | obtained from the 7^{th} value of resourceList |
| ‘111’ | 8^{th} PUCCH resource provided by pucch-ResourceId |
| | obtained from the 8^{th} value of resourceList |

If the number of selected PUCCH resources in the PUCCH resource set is greater than 8, the PUCCH resources may be selected based on Equation (1) below.

$${r}_{PUCCH} = \qquad ( 1 )$$

$$\{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ ⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ & if {Δ}_{PRI} \geq {R}_{PUCCH} mod 8\end{matrix} \}$$

In Equation (1), r_{PUCCH} indicates an index of a selected PUCCH resource in the PUCCH resource set, R_{PUCCH} indicates the number of PUCCH resources belonging to the PUCCH resource set, Δ_{PR2} indicates a PRI value, N_{CCE,P} indicates the total number of CCEs of CORESET p to which received DCI belongs, and n_{CCE,p} indicates a first CCE index for the received DCI.

A point in time at which a corresponding PUCCH resource is transmitted is after K₁ slots from TB transmission which corresponds to corresponding HARQ-ACK. A candidate of value K₁ is configured via a higher layer, and more specifically, may be configured in parameter dl-DataToUL-ACK in PUCCH-Config specified in Table 27. One K₁ value among the candidates may be selected by a PDSCH-to-HARQ feedback timing indicator in the DCI for scheduling of the TB, and this value may be the value specified in Table 5 or Table 6. The unit of the K₁ value may be units of slots or units of sub slots. Here, a sub slot is a unit of a length smaller than that of a slot, and one or multiple symbols may constitute one sub slot.

Next, a case where two or more PUCCH resources are located in one slot is described. The terminal may transmit UCI via one or two PUCCH resources in one slot or sub-slot, and when UCI is transmitted via two PUCCH resources in one slot/sub-slot, i) respective PUCCH resources do not overlap in units of symbols, and ii) at least one PUCCH resource may be a short PUCCH. The terminal may not expect to transmit multiple PUCCH resources for HARQ-ACK transmission within one slot.

PUCCH: Relating to Transmission Beam

Next, uplink transmission beam configuration to be used for PUCCH transmission is described. If the terminal does not have a UE-specific configuration for a PUCCH resource configuration (dedicated PUCCH resource configuration), a PUCCH resource set is provided via pucch-ResourceCommon that is higher-layer signaling, wherein the beam configuration for PUCCH transmission conforms to a beam configuration used in PUSCH transmission scheduled via a random-access response (RAR) UL grant. If the terminal has a UE-specific configuration for a PUCCH resource configuration (dedicated PUCCH resource configuration), the beam configuration for PUCCH transmission may be provided via pucch-spatialRelationInfoId that is higher signaling included in Table 24. If the terminal is configured with one pucch-spatialRelationInfoId, the beam configuration for PUCCH transmission of the terminal may be provided via one pucch-spatialRelationInfoId. If the terminal is configured with multiple pucch-spatialRelationInfoIDs, the terminal may be indicated to activate one of the multiple pucch-spatialRelationInfoIDs via a MAC control element (CE). The terminal may be configured with up to eight pucch-spatialRelationInfoIDs via higher signaling, and may be indicated to activate only one pucch-spatialRelationInfoID therefrom. If the terminal is indicated to activate any pucch-spatialRelationInfoID via the MAC CE, the terminal may apply pucch-spatialRelationInfoID activation via the MAC CE from a slot that appears first after 3Nₛₗₒₜ^{subframe,μ} slots from a slot for HARQ-ACK transmission with respect to a PDSCH for transmission of the MAC CE including activation information of pucch-spatialRelationInfoID. is a neurology applied to PUCCH transmission, and Nₛₗₒₜ^{subframe,μ} refers to the number of slots per subframe in a given neurology. A higher layer configuration for pucch-spatialRelationInfo may be as shown in Table 30 below.

TABLE 30

| | |
|---|---|
| PUCCH-SpatialRelationInfo ::= | SEQUENCE { |
| pucch-SpatialRelationInfoId | PUCCH-SpatialRelationInfoId, |

servingCellId ServCellIndex
OPTIONAL, -- Need S

| | |
|---|---|
| referenceSignal | CHOICE { |
| ssb-Index | SSB-Index, |

csi-RS-Index NZP-CSI-RS-
ResourceId,

| | |
|---|---|
| srs | PUCCH-SRS |

```
    },
    pucch-PathlossReferenceRS-Id PUCCH-
PathlossReferenceRS-Id,
```

| | |
|---|---|
| p0-PUCCH-Id | P0-PUCCH-Id, |

```
    closedLoopIndex ENUMERATED { i0, i1 }
  }
  PUCCH-SpatialRelationInfoId ::= INTEGER
(1..maxNrofSpatialRelationInfos)
```

According to Table 30, one referenceSignal configuration may exist in a specific pucch-spatialRelationInfo configuration, and the referenceSignal may be ssb-Index indicating a specific SS/PBCH, may be csi-RS-Index indicating a specific CSI-RS, or may be srs indicating a specific SRS. If referenceSignal is configured with ssb-Index, the terminal may configure, as a beam for PUCCH transmission, a beam used when receiving an SS/PBCH corresponding to ssb-Index among SS/PBCHs in the same serving cell, or if servingCellId is provided, a beam used when receiving an SS/PBCH corresponding to ssb-Index among SS/PBCHs in a cell indicated by servingCellId may be configured as the beam for PUCCH transmission. If the referenceSignal is configured with csi-RS-Index, the terminal may configure, as a beam for PUCCH transmission, a beam used when receiving a CSI-RS corresponding to csi-RS-Index among CSI-RSs in the same serving cell, or if servingCellId is provided, a beam used when receiving a CSI-RS corresponding to csi-RS-Index among CSI-RSs in a cell indicated by servingCellId may be configured as the beam for PUCCH transmission. If the referenceSignal is configured with srs, the terminal may configure, as a beam for PUCCH transmission, a transmission beam used when transmitting an SRS corresponding to a resource index provided via a higher signaling resource in the same serving cell and/or in an activated uplink BWP, or if servingCellID and/or uplinkBWP are/is provided, a transmission beam used when transmitting an SRS corresponding to a resource index provided via a higher signaling resource in a cell indicated by servingCellID and/or uplinkBWP and/or in the uplink BWP may be configured as a beam for PUCCH transmission. One pucch-PathlossReferenceRS-Id configuration may exist in a specific pucch-spatialRelationInfo configuration. PUCCH-PathlossReferenceRS of Table 31 man be mapped with pucch-PathlossReferenceRS-Id of Table 30, and up to 4 configurations are possible via pathlossReferenceRSs in higher signaling of PUCCH-PowerControl of Table 31. PUCCH-PathlossReferenceRS may be configured with ssb-Index if connected to an SS/PBCH via higher signaling of referenceSignal, and may be configured with csi-RS-Index if connected to a CSI-RS.

TABLE 31

| | |
|---|---|
| PUCCH-PowerControl ::= | SEQUENCE { |

```
    deltaF-PUCCH-f0 INTEGER (−16..15)
OPTIONAL, -- Need R
    deltaF-PUCCH-f1 INTEGER (−16..15)
OPTIONAL, -- Need R
    deltaF-PUCCH-f2 INTEGER (−16..15)
OPTIONAL, -- Need R
    deltaF-PUCCH-f3 INTEGER (−16..15)
OPTIONAL, -- Need R
    deltaF-PUCCH-f4 INTEGER (−16..15)
OPTIONAL, -- Need R
    p0-Set SEQUENCE (SIZE
(1..maxNrofPUCCH-P0-PerSet)) OF P0-PUCCH OPTIONAL, --
Need M
    pathlossReferenceRSs SEQUENCE (SIZE
(1..maxNrofPUCCH-PathlossReferenceRSs)) OF PUCCH-PathlossReferenceRS
OPTIONAL, -- Need M
    twoPUCCH-PC-AdjustmentStates ENUMERATED {twoStates}
OPTIONAL, -- Need S
    ...,
    [[
    pathlossReferenceRSs-v1610 SetupRelease { PathlossReferenceRSs-
v1610 } OPTIONAL -- Need M
    ]]
  }
```

| | |
|---|---|
| P0-PUCCH ::= | SEQUENCE { |
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |

PathlossReferenceRSs-v1610 ::= SEQUENCE (SIZE
(1..maxNrofPUCCH-PathlossReferenceRSsDiff-r16)) OF PUCCH-
PathlossReferenceRS-r16

| | |
|---|---|
| PUCCH-PathlossReferenceRS ::= | SEQUENCE { |

pucch-PathlossReferenceRS-Id PUCCH-
PathlossReferenceRS-Id,

| | |
|---|---|
| referenceSignal | CHOICE { |
| ssb-Index | SSB-Index, |

```
      csi-RS-Index NZP-CSI-RS-
ResourceId
    }
```

| | |
|---|---|
| } | SEQUENCE { |

```
  PUCCH-PathlossReferenceRS-r16 ::=
    pucch-PathlossReferenceRS-Id-r16 PUCCH-
PathlossReferenceRS-Id-v1610,
```

| | |
|---|---|
| referenceSignal-r16 | CHOICE { |

```
      ssb-Index-r16 SSB-
Index,
      csi-RS-Index-r16 NZP-
CSI-RS-ResourceId
    }
  }
```

PUCCH: Group-Based Spatial Relation Activation

In Rel-15, if multiple pucch-spatialRelationInfoDs are configured, the terminal may receive a MAC CE for activation of a spatial relation for each PUCCH resource, thereby determining a spatial relation of a corresponding PUCCH resource. However, such a method has a disadvantage of requiring a lot of signaling overheads to activate the spatial relation of multiple PUCCH resources. Therefore, in Rel-16, a new MAC CE for adding a PUCCH resource group and activating a spatial relation in units of PUCCH resource groups has been introduced. For the PUCCH resource groups, up to 4 PUCCH resource groups may be configured via resourceGroupToAddModList of Table 24, and for each PUCCH resource group, multiple PUCCH resource TDs in one PUCCH resource group may be configured as a list as shown in Table 32 below.

```
TABLE 32
  PUCCH-ResourceGroup-r16 ::= SEQUENCE {
    pucch-ResourceGroupId-r16 PUCCH-
ResourceGroupId-r16,
    resourcePerGroupList-r16 SEQUENCE (SIZE
(1..maxNrofPUCCH-ResourcesPerGroup-r16)) OF PUCCH-ResourceId
  }
  PUCCH-ResourceGroupId-r16 ::= INTEGER
(0..maxNrofPUCCH-ResourceGroups-1-r16)
```

In Rel-16, the base station may configure each PUCCH resource group for the terminal via resourceGroupToAddModList in Table 24 and the higher layer configuration of Table 32, and may configure a MAC CE for simultaneous activation of spatial relations of all PUCCH resources in one PUCCH resource group.

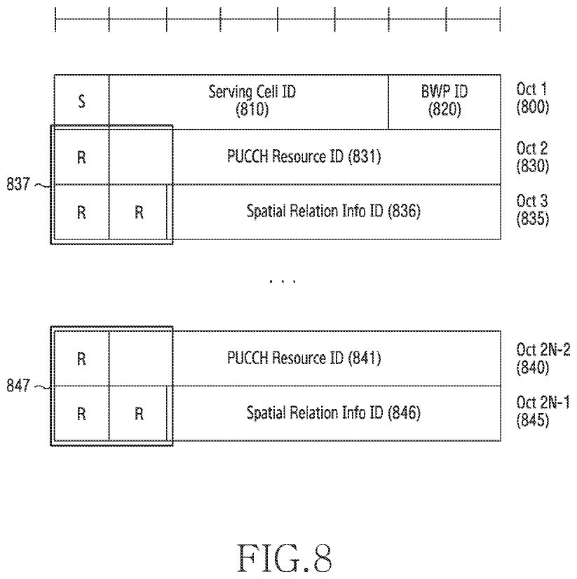

FIG. 8 is a diagram illustrating an example of a MAC CE for PUCCH resource group-based spatial relation activation in the wireless communication system, according to an embodiment.

Referring to the example of FIG. 8, a supported cell ID 810 and a BWP ID 820 configured with PUCCH resources, to which a MAC CE is to be applied, are indicated by Oct 1 800. PUCCH Resource IDs 831 and 841 indicate IDs of PUCCH resources, and if the indicated PUCCH resources are included in a PUCCH resource group according to resourceGroupToAddModList, another PUCCH resource ID in the same PUCCH resource group is not indicated in the same MAC CE, and all PUCCH resources in the same PUCCH resource group are activated with the same Spatial Relation Info IDs 836 and 846. In this case, Spatial Relation Info IDs 836 and 846 include a value corresponding to PUCCH-SpatialRelationInfoId−1 to be applied to the PUCCH resource group of Table 30.

Relating to SRS

A method for uplink channel estimation using sounding reference signal (SRS) transmission of the terminal is described as follows. The base station may configure at least one SRS configuration for each uplink BWP to transfer configuration information for SRS transmission to the terminal, and may also configure at least one SRS resource set for each SRS configuration. As an example, the base station and the terminal may transmit and receive higher signaling information as follows to transfer information on the SRS resource set.
srs-ResourceSetId: an SRS resource set index
srs-ResourceIdList: a set of SRS resource indexes referenced by an SRS resource set
resourceType: a time axis transmission configuration of an SRS resource referenced by an SRS resource set, wherein resourceType may be configured to be one of “periodic”, “semi-persistent”, and “aperiodic”. If resourceType is configured to be “periodic” or “semi-persistent”, associated CSI-RS information may be provided according to a usage of the SRS resource set. If resourceType is configured to be “aperiodic”, an aperiodic SRS resource trigger list and slot offset information may be provided, and associated CSI-RS information may be provided according to a usage of the SRS resource set.
usage: a configuration for a usage of an SRS resource referenced by an SRS resource set, wherein the usage may be configured to be one of “beamManagement”, “codebook”, “nonCodebook”, and “antennaSwitching”.
alpha, p0, pathlossReferenceRS, srs-PowerControlAdjustmentStates: providing parameter configurations for transmission power adjustment of an SRS resource referenced by an SRS resource set.

The terminal may understand that an SRS resource included in a set of SRS resource indexes referenced by an SRS resource set conforms to information included in the SRS resource set.

In addition, the base station and the terminal may transmit or receive higher-layer signaling information in order to transfer individual configuration information for the SRS resource. As an example, the individual configuration information for the SRS resource may include time-frequency axis mapping information within a slot of the SRS resource, which may include information on frequency hopping within a slot or between slots of the SRS resource. In addition, the individual configuration information for the SRS resource may include a time axis transmission configuration of the SRS resource, and may be configured to be one of “periodic”, “semi-persistent”, and “aperiodic”. This may be limited to having the time axis transmission configuration, such as the SRS resource set including the SRS resource. If the time axis transmission configuration of the SRS resource is configured to be “periodic” or “semi-persistent”, an additional SRS resource transmission period and slot offset (e.g., periodicityAndOffset) may be included in the time axis transmission configuration.

The base station may activate, deactivate, or trigger SRS transmission to the terminal via L1 signaling (e.g., DCI) or higher-layer signaling including MAC CE signaling or RRC signaling. For example, the base station may activate or deactivate periodic SRS transmission for the terminal via higher-layer signaling. The base station may indicate to activate an SRS resource set in which resourceType is configured to be periodic via higher-layer signaling, and the terminal may transmit an SRS resource referenced by the activated SRS resource set. Time-frequency axis resource mapping within a slot of the transmitted SRS resource conforms to resource mapping information configured in the SRS resource, and slot mapping including a transmission period and a slot offset conforms to periodicityAndOffset configured in the SRS resource. In addition, a spatial domain transmission filter applied to the transmitted SRS resource may refer to spatial relation info configured in the SRS resource, or may refer to associated CSI-RS information configured in the SRS resource set including the SRS resource. The terminal may transmit the SRS resource in an uplink BWP activated for the periodic SRS resource activated via higher-layer signaling.

For example, the base station may activate or deactivate semi-persistent SRS transmission for the terminal via higher-layer signaling. The base station may indicate to activate an SRS resource set via MAC CE signaling, and the terminal may transmit an SRS resource referenced by the activated SRS resource set. The SRS resource set activated via MAC CE signaling may be limited to the SRS resource set in which resourceType is configured to be semi-persistent. Time-frequency axis resource mapping within a slot of the transmitted SRS resource conforms to resource mapping information configured in the SRS resource, and slot mapping including a transmission period and a slot offset conforms to periodicityAndOffset configured in the SRS resource. In addition, a spatial domain transmission filter applied to the transmitted SRS resource may refer to spatial relation info configured in the SRS resource, or may refer to associated CSI-RS information configured in the SRS resource set including the SRS resource. If spatial relation info is configured in the SRS resource, instead of conforming to the same, the spatial domain transmission filter may be determined by referring to configuration information on spatial relation info transferred via MAC CE signaling for activation of semi-persistent SRS transmission. The terminal may transmit the SRS resource in an uplink BWP activated for the semi-persistent SRS resource activated via higher-layer signaling.

For example, the base station may trigger aperiodic SRS transmission to the terminal via DCI. The base station may indicate one of aperiodic SRS resource triggers (aperiodicSRS-ResourceTrigger) via an SRS request field of the DCI. The terminal may understand that an SRS resource set has been triggered, the SRS resource set including an aperiodic SRS resource trigger indicated via the DCI in an aperiodic SRS resource trigger list in configuration information of the SRS resource set. The terminal may transmit an SRS resource referenced by the triggered SRS resource set. Time-frequency axis resource mapping within a slot of the transmitted SRS resource conforms to resource mapping information configured in the SRS resource. In addition, slot mapping of the transmitted SRS resource may be determined via a slot offset between a PDCCH including the DCI and the SRS resource, which may refer to value(s) included in a slot offset set configured in the SRS resource set. Specifically, the slot offset between the PDCCH including the DCI and the SRS resource, a value indicated by a time domain resource assignment field of the DCI from among offset value(s) included in the slot offset set configured in the SRS resource set may be applied. In addition, a spatial domain transmission filter applied to the transmitted SRS resource may refer to spatial relation info configured in the SRS resource, or may refer to associated CSI-RS information configured in the SRS resource set including the SRS resource. The terminal may transmit the SRS resource in an uplink BWP activated for the aperiodic SRS resource triggered via the DCI.

When the base station triggers aperiodic SRS transmission to the terminal via the DCI, in order for the terminal to transmit an SRS by applying configuration information for the SRS resource, a minimum time interval between a PDCCH including the DCI triggering aperiodic SRS transmission and the transmitted SRS may be required. A time interval for SRS transmission of the terminal may be defined to be the number of symbols between the last symbol of the PDCCH including the DCI triggering aperiodic SRS transmission and the first symbol to which a first transmitted SRS resource among the transmitted SRS resource(s) is mapped. The minimum time interval may be determined by referring to a PUSCH preparation procedure time required for the terminal to prepare for PUSCH transmission. In addition, the minimum time interval may have a different value depending on a usage of the SRS resource set including the transmitted SRS resource. For example, the minimum time interval may be defined to be N2 symbols defined in consideration of terminal processing capability according to the capability of the terminal by referring to the PUSCH preparation procedure time of the terminal. In addition, if the usage of the SRS resource set is configured to be “codebook” or “antennaSwitching” in consideration of the usage of the SRS resource set including the transmitted SRS resource, the minimum time interval may be determined to be N2 symbols, and if the usage of the SRS resource set is configured to be “nonCodebook” or “beamManagement”, the minimum time interval may be determined to be N2+14 symbols. If the time interval for aperiodic SRS transmission is greater than or equal to the minimum time interval, the terminal may transmit an aperiodic SRS, and if the time interval for aperiodic SRS transmission is less than the minimum time interval, the terminal may disregard the DCI triggering an aperiodic SRS.

TABLE 33

| SRS-Resource ::= | SEQUENCE { |
|---|---|
| srs-ResourceId | SRS-ResourceId, |
| nrofSRS-Ports ENUMERATED {port1, | |
| ports2, ports4}, | |
| ptrs-PortIndex ENUMERATED {n0, n1 } | |
| OPTIONAL, -- Need R | |
| transmissionComb | CHOICE { |
| n2 | SEQUENCE { |
| combOffset-n2 INTEGER | |
| (0..1), | |
| cyclicShift-n2 | INTEGER (0..7) |
| }, | |
| n4 | SEQUENCE { |
| combOffset-n4 INTEGER | |
| (0..3), | |
| cyclicShift-n4 | INTEGER (0..11) |
| } | |
| }, | |
| resourceMapping | SEQUENCE { |
| startPosition | INTEGER (0..5), |
| nrofSymbols ENUMERATED | |
| {n1, n2, n4}, | |
| repetitionFactor ENUMERATED {n1, | |
| n2, n4} | |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping ENUMERATED | |
| { neither, groupHopping, sequenceHopping }, | |
| resourceType | CHOICE { |
| aperiodic | SEQUENCE { |
| ... | |
| }, | |
| semi-persistent | SEQUENCE { |
| periodicityAndOffset-sp SRS- | |
| PeriodicityAndOffset, | |
| ... | |
| }, | |
| periodic | SEQUENCE { |
| periodicityAndOffset-p SRS- | |
| PeriodicityAndOffset, | |
| ... | |
| } | |
| }, | |
| sequenceId | INTEGER (0..1023), |

```
    spatialRelationInfo SRS-SpatialRelationInfo
OPTIONAL, -- Need R
    ...
  }
```

The spatialRelationInfo configuration information in Table 33 refers to one reference signal and applies beam information of the reference signal to a beam used for corresponding SRS transmission. For example, the configuration of spatialRelationInfo may include information as shown in Table 34 below.

TABLE 34

| SRS-SpatialRelationInfo ::= | SEQUENCE { |
|---|---|
| servingCellId ServCellIndex | |
| OPTIONAL, -- Need S | |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
      }
    }
  }
```

Referring to the spatialRelationInfo configuration, an SS/PBCH block index, a CSI-RS index, or an SRS index may be configured as an index of a reference signal to be referenced in order to use beam information of a specific reference signal. Higher signaling referenceSignal is configuration information indicating beam information of which reference signal is to be referenced for corresponding SRS transmission, ssb-Index refers to an SS/PBCH block index, csi-RS-Index refers to a CSI-RS index, and srs refers to an SRS index. If a value of higher signaling referenceSignal is configured to be “ssb-Index”, the terminal may apply, as a transmission beam of the SRS transmission, a reception beam used when receiving an SS/PBCH block corresponding to ssb-Index. If the value of higher signaling referenceSignal is configured to be “csi-RS-Index”, the terminal may apply, as a transmission beam of the SRS transmission, a reception beam used when receiving a CSI-RS corresponding to csi-RS-Index. If the value of higher signaling referenceSignal is configured to be “srs”, the terminal may apply, as a transmission beam of the SRS transmission, a transmission beam used when transmitting an SRS corresponding to srs.

PUSCH: Relating to Transmission Scheme

Next, a scheduling scheme of PUSCH transmission is described. PUSCH transmission may be dynamically scheduled by a UL grant in DCI or may be operated by configured grant Type 1 or Type 2. Dynamic scheduling indication for PUSCH transmission is possible with DCI format 0_0 or 0_1.

For configured grant Type 1 PUSCH transmission, the UL grant in DCI may not be received, and configuration may be performed semi-statically via reception of configuredGrantConfig including rrc-ConfiguredUplinkGrant of Table 35 via higher signaling. Configured grant Type 2 PUSCH transmission may be semi-persistently scheduled by the UL grant in DCI after reception of configuredGrantConfig that does not include rrc-ConfiguredUplinkGrant of Table 35 via higher signaling. When PUSCH transmission is operated by the configured grant, parameters applied to PUSCH transmission are applied via configuredGrantConfig that is higher signaling in Table 38, except for dataScramblingIdentityPUSCH, txConfig, codebookSubset, maxRank, and scaling of UCI-OnPUSCH provided via pusch-Config that is higher signaling in Table 36. If the terminal is provided with transformPrecoder in configuredGrantConfig which is higher signaling in Table 35, the terminal applies tp-pi2BPSK in pusch-Config of Table 36 to PUSCH transmission operated by the configured grant.

TABLE 35

| | |
|---|---|
| ConfiguredGrantConfig ::= | SEQUENCE { |

frequencyHopping ENUMERATED {intraSlot,

| | |
|---|---|
| interSlot} | OPTIONAL, -- Need S, |
| cg-DMRS-Configuration | DMRS-UplinkConfig, |

```
    mcs-Table ENUMERATED {qam256,
qam64LowSE} OPTIONAL, --
Need S
    mcs-TableTransformPrecoder ENUMERATED {qam256,
qam64LowSE} OPTIONAL, --
Need S
    uci-OnPUSCH SetupRelease { CG-UCI-
OnPUSCH } OPTIONAL, --
Need M
    resourceAllocation ENUMERATED
{ resourceAllocationType0, resourceAllocationType1, dynamicSwitch },
    rbg-Size ENUMERATED {config2}
OPTIONAL, -- Need S
```

| | |
|---|---|
| powerControlLoopToUse | ENUMERATED {n0, n1}, |
| p0-PUSCH-Alpha | P0-PUSCH-AlphaSetId, |

transformPrecoder ENUMERATED {enabled,
disabled} OPTIONAL, -- Need
S

| | |
|---|---|
| nrofHARQ-Processes | INTEGER(1..16), |

```
    repK ENUMERATED {n1, n2, n4,
n8},
    repK-RV ENUMERATED {s1-0231,
s2-0303, s3-0000} OPTIONAL, -- Need R
```

| | |
|---|---|
| periodicity | ENUMERATED { |
| | sym2, sym7, |

sym1x14, sym2x14, sym4x14, sym5x14, sym8x14, sym10x14, sym16x14, sym20x14,

sym32x14,

sym40x14, sym64x14, sym80x14, sym128x14, sym160x14, sym256x14, sym320x14,
sym512x14,

sym640x14,

sym1024x14, sym1280x14, sym2560x14, sym5120x14,

sym6, sym1x12,

sym2x12, sym4x12, sym5x12, sym8x12, sym10x12, sym16x12, sym20x12, sym32x12,

sym40x12,

sym64x12, sym80x12, sym128x12, sym160x12, sym256x12, sym320x12, sym512x12,
sym640x12,

sym1280x12,

```
sym2560×12
    },
    configuredGrantTimer INTEGER (1..64)
OPTIONAL, -- Need R
```

| | |
|---|---|
| rrc-ConfiguredUplinkGrant | SEQUENCE { |
| timeDomainOffset | INTEGER (0..5119), |
| timeDomainAllocation | INTEGER (0..15), |

frequencyDomainAllocation BIT STRING
(SIZE(18)),

| | |
|---|---|
| antennaPort | INTEGER (0..31), |

dmrs-SeqInitialization INTEGER (0..1)
OPTIONAL, -- Need R

| | |
|---|---|
| precodingAndNumberOfLayers | INTEGER (0..63), |

```
      srs-ResourceIndicator INTEGER (0..15)
OPTIONAL, -- Need R
      mcsAndTBS INTEGER (0..31),
      frequencyHoppingOffset INTEGER (1..
maxNrofPhysicalResourceBlocks−1) OPTIONAL, -- Need R
      pathlossReferenceIndex INTEGER
(0..maxNrofPUSCH-PathlossReferenceRSs−1),
      ...
    }
OPTIONAL,  -- Need R
    ...
  }
```

Next, a PUSCH transmission method is described. A DMRS antenna port for PUSCH transmission is the same as an antenna port for SRS transmission. PUSCH transmission may conform to each of a codebook-based transmission method and a non-codebook-based transmission method, depending on whether a value of txConfig in pusch-Config of Table 36], which is higher signaling, is “codebook” or “nonCodebook”.

As described above, PUSCH transmission may be dynamically scheduled via DCI format 0_0 or 0_1, and may be semi-statically configured by a configured grant. If the terminal is indicated with scheduling for PUSCH transmission via DCI format 0_0, the terminal performs beam configuration for PUSCH transmission by using pucch-spatialRelationInfoID corresponding to a UE-specific PUCCH resource which corresponds to a minimum TD within an enabled uplink BWP in a serving cell, in which case the PUSCH transmission is based on a single antenna port. The terminal does not expect scheduling for PUSCH transmission via DCI format 0_0, within a BWP in which a PUCCH resource including pucch-spatialRelationInfo is not configured. If the terminal is not configured with txConfig in pusch-Config of Table 36, the terminal does not expect to be scheduled via DCI format 0_1.

TABLE 36

| | |
|---|---|
| PUSCH-Config ::= | SEQUENCE { |

```
    dataScramblingIdentityPUSCH INTEGER (0..1023)
OPTIONAL, -- Need S
    txConfig ENUMERATED
{codebook, nonCodebook} OPTIONAL, -
- Need S
    dmrs-UplinkForPUSCH-MappingTypeA SetupRelease { DMRS-
```

| | |
|---|---|
| UplinkConfig } | OPTIONAL, -- Need M |

dmrs-UplinkForPUSCH-MappingTypeB SetupRelease { DMRS-

| | |
|---|---|
| UplinkConfig } | OPTIONAL, -- Need M |

```
    pusch-PowerControl PUSCH-PowerControl
OPTIONAL, -- Need M
    frequencyHopping ENUMERATED
{intraSlot, interSlot} OPTIONAL, --
Need S
    frequencyHoppingOffsetLists SEQUENCE (SIZE (1..4))
OF INTEGER (1..maxNrofPhysicalResourceBlocks−1)
OPTIONAL, -- Need M
    resourceAllocation ENUMERATED
{ resourceAllocationType0, resourceAllocationType1, dynamicSwitch},
    pusch-TimeDomainAllocationList SetupRelease { PUSCH-
```

| | |
|---|---|
| TimeDomainResourceAllocationList } | OPTIONAL, -- Need M |

pusch-AggregationFactor ENUMERATED { n2, n4,

| | |
|---|---|
| n8 } | OPTIONAL, -- Need S |

```
    mcs-Table ENUMERATED
{qam256, qam64LowSE} OPTIONAL,
-- Need S
    mcs-TableTransformPrecoder ENUMERATED {qam256,
qam64LowSE} OPTIONAL, -- Need
S
    transformPrecoder ENUMERATED {enabled,
```

| | |
|---|---|
| disabled} | OPTIONAL, -- Need S |

```
    codebookSubset ENUMERATED
{fullyAndPartialAndNonCoherent, partialAndNonCoherent,nonCoherent}
OPTIONAL, -- Cond codebookBased
    maxRank INTEGER (1..4)
OPTIONAL, -- Cond codebookBased
    rbg-Size ENUMERATED
```

| | |
|---|---|
| { config2} | OPTIONAL, -- Need S |

uci-OnPUSCH SetupRelease { UCI-

| | |
|---|---|
| OnPUSCH} | OPTIONAL, -- Need M |

tp-pi2BPSK ENUMERATED

| | |
|---|---|
| {enabled} | OPTIONAL, -- Need S |

```
    ...
  }
```

Next, codebook-based PUSCH transmission is described. Codebook-based PUSCH transmission may be dynamically scheduled via DCI format 0_0 or 0_1 and may operate semi-statically by a configured grant. If a codebook-based PUSCH is dynamically scheduled by DCI format 0_1 or is configured semi-statically by a configured grant, the terminal determines a precoder for PUSCH transmission, based on an SRS resource indicator (SRI), a transmission precoding matrix indicator (TPMI), and a transmission rank (the number of PUSCH transmission layers).

In this case, the SRI may be given via a field, SRS resource indicator, in DCI or may be configured via srs-ResourceIndicator that is higher signaling. The terminal is configured with at least one SRS resource at codebook-based PUSCH transmission, and may be configured with up to two SRS resources. When the terminal is provided with the SRI via DCI, an SRS resource indicated by the SRI refers to an SRS resource corresponding to the SRI from among SRS resources transmitted before a PDCCH including the SRI. The TPMI and the transmission rank may be given via a field, precoding information and number of layers, in DCI or may be configured via precodingAndNumberOfLayers that is higher signaling. The TPMI is used to indicate a precoder applied to PUSCH transmission. If the terminal is configured with one SRS resource, the TPMI is used to indicate a precoder to be applied in the configured one SRS resource. If the terminal is configured with multiple SRS resources, the TPMI is used to indicate a precoder to be applied in the SRS resource indicated via the SRI.

A precoder to be used for PUSCH transmission is selected from an uplink codebook having the same number of antenna ports as a value of nrofSRS-Ports in SRS-Config which is higher signaling. In codebook-based PUSCH transmission, the terminal determines a codebook subset, based on codebookSubset in pusch-Config which is higher signaling and the TPMI. codebookSubset in pusch-Config which is higher signaling may be configured to be one of “fullyAndPartialAndNonCoherent”, “partialAndNonCoherent”, or “nonCoherent”, based on UE capability reported to the base station by the terminal. If the terminal has reported “partialAndNonCoherent” as UE capability, the terminal does not expect a value of codebookSubset, which is higher signaling, to be configured to “fullyAndPartialAndNonCoherent”. If the terminal has reported “nonCoherent” as UE capability, the terminal expects the value of codebookSubset, which is higher signaling, to be configured to neither “fullyAndPartialAndNonCoherent” nor “partialAndNonCoherent”. If nrofSRS-Ports in SRS-ResourceSet which is higher signaling indicates two SRS antenna ports, the terminal does not expect the value of codebookSubset, which is higher signaling, to be configured to “partialAndNonCoherent”.

The terminal may be configured with one SRS resource set, in which a value of usage in SRS-ResourceSet that is higher signaling is configured to “codebook”, and one SRS resource in the corresponding SRS resource set may be indicated via the SRI. If multiple SRS resources are configured in the SRS resource set in which the usage value in SRS-ResourceSet that is higher signaling is configured to “codebook”, the terminal expects that the value of nrofSRS-Ports in SRS-Resource that is higher signaling is configured to be the same for all SRS resources.

The terminal transmits one or multiple SRS resources included in the SRS resource set, in which the value of usage is configured to “codebook”, to the base station according to higher signaling, and the base station selects one of the SRS resources transmitted by the terminal and indicates the terminal to perform PUSCH transmission using transmission beam information of the corresponding SRS resource. In this case, in codebook-based PUSCH transmission, the SRI is used as information for selecting of an index of one SRS resource and is included in the DCI. Additionally, the base station adds, to the DCI, information indicating the rank and TPMI to be used by the terminal for PUSCH transmission. The terminal uses the SRS resource indicated by the SRI to perform PUSCH transmission by applying the precoder indicated by the TPMI and the rank, which has been indicated based on a transmission beam of the SRS resource.

Next, non-codebook-based PUSCH transmission is described. Non-codebook-based PUSCH transmission may be dynamically scheduled via DCI format 0_0 or 0_1 and may operate semi-statically by a configured grant. If at least one SRS resource is configured in an SRS resource set, in which the value of usage in SRS-ResourceSet that is higher signaling is configured to “nonCodebook”, the terminal may be scheduled for non-codebook-based PUSCH transmission via DCI format 0_1.

For the SRS resource set in which the value of usage in SRS-ResourceSet that is higher signaling is configured to “nonCodebook”, the terminal may be configured with one connected non-zero power (NZP) CSI-RS resource. The terminal may perform calculation on a precoder for SRS transmission via measurement for the NZP CSI-RS resource connected to the SRS resource set. If a difference between a last reception symbol of an aperiodic NZP CSI-RS resource connected to the SRS resource set and a first symbol of aperiodic SRS transmission in the terminal is less than 42 symbols, the terminal does not expect information on the precoder for SRS transmission to be updated.

If a value of resourceType in SRS-ResourceSet that is higher signaling is configured to “aperiodic”, the connected NZP CSI-RS is indicated via an SRS request which is a field in DCI format 0_1 or 1_1. In this case, if the connected NZP CSI-RS resource is an aperiodic NZP CSI-RS resource, the presence of the connected NZP CSI-RS in a case where a value of the field, SRS request, in DCI format 0_1 or 1_1 is not “00” is indicated. In this case, the corresponding DCI should indicate neither a cross carrier nor cross BWP scheduling. If the value of the SRS request indicates the presence of the NZP CSI-RS, the NZP CSI-RS is located in a slot in which a PDCCH including the SRS request field has been transmitted. TCI states configured in scheduled subcarriers are not configured to QCL-TypeD.

If a periodic or semi-persistent SRS resource set is configured, the connected NZP CSI-RS may be indicated via associated CSI-RS in SRS-ResourceSet that is higher signaling. For non-codebook-based transmission, the terminal does not expect that spatialRelationInfo, which is higher signaling for the SRS resource, and associated CSI-RS in SRS-ResourceSet that is higher signaling are configured together.

If multiple SRS resources are configured, the terminal may determine the precoder and transmission rank to be applied to PUSCH transmission, based on the SRI indicated by the base station. The SRI may be indicated via the field, SRS resource indicator, in DCI or may be configured via srs-ResourceIndicator that is higher signaling. Like the aforementioned codebook-based PUSCH transmission, when the terminal receives the SRI via the DCI, the SRS resource indicated by the SRI refers to an SRS resource corresponding to the SRI from among SRS resources transmitted before the PDCCH including the SRI. The terminal may use one or multiple SRS resources for SRS transmission, and the maximum number of SRS resources simultaneously transmittable in the same symbol within one SRS resource set is determined by UE capability reported to the base station by the terminal. In this case, the SRS resources that the terminal simultaneously transmits occupy the same RB. The terminal configures one SRS port for each SRS resource. Only one SRS resource set, in which the value of usage in SRS-ResourceSet that is higher signaling is configured to “nonCodebook”, may be configured, and up to 4 SRS resources for the non-codebook-based PUSCH transmission may be configured.

The base station transmits one NZP CSI-RS connected to the SRS resource set to the terminal, and the terminal calculates, based on a result of measurement at reception of the NZP CSI-RS, the precoder to be used during transmission of one or multiple SRS resources in the SRS resource set. The terminal applies the calculated precoder when transmitting, to the base station, one or multiple SRS resources in the SRS resource set in which usage is configured to “nonCodebook”, and the base station selects one or multiple SRS resources from among the received one or multiple SRS resources. In non-codebook-based PUSCH transmission, the SRI refers to an index capable of representing one SRS resource or a combination of multiple SRS resources, and the SRI is included in the DCI. The number of SRS resources indicated by the SRI transmitted by the base station may be the number of transmission layers of the PUSCH, and the terminal transmits the PUSCH by applying, to each layer, the precoder applied to SRS resource transmission.

PUSCH: Preparation Procedure Time

Next, a PUSCH preparation procedure time is described. If the base station uses DCI format 0_0, 0_1, or 0_2 to schedule the terminal to transmit the PUSCH, the terminal may require a PUSCH preparation procedure time for transmitting the PUSCH by applying a transmission method (a transmission precoding method of an SRS resource, the number of transmission layers, and a spatial domain transmission filter) indicated via the DCI. In NR, the PUSCH preparation procedure time is defined in consideration of the same. The PUSCH preparation procedure time of the terminal may follow Equation (2) below.

Tproc,2=max((N2+d2,1+d2)(2048+144)κ2−μTc+Text+Tswitch,d2,2) (2)

In Tproc,2 described above with Equation (2), each variable may have the following meaning.
N2: The number of symbols determined according to UE processing capability 1 or 2 and numerology according to capability of the terminal. If UE processing capability 1 is reported according to a capability report of the terminal, N2 may have values of Table 37, and if UE processing capability 2 is reported and it is configured, via higher-layer signaling, that UE processing capability 2 is available, N2 may have values of Table 38.

TABLE 37

| | PUSCH preparation time N₂ |
|---|---|
| μ | [symbols] |
| 0 | 10 |
| 1 | 12 |
| 2 | 23 |
| 3 | 36 |

TABLE 38

| | PUSCH preparation time N₂ |
|---|---|
| μ | [symbols] |
| 0 | 5 |
| 1 | 5.5 |
| 2 | 11 for frequency range 1 |

d2,1: the number of symbols determined to be 0 if all resource elements of a first OFDM symbol of PUSCH transmission are configured to include only DM-RS, and the number of symbols determined to be 1 otherwise.
κ: 64
μ: μ follows one of μ_{DL} or μ_{UL}, at which Tproc,2 has a greater value. μ_{DL} indicates a numerology of a downlink in which a PDCCH including DCI for scheduling of a PUSCH is transmitted, and μ_{UL} indicates a numerology of an uplink in which a PUSCH is transmitted.
Tc: Tc has 1/(Δfₘₐₓ·N_{f}), Δfₘₐₓ=480·10³ Hz, and N_{f}=4096.
d2,2: d2,2 follows a BWP switching time when DCI for scheduling of a PUSCH indicates BWP switching, and has 0 otherwise.
d2: When OFDM symbols of a PUCCH having a low priority index, a PUSCH having a high priority index, and a PUCCH overlap in time, a value of d2 of the PUSCH having the high priority index is used. Otherwise, d2 is 0.
Text: When the terminal uses a shared spectrum channel access scheme, the terminal may calculate Text and apply the same to a PUSCH preparation procedure time. Otherwise, Text is assumed to be 0.
Tswitch: If an uplink switching interval is triggered, Tswitch is assumed to be a switching interval time. Otherwise, Tswitch is assumed to be 0.

The base station and the terminal determine that the PUSCH preparation procedure time is not sufficient when a first symbol of the PUSCH starts before a first uplink symbol in which a CP starts after Tproc,2 from a last symbol of the PDCCH including the DCI for scheduling of the PUSCH, in consideration of time axis resource mapping information of the PUSCH scheduled via the DCI and a timing advance effect between the uplink and the downlink. Otherwise, the base station and the terminal determine that the PUSCH preparation procedure time is sufficient. If the PUSCH preparation procedure time is sufficient, the terminal transmits the PUSCH, and if the PUSCH preparation procedure time is not sufficient, the terminal may disregard the DCI for scheduling of the PUSCH.

PUSCH: Relating to Transmission

Hereinafter, repeated transmission of an uplink data channel in the 5G system is described as follows. In the 5G system, repeated PUSCH transmission type A and repeated PUSCH transmission type B are supported as two types of the method for repeated transmission of an uplink data channel. The terminal may be configured with one of repeated PUSCH transmission type A or B via higher-layer signaling.

1. Repeated PUSCH Transmission Type A

As described above, a symbol length of an uplink data channel and a position of a start symbol are determined by a time domain resource allocation method within one slot, and the base station may notify the terminal of the number of repeated transmissions via higher-layer signaling (e.g., RRC signaling) or L1 signaling (e.g., DCI).

The terminal may repeatedly transmit an uplink data channel, which has the same length and start symbol as those of the configured uplink data channel, in consecutive slots, based on the number of repeated transmissions received from the base station. In this case, when at least one symbol among symbols of the uplink data channel configured for the terminal or in the slot configured for uplink for the terminal is configured to be downlink, the terminal omits uplink data channel transmission, but counts the number of repeated transmissions of the uplink data channel.

2. Repeated PUSCH Transmission Type B

As described above, a start symbol and a length of an uplink data channel are determined by the time domain resource allocation method within one slot, and the base station may notify the terminal of the number of repeated transmissions, numberofrepetitions, via higher-layer signaling (e.g., RRC signaling) or L1 signaling (e.g., DCI).

First, nominal repetition of the uplink data channel is determined as follows, based on the configured start symbol and length of the uplink data channel. A slot in which n-th nominal repetition starts is given by

$${K}_{s} + ⌊ \frac{S + n \cdot L}{{N}_{symb}^{slot}} ⌋ ,$$

and a symbol starting in the slot is given by mod(S+n·L,N_{symb}^{slot}). A slot in which n-th nominal repetition ends is given by

$${K}_{s} + ⌊ \frac{S + ( n + 1 ) \cdot L - 1}{{N}_{symb}^{slot}} ⌋ ,$$

and a symbol ending in the slot is given by mod(S+(n+1)·L−1,N_{symb}^{slot}). Here, n=0, . . . , numberofrepetitions−1, S is the configured start symbol of the uplink data channel, and L indicates the configured symbol length of the uplink data channel. Kₛ indicates a slot in which PUSCH transmission starts, and N_{symb}^{slot} indicates the number of symbols per slot.

The terminal determines an invalid symbol for repeated PUSCH transmission type B. A symbol configured for downlink by tdd-UL-DL-ConfigurationCommon or tdd-UL-DL-ConfigurationDedicated is determined as an invalid symbol for repeated PUSCH transmission type B. In addition, an invalid symbol may be configured by a higher-layer parameter (e.g., InvalidSymbolPattern). A higher-layer parameter (e.g., InvalidSymbolPattern) provides a symbol level bitmap over one slot or two slots so that an invalid symbol may be configured. 1 in the bitmap indicates an invalid symbol. In addition, a period and a pattern of the bitmap may be configured via a higher-layer parameter (e.g., periodicityAndPattern). If the higher-layer parameter (e.g., InvalidSymbolPattern) is configured and parameter InvalidSymbolPatternIndicator-ForDCIFormat0_1 or InvalidSymbolPatternIndicator-ForDCIFormat0_2 indicates 1, the terminal applies an invalid symbol pattern, and if the parameter indicates 0, the terminal does not apply the invalid symbol pattern. If the higher-layer parameter (e.g., InvalidSymbolPattern) is configured and parameter InvalidSymbolPatternIndicator-ForDCIFormat0_1 or InvalidSymbolPatternIndicator-ForDCIFormat0_2 is not configured, the terminal applies the invalid symbol pattern.

After an invalid symbol is determined, for each nominal repetition, the terminal may consider symbols other than the invalid symbol to be valid symbols. If one or more valid symbol are included in each nominal repetition, the nominal repetition may include one or more actual repetitions. Here, each actual repetition includes “a consecutive set of” valid symbols available for repeated PUSCH transmission type B within one slot.

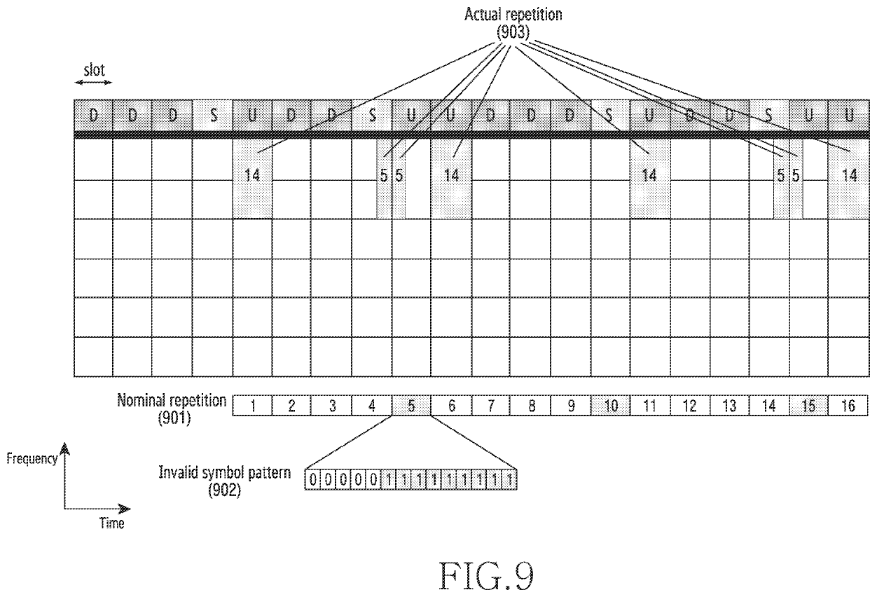

FIG. 9 is a diagram illustrating an example of repeated PUSCH transmission type B in the wireless communication system, according to an embodiment.

For a terminal, a start symbol S of an uplink data channel may be configured to be 0, a length L of the uplink data channel may be configured to be 14, and the number of repeated transmissions may be configured to be 16. In this case, nominal repetition 901 is indicated in 16 consecutive slots. Then, the terminal may determine, as an invalid symbol, a symbol configured to be a downlink symbol in each nominal repetition 901. In addition, the terminal determines, as invalid symbols, symbols configured to be 1 in an invalid symbol pattern 902. In each nominal repetition, if valid symbols that are not invalid symbols include one or more consecutive symbols in one slot, actual repetition 903 is configured and transmission is performed.

In addition, with respect to repeated PUSCH transmission, in NR Release 16, the following additional methods may be defined for UL grant-based PUSCH transmission and configured grant-based PUSCH transmission over slot boundaries.
Method 1 (mini-slot level repetition): Via one UL grant, two or more repeated PUSCH transmissions are scheduled within one slot or over boundaries of consecutive slots. In addition, with respect to Method 1, time domain resource allocation information in DCI indicates a resource of a first repeated transmission. In addition, time domain resource information of the remaining repeated transmissions may be determined according to time domain resource information of the first repeated transmission and an uplink or downlink direction determined for each symbol of each slot. Each repeated transmission occupies consecutive symbols.
Method 2 (multi-segment transmission): Via one UL grant, two or more repeated PUSCH transmissions are scheduled in consecutive slots. In this case, one transmission is designated for each slot, and start points or repetition lengths may be different for each transmission. In addition, with respect to Method 2, time domain resource allocation information in the DCI indicates start points and repetition lengths of all repeated transmissions. In addition, when repeated transmission is performed within a single slot via Method 2, if there are multiple bundles of consecutive uplink symbols in the slot, each repeated transmission is performed for each bundle of uplink symbols. If a bundle of consecutive uplink symbols exists uniquely in the slot, one repeated PUSCH transmission is performed according to the method of NR Release 15.
Method 3: Via two or more UL grants, two or more repeated PUSCH transmissions are scheduled in consecutive slots. In this case, one transmission is designated for each slot, and an n-th UL grant may be received before PUSCH transmission scheduled via an (n−1)th UL grant ends.
Method 4: Via one UL grant or one configured grant, one or multiple repeated PUSCH transmissions within a single slot, or two or more repeated PUSCH transmissions over the boundaries of consecutive slots may be supported. The number of repetitions indicated to the terminal by the base station is merely a nominal value, and the number of repeated PUSCH transmissions actually performed by the terminal may be greater than the nominal number of repetitions. Time domain resource allocation information in DCI or in the configured grant refers to a resource of a first repeated transmission indicated by the base station. Time domain resource information of the remaining repeated transmissions may be determined by referring, at least in part, to resource information of the first repeated transmission and uplink or downlink directions of symbols. If the time domain resource information of repeated transmission indicated by the base station spans a slot boundary or includes an uplink/downlink switching point, the repeated transmission may be divided into multiple repeated transmissions. In this case, one repeated transmission may be included for each uplink period in one slot.

PUSCH: Frequency Hopping Procedure

Hereinafter, frequency hopping of an uplink data channel (PUSCH) in the 5G system is described in detail.

In 5G, as a frequency hopping method of an uplink data channel, two methods are supported for each repeated PUSCH transmission type. First, repeated PUSCH transmission type A supports intra-slot frequency hopping and inter-slot frequency hopping, and repeated PUSCH transmission type B supports inter-repetition frequency hopping and inter-slot frequency hopping.

The intra-slot frequency hopping method supported by repeated PUSCH transmission type A is a method by which the terminal changes an allocated resource of the frequency domain by a configured frequency offset in two hops within one slot and performs transmission. In intra-slot frequency hopping, a starting RB of each hop may be expressed via Equation (3) below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad ( 3 )$$

In Equation (3), i=0 and i=1 indicate a first hop and a second hop, respectively, and RBₛₜₐᵣₜ indicates a starting RB in a UL BWP and is calculated based on a frequency resource allocation method. RB_{offset} indicates a frequency offset between two hops via a higher-layer parameter. The number of symbols of the first hop may be indicated by └N_{symb}^{PUSCH,s}/2┘, and the number of symbols of the second hop may be indicated by N_{symb}^{PUSCH,s}−└N_{symb}^{PUSCH,s}/2┘. N_{symb}^{PUSCH,s} is a length of PUSCH transmission within one slot and is represented by the number of OFDM symbols.

In the following, the inter-slot frequency hopping method supported by repeated PUSCH transmission types A and B is a method in which the terminal changes an allocated resource of the frequency domain by a configured frequency offset for each slot and performs transmission. In inter-slot frequency hopping, during nₛ^{μ} slots, a starting RB may be expressed via Equation (4) below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad ( 4 )$$

In Equation (4), nₛ^{μ} indicates a current slot number in multi-slot PUSCH transmission, and RBₛₜₐᵣₜ indicates a starting RB in a UL BWP and is calculated based on the frequency resource allocation method. RB_{offset} indicates a frequency offset between two hops via a higher-layer parameter.

Next, the inter-repetition frequency hopping method supported by repeated PUSCH transmission type B includes performing transmission by moving resources allocated on the frequency domain as much as a configured frequency offset for one or multiple actual repetitions within each nominal repetition. RBstart(n), which is an index of a starting RB in the frequency domain for one or multiple actual repetitions within an n-th nominal repetition, may conform to Equation (5) below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad ( 5 )$$

In Equation (5), n indicates an index of nominal repetition, and RB_{offset} indicates an RB offset between two hops via a higher-layer parameter.

Rate Matching for UCI Multiplexed on PUSCH

Hereinafter, rate matching for UCI in the 5G system is described in detail. First, before rate matching for UCI is described, a case in which UCI is multiplexed to a PUSCH is described. The terminal transmits multiple overlapping PUCCH(s) or overlapping PUCCH(s) and PUSCH(s) in one slot, the terminal is configured to multiplex different UCI types on one PUCCH, and if at least one of the multiple overlapping PUCCH(s) or PUSCH(s) is a signal transmitted upon reception of a DCI format by the terminal, the terminal may multiplex all corresponding UCI types that satisfy the timeline condition as described in detail in the following clause 9.2.5 of 3GPP standard TS 38.213. As an example of the timeline condition for UCI multiplexing, if one of PUCCH transmission or PUSCH transmission is scheduled via DCI, the terminal may perform UCI multiplexing only if a first symbol of the earliest PUCCH or PUSCH among the PUCCH and PUSCH overlapping in the slot satisfies the following conditions:

S0 is not a symbol transmitted prior to a symbol including a CP starting after T_{proc,1}^{mux} from the last symbol of a corresponding PDSCH. Here, T_{proc,1}^{mux} is a maximum value of {T_{proc,1}^{mux,1}, . . . , T_{proc,1}^{mux,i}, . . . } for an i-th PDSCH associated with HARQ-ACK transmitted on a PUCCH in an overlapping PUCCH and PUSCH group. T_{proc,1}^{mux,i} is a processing procedure time for the i-th PDSCH and is defined to be T_{proc,1}^{mux,i}=(N₁+d_{1,1})*(2048+144)*κ*2^{-μ}*T_{C}. Here, d_{1,1} is a value determined for the i-th PDSCH with reference to clause 5.3 of 3GPP standard TS 38.214, and N₁ is a PDSCH processing time value according to PDSCH processing capability. In addition, μ is a smallest subcarrier configuration value among a PDCCH for scheduling the i-th PDSCH, the i-th PDSCH, a PUCCH including HARQ-ACK for the i-th PDSCH, and all PUSCHs among the overlapping PUCCH and PUSCH groups. T_{C} is 1/(Δfₘₐₓ·N_{f}), Δfₘₐₓ=480·10³ Hz, N_{f}=4096,and κ is 64.

This is a part of the timeline condition for UCI multiplexing, and when the timeline condition is satisfied by referring to clause 9.2.5 of 3GPP standard TS 38.213, the terminal may perform UCI multiplexing on the PUSCH. When a PUCCH and a PUSCH overlap, and the timeline condition for UCI multiplexing described in detail in clause 9.2.5 of 3GPP standard TS 38.213 including the above example is satisfied, the terminal may multiplex, on the PUSCH, HARQ-ACK and/or CSI information included in the PUCCH and may not transmit the PUCCH according to the UCI information included in the PUSCH.

Then, if the PUCCH and PUSCH overlap, the timeline condition for UCI multiplexing is satisfied, and the terminal determines to multiplex UCI included in the PUCCH on the PUSCH, the terminal performs UCI rate matching for UCI multiplexing. UCI multiplexing is performed in an order of HARQ-ACK, configured grant uplink control information (CG-UCI), CSI part 1, and CSI part 2. The terminal performs rate matching in consideration of the UCI multiplexing order. Therefore, the terminal calculates a coded modulation symbol per layer for HARQ-ACK and CG-UCI, and in consideration of the same, the terminal calculates a coded modulation symbols per layer for CSI part 1. Thereafter, the terminal calculates a coded modulation symbol per layer for CSI part 2 in consideration of the coded modulation symbols per layer for HARQ-ACK, CG-UCI, and CSI part 1.

When rate matching is performed according to each UCI type, a method for calculating the number of coded modulation symbols per layer varies depending on a repeated transmission type of the PUSCH on which UCI is multiplexed and whether or not uplink data (uplink shared channel, hereinafter, UL-SCH) is included. For example, when rate matching for HARQ-ACK is performed, an equation for obtaining a coded modulation symbol per layer according to a PUSCH on which UCI is multiplexed is shown in Equation (6) below.

$${Q}_{ACK}^{′} = min \{ ⌈ \frac{( {O}_{ACK} + {L}_{ACK} ) * {β}_{offset}^{PUSCH} * {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α * {\sum }_{l = {l}_{0}}^{{N}_{symb , all}^{PUSCH} - 1} {M}_{sc}^{UCI} ( l ) ⌉ \} \qquad ( 6 )$$

$${Q}_{ACK}^{′} = min \{ ⌈ \frac{( {O}_{ACK} + {L}_{ACK} ) * {β}_{offset}^{PUSCH} * {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \qquad ( 7 )$$

$$⌈ α * {\sum }_{l = 0}^{{N}_{symb , nominal}^{PUSCH} - 1} {M}_{sc , nominal}^{UCI} ( l ) ⌉ , {\sum }_{l = 0}^{{N}_{symb , actual}^{PUSCH} - 1} {M}_{sc , actual}^{UCI} ( l ) \}$$

$${Q}_{ACK}^{′} = min \{ ⌈ \frac{( {O}_{ACK} + {L}_{ACK} ) * {β}_{offset}^{PUSCH}}{R * {Q}_{m}} ⌉ , ⌈ α * {\sum }_{l = {l}_{0}}^{{N}_{symb , all}^{PUSCH} - 1} {M}_{sc}^{UCI} ( l ) ⌉ \} \qquad ( 8 )$$

Equation (6) is an equation for obtaining a coded modulation symbol per layer for HARQ-ACK multiplexed on a PUSCH in a case other than repeated PUSCH transmission type B including a UL-SCH, and Equation (7) is an equation for obtaining a coded modulation symbol per layer for HARQ-ACK multiplexed on repeated PUSCH transmission type B including a UL-SCH. Equation (8) is an equation for obtaining a coded modulation symbol per layer for HARQ-ACK multiplexed on a PUSCH that does not include a UL-SCH.

In Equation (6), O_{ACK} is the number of HARQ-ACK bits. L_{ACK} is the number of CRC bits for HARQ-ACK. β_{offset}^{PUSCH} is a beta offset for HARQ-ACK and is the same as β_{offset}^{HARQ-ACK}. C_{UL-SCH} is the number of code blocks of a UL-SCH for PUSCH transmission, and Kᵣ is a code block size of an r-th code block. M_{sc}^{UCI}(l) indicates the number of resource elements available for UCI transmission in symbol l, and the number is determined according to the presence or absence of a DMRS and a PTRS of symbol l. If symbol l includes a DMRS, then M_{sc}^{UCI}(l)=0. For symbol l including no DMRS, M_{sc}^{UCI}(l)=M_{sc}^{PUSCH}−M_{sc}^{PT-RS}(l). M_{sc}^{PUSCH} is the number of subcarriers for a bandwidth scheduled with PUSCH transmission, and M_{sc}^{PT-RS}(l) is the number of subcarriers including a PTRS in symbol l. N_{symb,all}^{PUSCH} a indicates a total number of symbols of a PUSCH. α is higher-layer parameter scaling, which refers to a ratio of resources, on which UCI may be multiplexed, among all resources for PUSCH transmission. l₀ indicates an index of a first symbol including no DMRS after a first DMRS.

In Equation (7), M_{sc,nominal}^{UCI}(l) indicates the number of resource elements available for UCI transmission for nominal repetition, and is 0 for a symbol including a DMRS, M_{sc,nominal}^{UCI}(l)=M_{sc}^{PUSCH}−M_{sc,nominal}^{PT-RS}(l) for a symbol including no DMRS, and M_{sc,nominal}^{PT-RS}(l) is the number of subcarriers including a PTRS in symbol l for a PUSCH with an assumption of nominal repetition. N_{symb,nominal}^{PUSCH} indicates a total number of symbols for nominal repetitions of the PUSCH. M_{sc,actual}^{UCI}(l) indicates the number of resource elements available for UCI transmission for actual repetition, is 0 for a symbol including a DMRS, and satisfies M_{sc,actual}^{UCI}(l)=M_{sc}^{PUSCH}−M_{sc,actual}^{PT-RS}(l) for a symbol including no DMRS, and M_{sc,actual}^{PT-RS}(l) is the number of subcarriers including a PTRS in symbol l for actual repetition of the PUSCH. N_{symb,actual}^{PUSCH} indicates a total number of symbols for actual repetitions of the PUSCH.

In Equation (8), R is a code rate of a PUSCH, and Qₘ is a modulation order of the PUSCH.

The number of coded modulation symbols per layer, for which rate matching of CSI part 1 has been performed, may be calculated similarly to HARQ-ACK, but the maximum number of allocable resources among all resources may be reduced to a value obtained by excluding the number of coded modulation symbols for HARQ-ACK/CG-UCI. Equations for obtaining the coded modulation symbol per layer for CSI part 1 are as shown in Equation (9), Equation (10), Equation (11), and Equation (12) according to a repeated PUSCH transmission type and whether or not a UL-SCH is included.

$${Q}_{CSI - 1}^{′} = min \{ ⌈ \frac{( {O}_{CSI - 1} + {L}_{CSI - 1} ) * {β}_{offset}^{PUSCH} * {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \qquad ( 9 )$$

$$⌈ α * {\sum }_{l = 0}^{{N}_{symb , all}^{PUSCH} - 1} {M}_{sc}^{UCI} ( l ) ⌉ - {Q}_{ACK / CG - UCI}^{′} \}$$

$${Q}_{CSI - 1}^{′} = min \{ ⌈ \frac{( {O}_{CSI - 1} + {L}_{CSI - 1} ) * {β}_{offset}^{PUSCH} * {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \qquad ( 10 )$$

$$⌈ α * {\sum }_{l = 0}^{{N}_{symb , nominal}^{PUSCH} - 1} {M}_{sc , nominal}^{UCI} ( l ) ⌉ - {Q}_{ACK / CG - UCI}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} \}$$

$${Q}_{CSI - 1}^{′} = min \{ ⌈ \frac{( {O}_{CSI - 1} + {L}_{CSI - 1} ) * {β}_{offset}^{PUSCH}}{R * {Q}_{m}} ⌉ , \\ {\sum }_{l = 0}^{{N}_{symb , all}^{PUSCH} - 1} {M}_{sc}^{UCI} ( l ) - {Q}_{ACK}^{′} \} \qquad ( 11 )$$

$${Q}_{CSI - 1}^{′} = {\sum }_{l = 0}^{{N}_{symb , all}^{PUSCH} - 1} {M}_{sc}^{UCI} ( l ) - {Q}_{ACK}^{′} \qquad ( 12 )$$

Equation (9) is for obtaining a coded modulation symbol per layer for CSI part 1 multiplexed on a PUSCH in a case other than repeated PUSCH transmission type B including a UL-SCH, and Equation (10) is for obtaining a coded modulation symbol per layer for CSI part 1 multiplexed on repeated PUSCH transmission type B including a UL-SCH. Equation (11) is for, when CSI part 1 and CSI part 2 are multiplexed on a PUSCH including no UL-SCH, obtaining a coded modulation symbol per layer for multiplexed CSI part 1. Equation (12) is an equation for, when CSI part 2 is not multiplexed on a PUSCH including no UL-SCH, obtaining a coded modulation symbol per layer for multiplexed CSI part 1. In Equation (9), O_{CSI-1} and L_{CSI-1} refer to the number of bits for CSI part 1 and the number of CRC bits for CSI part 1, respectively. β_{offset}^{PUSCH} is a beta offset for CSI part 1 and is the same as β_{offset}^{CSI-part1}. Q′_{ACK/CG-UCI} is the number of coded modulation symbols per layer, which is calculated for HARQ-ACK and/or CG-UCI. Other parameters are the same as the aforementioned parameters required for calculating the number of coded modulation symbols per layer for HARQ-ACK.

The number of coded modulation symbols per layer, for which rate matching of CSI part 2 has been performed, may also be calculated similarly to CSI part 1, but the maximum number of allocable resources among all resources may be reduced to a value obtained by excluding the number of coded modulation symbols for CSI part 2 and the number of coded modulation symbols for HARQ-ACK/CG-UCI. Equations for obtaining the coded modulation symbol per layer for CSI part 1 are as shown in Equation (13), Equation (14), and Equation (15) according to a repeated PUSCH transmission type and whether or not a UL-SCH is included.

$${Q}_{CSI - 2}^{′} = min \{ ⌈ \frac{( {O}_{CSI - 2} + {L}_{CSI - 2} ) * {β}_{offset}^{PUSCH} * {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \qquad ( 13 )$$

$$⌈ α * {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$$

$${Q}_{CSI - 2}^{′} = min \{ ⌈ \frac{( {O}_{CSI - 2} + {L}_{CSI - 2} ) * {β}_{offset}^{PUSCH} * {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \qquad ( 14 )$$

$$⌈ α * {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$$

$${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′} \qquad ( 15 )$$

Equation (13) is for obtaining a coded modulation symbol per layer for CSI part 2 multiplexed on a PUSCH in a case other than repeated PUSCH transmission type B including a UL-SCH, and Equation (14) is for obtaining a coded modulation symbol per layer for CSI part 2 multiplexed on repeated PUSCH transmission type B including a UL-SCH. Equation (15) is an equation for obtaining a coded modulation symbol per layer for CSI part 2 multiplexed on a PUSCH including no UL-SCH. In Equation (13), O_{CSI-2} and L_{CSI-2} refer to the number of bits for CSI part 2 and the number of CRC bits for CSI part 2, respectively. β_{offset}^{PUSCH} is a beta offset for CSI part 2 and is the same as β_{offset}^{CSI-part2}. Other parameters are the same as the aforementioned parameters required for calculating the number of coded modulation symbols per layer for HARQ-ACK and CSI part 1.

The number of coded modulation symbols per layer, for which rate matching of CG-UCI has been performed, may also be calculated similarly to HARQ-ACK. An equation for obtaining a coded modulation symbol per layer for CG-UCI multiplexed on a PUSCH including a UL-SCH is shown in Equation (16).

$${Q}_{CG - UCI}^{′} = \qquad ( 16 )$$

$$min \{ ⌈ \frac{( {O}_{CG - UCI} + {L}_{CG - UC} ) * {β}_{offset}^{PUSCH} * {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$$

$$⌈ α * {\sum }_{l = {l}_{0}}^{{N}_{symb , all}^{PUSCH} - 1} {M}_{sc}^{UCI} ( l ) ⌉ \}$$

In Equation (16), O_{CG-UCI} and L_{CG-UCI} refer to the number of bits of CG-UCI and the number of CRC bits for CG-UCI, respectively. β_{offset}^{PUSCH} is a beta offset for CG-UCI and is the same as β_{offset}^{CG-UCI}. Other parameters are the same as the aforementioned parameters required for calculating the number of coded modulation symbols per layer for HARQ-ACK.

When HARQ-ACK and CG-UCI are multiplexed on a PUSCH including a UL-SCH, the number of coded modulation symbols per layer, for which rate matching has been performed for HARQ-ACK and CG-UCI, may be calculated as in Equation (17) below.

$${Q}_{CG - UCI}^{′} = \qquad ( 17 )$$

$$min \{ ⌈ \frac{( {O}_{ACK} + {O}_{CG - UCI} + {L}_{ACK} ) * {β}_{offset}^{PUSCH} * {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$$

$$⌈ α * {\sum }_{l = {l}_{0}}^{{N}_{symb , all}^{PUSCH} - 1} {M}_{sc}^{UCI} ( l ) ⌉ \}$$

In Equation (17), β_{offset}^{PUSCH} is a beta offset for HARQ-ACK and is equal to β_{offset}^{HARQ-ACK}, and other parameters are the same as the aforementioned parameters required for calculating the number of coded modulation symbols per layer for HARQ-ACK.

After calculating the number of coded modulation symbols per layer according to each UCI type as described above, the number E_{UCI} of bits for the entire UCI may be calculated based on E_{UCI}=N_{L}*Q′*Qₘ, wherein N_{L} is the number of transmission layers of the PUSCH, Qₘ is a modulation order, and Q′ is the number of coded modulation symbols per layer according to a UCI type, which may be Q′_{ACK}, Q′_{CSI-1}, Q′_{CSI-2}, or Q′_{CG-UCI}.

Relating to UE Capability Reporting

In LTE and NR, in a state where a terminal is connected to a serving base station, the terminal may perform a procedure of reporting capability supported thereby to the base station. In the description below, this is referred to as a UE capability report.

The base station may transfer, to the connected terminal, a UE capability enquiry message for requesting a capability report. The message may include a UE capability request for each radio access technology (RAT) type of the base station. The request for each RAT type may include supported frequency band combination information and the like. In a case of the UE capability enquiry message, UE capability may be requested for multiple RAT types via a container of a single RRC message transmitted by the base station, or the base station may include multiple UE capability enquiry messages including the UE capability request for each RAT type so as to transfer the same to the terminal. That is, the UE capability enquiry is repeated multiple times within one message, and the terminal may configure a corresponding UE capability information message and report the same multiple times. In the next-generation mobile communication system, a UE capability request for multi-RAT dual connectivity (MR-DC) including NR, LTE, and E-UTRA-NR dual connectivity (EN-DC) may be made. The UE capability enquiry message is generally transmitted initially after the terminal is connected to the base station, but may be requested by the base station under any conditions when necessary.

As described above, the terminal having received, from the base station, a request for a UE capability report configures UE capability according to RAT type and band information requested from the base station. Hereinafter, a method of configuring UE capability by the terminal in the NR system is described.
1. If a terminal receives, from a base station, a list of LTE and/or NR bands via a UE capability, the terminal configures a band combination (BC) for EN-DC and NR stand-alone (SA). That is, the terminal configures a candidate list of a BC for EN-DC and NR SA, based on the bands requested from the base station via FreqBandList. The bands have priorities in the order described in FreqBandList.
2. If the base station requests a UE capability report by setting an “eutra-nr-only” flag or an “eutra” flag, the terminal completely removes NR SA BCs from the configured candidate list of Bcs. This may occur only when the LTE base station (eNB) requests “eutra” capability.
3. Thereafter, the terminal removes fallback BCs from the candidate list of BCs configured in the above operation. Here, the fallback BC refers to a BC obtainable by removing a band corresponding to at least one SCell from any BC, and since a BC before removal of the band corresponding to at least one SCell is already able to cover the fallback BC, this can be omitted. This operation is also applied to MR-DC, i.e., LTE bands. The remaining BCs after this operation constitute a final “candidate BC list”.
4. The terminal selects BCs to be reported by selecting BCs conforming to the requested RAT type from the final “candidate BC list”. In this operation, the terminal configures supportedBandCombinationList in a predetermined order. That is, the terminal configures the BCs and UE capability to be reported according to a preconfigured rat-Type order (nr->eutra-nr->eutra). The terminal configures featureSetCombination for configured supportedBandCombinationList and configures a list of “candidate feature set combination” from the candidate BC list from which the list of fallback BCs (including equal or lower-level capabilities) has been removed. The “candidate feature set combination” may include feature set combinations for both NR and UTRA-NR BC, and may be obtained from feature set combinations of UE-NR-capabilities and UE-MRDC-capabilities containers.
5. If the requested rat Type is eutra-nr and affects, featureSetCombinations is included in both of two containers of UE-MRDC-Capabilities and UE-NR-Capabilities. However, the feature set of NR is included only in UE-NR-Capabilities.

After the UE capability is configured, the terminal transfers a UE capability information message including the UE capability to the base station. The base station performs appropriate scheduling and transmission or reception management with respect to the corresponding terminal at a later time, based on the UE capability received from the terminal.

Relating to CA/DC

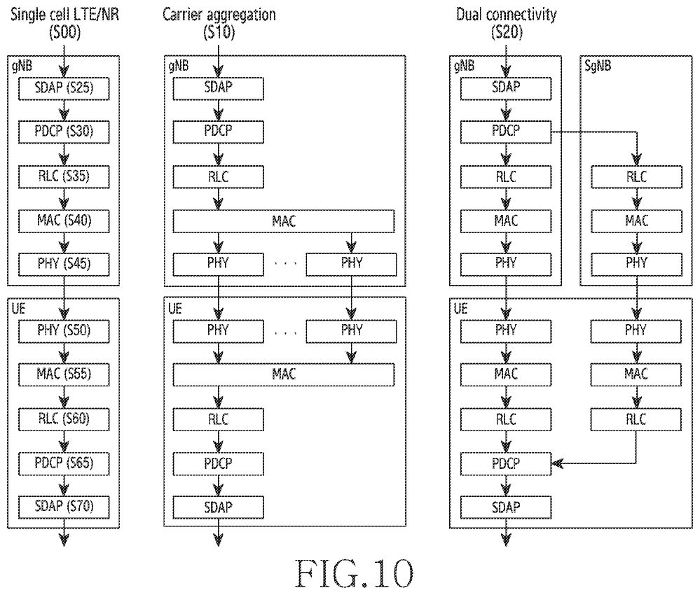

FIG. 10 is a diagram illustrating a radio protocol structure of a base station and a terminal in single cell, carrier aggregation, and dual connectivity situations, according to an embodiment.

Referring to FIG. 10, radio protocols of a next-generation mobile communication system include NR service data adaptation protocols (SDAP) S25 and S70, NR packet data convergence protocols (PDCP) S30 and S65, NR radio link controls (RLC) S35 and S60, and NR medium access controls (MAC) S40 and S55 layers in a terminal and an NR base station, respectively.

Main functions of the NR SDAPs S25 and S70 may include some of the following functions.
User data transfer function (transfer of user plane data)
Function of mapping a QoS flow and a data bearer for an uplink and a downlink (mapping between a QoS flow and a DRB for both DL and UL)
Function of marking a QoS flow ID in an uplink and a downlink (marking QoS flow ID in both DL and UL packets)
Function of mapping reflective QoS flows to data bearers for uplink SDAP PDUs (reflective QoS flow to DRB mapping for the UL SDAP PDUs)

With respect to an SDAP layer device, the terminal may be configured with, via an RRC message, whether to use a header of the SDAP layer device or whether to use a function of the SDAP layer device for each PDCP layer device, for each bearer, or for each logical channel, and if the SDAP header is configured, a NAS QoS reflection configuration 1-bit indicator (NAS reflective QoS) and an AS QoS reflection configuration 1-bit indicator (AS reflective QoS) in the SDAP header may be indicated to cause the terminal to update or reconfigure mapping information for data bearers and QoS flows in an uplink and a downlink. The SDAP header may include QoS flow ID information indicating QoS. The QoS information may be used as a data processing priority, scheduling information, etc. to support a smooth service.

Main functions of the NR PDCPs S30 and S65 may include some of the following functions.
Header compression and decompression function (ROHC only)
User data transmission function (transfer of user data)
Sequential delivery function (in-sequence delivery of upper layer PDUs)
Non-sequential delivery function (out-of-sequence delivery of upper layer PDUs)
Reordering function (PDCP PDU reordering for reception)
Duplicate detection function (duplicate detection of lower layer SDUs)
Retransmission function (retransmission of PDCP SDUs)
Encryption and decryption function (ciphering and deciphering)
Timer-based SDU discard function (timer-based SDU discard in uplink)

In the above, the reordering function of the NR PDCP device refers to a function of reordering PDCP PDUs received from a lower layer in order based on a PDCP sequence number (SN), and may include a function of transferring data to a higher layer according to the reordered sequence. Alternatively, the reordering function of the NR PDCP device may include a function of direct transfer without considering a sequence, may include a function of reordering the sequence to record lost PDCP PDUs, may include a function of reporting states of the lost PDCP PDUs to a transmission side, and may include a function of requesting retransmission of the lost PDCP PDUs.

Main functions of the NR RLCs S35 and S60 may include some of the following functions.
Data transmission function (transfer of upper layer PDUs)
Sequential delivery function (in-sequence delivery of upper layer PDUs)
Non-sequential delivery function (out-of-sequence delivery of upper layer PDUs)
ARQ function (error correction through ARQ)
Concatenation, segmentation, and reassembly function (concatenation, segmentation and reassembly of RLC SDUs)
Re-segmentation function (re-segmentation of RLC data PDUs)
Reordering function (reordering of RLC data PDUs)
Duplicate detection function
Error detection function (protocol error detection)
RLC SDU discard function
RLC re-establishment function

In the above, the in-sequence delivery function of the NR RLC device may refer to a function of sequentially transferring, to a higher layer, RLC SDUs received from a lower layer. The in-sequence delivery function of the NR RLC device may include a function of, when originally one RLC SDU is segmented into multiple RLC SDUs and then received, reassembling and transferring the received RLC SDUs, may include a function of reordering the received RLC PDUs according to an RLC sequence number (SN) or a PDCP sequence number (SN), may include a function of reordering a sequence and recording lost RLC PDUs, may include a function of reporting states of the lost RLC PDUs to a transmission side, and may include a function of requesting retransmission of the lost RLC PDUs. The in-sequence delivery function of the NR RLC device may include a function of, when there is a lost RLC SDU, sequentially transferring only RLC SDUs before the lost RLC SDU to a higher layer, or may include a function of, even if there is a lost RLC SDU, if a predetermined timer expires, sequentially transferring, to the higher layer, all the RLC SDUs received before the timer starts. Alternatively, the in-sequence delivery function of the NR RLC device may include a function of, even if there is a lost RLC SDU, if a predetermined timer expires, sequentially transferring all currently received RLC SDUs to the higher layer. In the above, the RLC PDUs may be processed in the order of reception thereof (in the order of arrival regardless of the order of the sequence numbers or sequence numbers) and may be delivered to the PDCP device regardless of the order (out-of-sequence delivery). In the case of segments, segments stored in a buffer or to be received at a later time may be received, reconfigured into one complete RLC PDU, processed, and then may be delivered to the PDCP device. The NR RLC layer may not include a concatenation function, and the function may be performed in an NR MAC layer or may be replaced with a multiplexing function of the NR MAC layer.

In the above, the out-of-sequence delivery function of the NR RLC device refers to a function of directly delivering the RLC SDUs received from the lower layer to a higher layer regardless of order, and may include a function of, when originally one RLC SDU is divided into multiple RLC SDUs and then received, reassembling the divided RLC SDUs and then delivering the same, and may include a function of storing the RLC SN or the PDCP SN of the received RLC PDUs and arranging the same so as to record the lost RLC PDUs.

The NR MACs S40 and S55 may be connected to multiple NR RLC layer devices included in one terminal, and main functions of the NR MACs may include some of the following functions.
Mapping function (mapping between logical channels and transport channels)
Multiplexing and demultiplexing function (multiplexing/demultiplexing of MAC SDUs)
Scheduling information reporting function
HARQ function (error correction through HARQ)
Function of priority handling between logical channels (priority handling between logical channels of one UE)
Function of priority handling between terminals (priority handling between UEs by means of dynamic scheduling)
MBMS service identification function
Transport format selection function
Padding function

The NR PHY layers S45 and S50 may perform channel-coding and modulation of higher layer data, make the channel-coded and modulated higher layer data into OFDM symbols, and transmit the OFDM symbols via a radio channel, or may perform demodulation and channel-decoding of the OFDM symbols received through the radio channel and transfer the same to the higher layer.

The detailed structure of the radio protocol structure may be variously changed according to a carrier (or cell) operating method. For example, when the base station transmits, based on a single carrier (or cell), data to the terminal, the base station and the terminal use a protocol structure having a single structure for each layer, as shown in 500. On the other hand, when the base station transmits data to the terminal, based on carrier aggregation (CA) using multiple carriers in a single TRP, the base station and the terminal use a protocol structure in which up to the RLC layer has a single structure but the PHY layer is multiplexed via the MAC layer, as shown in S10. As another example, when the base station transmits data to the terminal, based on dual connectivity (DC) using multiple carriers in multiple TRPs, the base station and the terminal use a protocol structure in which up to the RLC has a single structure but the PHY layer is multiplexed via the MAC layer, as shown in S20.

Related to NC-JT

According to an embodiment, non-coherent joint transmission (NC-JT) may be used for the terminal to receive PDSCHs from multiple TRPs.

Unlike the conventional system, the 5G wireless communication system can support not only a service requiring a high transmission rate, but also a service having a very short transmission delay and a service requiring a high connection density. In a wireless communication network including multiple cells, transmission and reception points (TRPs), or beams, cooperative communication (coordinated transmission) between the respective cells, TRPs, or/and beams may satisfy various service requirements by enhancing the strength of a signal received by a terminal or efficiently performing interference control between the respective cells, TRPs, or/and beams.

Joint transmission (JT) is a representative transmission scheme for the aforementioned cooperative communication, and is a scheme for increasing the strength or throughput of a signal received by a terminal, by transmitting the signal to one terminal via multiple different cells, TRPs, and/or beams. In this case, channels between the terminal and the respective cells, TRPs, and/or beams may have significantly different characteristics, and in particular, non-coherent joint transmission (NC-JT) supporting non-coherent precoding between the respective cells, TRPs, and/or beams may require individual precoding, MCS, resource allocation, TCI indication, etc. according to a channel characteristic for each link between the terminal and the respective cells, TRPs, and/or beams.

The aforementioned NC-JT transmission may be applied to at least one of downlink data channel (PDSCH), downlink control channel (PDCCH), uplink data channel (PUSCH), and uplink control channel (PUCCH). During PDSCH transmission, transmission information, such as precoding, MCS, resource allocation, and TCI, is indicated via DL DCI, and for NC-JT transmission, the transmission information should be independently indicated for each cell, TRP, and/or beam. This becomes a major factor in increasing a payload required for DL DCI transmission, which may adversely affect reception performance of a PDCCH which transmits DCI. Therefore, in order to support JT of a PDSCH, it is necessary to carefully design tradeoff between the amount of DCI information and control information reception performance.

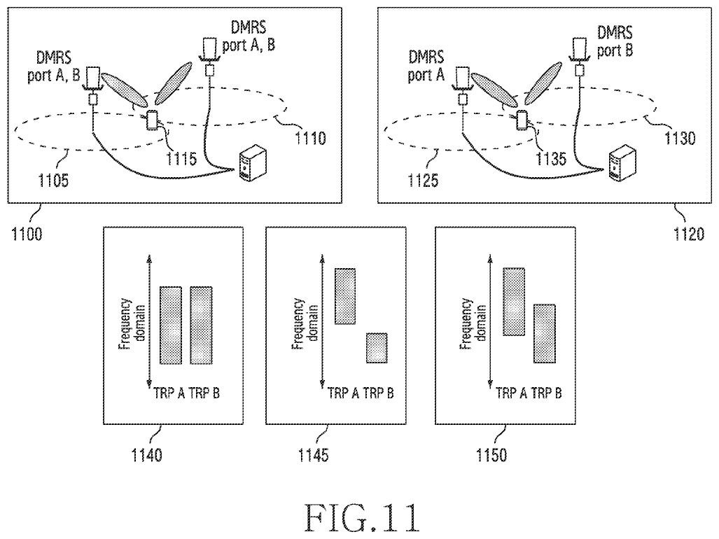

FIG. 11 is a diagram illustrating an example of an antenna port configuration and resource allocation for PDSCH transmission using cooperative communication in the wireless communication system, according to an embodiment.

Referring to FIG. 11, an example for PDSCH transmission is described for each joint transmission (JT) scheme, and examples for radio resource allocation for each TRP are illustrated.

Referring to FIG. 11, an example 1100 for coherent joint transmission (C-JT) supporting coherent precoding between respective cells, TRPs, or/and beams is illustrated.

For C-JT, TRP A 1105 and TRP B 1110 transmit a piece of single data (PDSCH) to a terminal 1115, and joint precoding may be performed in multiple TRPs. This may indicate that DMRSs are transmitted through identical DMRS ports in order for TRP A 1105 and TRP B 1110 to transmit the same PDSCH. For example, TRP A 1105 and TRP B 1110 may transmit DRMSs to the terminal through DMRS port A and DMRS port B, respectively. In this case, the terminal may receive one piece of DCI information for reception of one PDSCH demodulated based on the DMRSs transmitted through DMRS port A and DMRS port B.

Referring to FIG. 11, an example 1120 of non-coherent joint transmission (NC-JT) supporting non-coherent precoding between respective cells, TRPs, and/or beams for PDSCH transmission is illustrated.

For NC-JT, a PDSCH is transmitted to a terminal 1135 for each cell, TRP, or/and beam, and individual precoding may be applied to each PDSCH. Each cell, TRP, and/or beam transmits a different PDSCH or a different PDSCH layer to the terminal, thereby improving a throughput compared to single cell, TRP, and/or beam transmission. Each cell, TRP, and/or beam repeatedly transmits the same PDSCH to the terminal, thereby improving reliability compared to single cell, TRP and/or beam transmission. Hereinafter, for convenience of description, a cell, a TRP, and/or a beam is collectively referred to as a TRP.

In this case, various radio resource allocations may be considered, such as a case 1140 where frequency and time resources used in multiple TRPs for PDSCH transmission are all identical, a case 1145 where frequency and time resources used in multiple TRPs do not overlap at all, and a case 1150 where some of frequency and time resources used in multiple TRPs overlap.

For NC-JT support, DCI of various types, structures, and relations may be considered to assign multiple PDSCHs simultaneously to a single terminal.

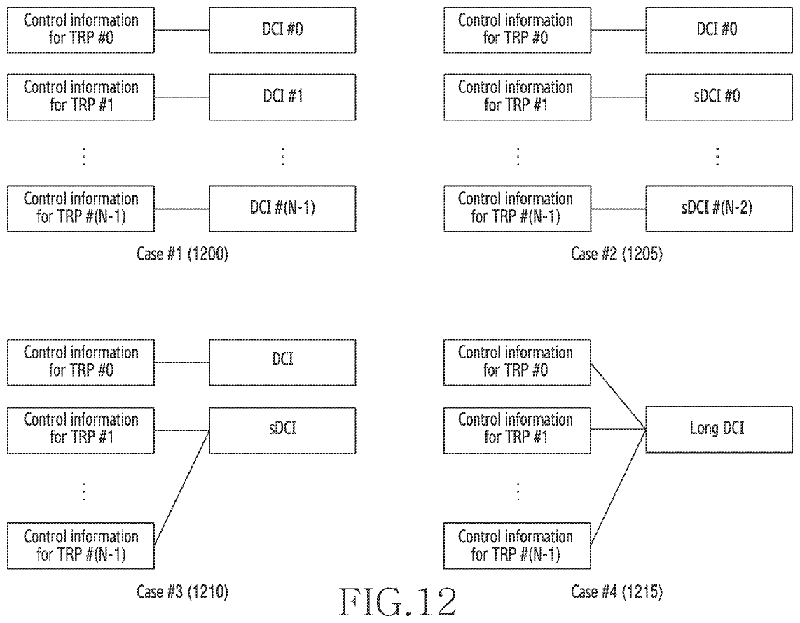

FIG. 12 is a diagram illustrating an example of a configuration of DCI for NC-JT in which respective TRPs transmit different PDSCHs or different PDSCH layers to a terminal in the wireless communication system, according to an embodiment.

Referring to FIG. 12, case #1 1200 is an example in which, in a situation where different (N−1) PDSCHs are transmitted from (N−1) additional TRPs (TRP #1 to TRP #(N−1)) in addition to a serving TRP (TRP #0) used during single PDSCH transmission, control information for PDSCHs transmitted in the additional (N−1) TRPs is transmitted independently of control information for a PDSCH transmitted in the serving TRP. That is, the terminal may acquire control information for PDSCHs transmitted from different TRPs (TRP #0 to TRP #(N−1)) via independent pieces of DCI (DCI #0 to DCI #(N−1)). Formats between the independent pieces of DCI may be the same or different from each other, and payloads between the DCI may also be the same or different from each other. In aforementioned case #1, each PDSCH control or allocation freedom may be completely guaranteed, but if respective pieces of DCI are transmitted in different TRPs, a coverage difference per DCI occurs and reception performance may be thus deteriorated.

Case #2 1205 shows an example dependent on control information for a PDSCH, in which, in a situation where (N−1) different PDSCHs are transmitted from (N−1) additional TRPs (TRP #1 to TRP #(N−1)) in addition to a serving TRP (TRP #0) used during single PDSCH transmission, control information (DCI) for each of PDSCHs of the additional (N−1) TRPs is transmitted, and each piece of the DCI is transmitted from the serving TRP.

For example, DCI #0, which is control information for the PDSCH transmitted from the serving TRP (TRP #0), includes all information elements of DCI format 1_0, DCI format 1_1, and DCI format 1_2, but shortened DCI (hereinafter, sDCI) (sDCI #0 to sDCI #(N−2)), which is control information for the PDSCHs transmitted from the cooperative TRPs (TRP #1 to TRP #(N−1)), may include only some of the information elements of DCI format 10, DCI format 1_1, and DCI format 1_2. Accordingly, for sDCI for transmission of the control information for the PDSCHs transmitted from the cooperative TRPs, a payload is small compared to normal DCI (nDCI) for transmission of the control information related to the PDSCH transmitted from the serving TRP, and it is thus possible to include reserved bits when compared to nDCI.

In aforementioned case #2, each PDSCH control or allocation freedom may be restricted according to a content of an information element included in sDCI, but since reception performance of sDCI is superior to that of nDCI, a probability that a coverage difference occurs per DCI may be lowered.

Case #3 1210 shows an example dependent on control information for a PDSCH, in which, in a situation where (N−1) different PDSCHs are transmitted from (N−1) additional TRPs (TRP #1 to TRP #(N−1)) in addition to a serving TRP (TRP #0) used during single PDSCH transmission, one piece of control information for PDSCHs of the (N−1) additional TRPs is transmitted, and the DCI is transmitted from the serving TRP.

For example, DCI #0, which is control information for the PDSCH transmitted from the serving TRP (TRP #0), includes all information elements of DCI format 1_0, DCI format 1_1, and DCI format 1_2, and for control information for the PDSCHs transmitted from the cooperative TRPs (TRP #1 to TRP #(N−1)), only some of the information elements of DCI format 10, DCI format 1_1, and DCI format 1_2 may be collected into one “secondary” DCI (sDCI) so as to be transmitted. For example, the sDCI may include at least one piece of HARQ-related information, such as frequency domain resource assignment, time domain resource assignment, and MCS of cooperative TRPs. In addition, information that is not included in the sDCI, such as a BWP indicator or a carrier indicator, may be based on the DCI (DCI #0, normal DCI, or nDCI) of the serving TRP.

In case #3 1210, each PDSCH control or allocation freedom may be restricted according to a content of the information element included in the sDCI, but sDCI reception performance may be adjustable, and complexity of DCI blind decoding of the terminal may be reduced compared to case #1 1200 or case #2 1205.

Case #4 1215 is an example in which, in a situation where (N−1) different PDSCHs are transmitted from (N−1) additional TRPs (TRP #1 to TRP #(N−1)) in addition to a serving TRP (TRP #0) used during single PDSCH transmission, control information for PDSCHs transmitted from the (N−1) additional TRPs is transmitted in the same DCI (long DCI) as that for the control information for the PDSCH transmitted from the serving TRP. That is, the terminal may acquire the control information for the PDSCHs transmitted from different TRPs (TRP #0 to TRP #(N−1)) via single DCI. For case #4 1215, complexity of DCI blind decoding of the terminal may not increase, but a PDSCH control or allocation freedom may be low, such that the number of cooperative TRPs is limited according to long DCI payload restrictions.

In the following descriptions and embodiments, sDCI may refer to various auxiliary DCI, such as shortened DCI, secondary DCI, and normal DCI (aforementioned DCI formats 1_0 to 1_1) including PDSCH control information transmitted in the coordinated TRPs, and if no particular limitation is specified, the description is similarly applicable to the various auxiliary DCI.

In the following description and embodiments, aforementioned cases #1 1200, case #2 1205, and case #3 1210, in which one or more pieces of DCI (PDCCHs) are used for NC-JT support, are classified as multiple PDCCH-based NC-JT, and aforementioned case #4 1215 in which single DCI (PDCCH) is used for NC-JT support may be classified as single PDCCH-based NC-JT. In multiple PDCCH-based PDSCH transmission, a CORESET in which DCI of the serving TRP (TRP #0) is scheduled and a CORESET in which DCI of the cooperative TRPs (TRP #1 to TRP #(N−1)) are scheduled may be differentiated. As a method for differentiating CORESETs, there may be a method for distinguishment via a higher-layer indicator for each CORESET, a method for distinguishment via a beam configuration for each CORESET, and the like. In addition, in the single PDCCH-based NC-JT, single DCI is for scheduling of a single PDSCH having multiple layers, instead of scheduling of multiple PDSCHs, and the aforementioned multiple layers may be transmitted from multiple TRPs. In this case, a connection relationship between a layer and a TRP for transmitting the layer may be indicated via a transmission configuration indicator (TCI) indication for the layer.

In embodiments of the disclosure, “cooperative TRP” may be replaced with various terms, such as “cooperative panel” or “cooperative beam” when actually applied.

In embodiments of the disclosure, “when NC-JT is applied” may be interpreted in various ways according to a situation such as “when a terminal receives one or more PDSCHs at the same time in one BWP”, “when a terminal receives PDSCH based on two or more transmission configuration indicator (TCI) indications at the same time in one BWP”, “when PDSCH received by a terminal is associated with one or more DMRS port groups”, etc., but it is used as an expression for convenience of description.

In the disclosure, a radio protocol structure for NC-JT may be used in various ways according to a TRP deployment scenario. For example, if there is no backhaul delay or is a small backhaul delay between cooperative TRPs, a method (CA-like method) of using a structure based on MAC layer multiplexing is possible in a similar manner to S10 of FIG. 10. On the other hand, if a backhaul delay between cooperative TRPs is so large that the backhaul delay cannot be ignored (e.g., when a time of 2 ms or longer is required for information exchange, such as CSI, scheduling, and HARQ-ACK, between the cooperative TRPs), a method (DC-like method) of securing characteristics robust to a delay by using an independent structure for each TRP from the RLC layer is possible in a similar manner to S20 of FIG. 10.

The terminal supporting C-JT/NC-JT may receive a C-JT/NC-JT-related parameter, setting value, or the like from a higher-layer configuration, and may set an RRC parameter of the terminal, based on the parameter, the setting value, or the like. For the higher-layer configuration, the terminal may use a UE capability parameter, for example, tci-StatePDSCH. Here, the UE capability parameter, for example, tci-StatePDSCH may define TCI states for the purpose of PDSCH transmission, the number of the TCI states may be configured to be 4, 8, 16, 32, 64, and 128 in FR1 and configured to be 64 and 128 in FR2, and among the configured numbers, up to 8 states that may be indicated by 3 bits of a TCI field in the DCI may be configured via a MAC CE message. The maximum value of 128 refers to a value indicated by maxNumberConfiguredTCIstatesPerCC in parameter tci-StatePDSCH included in capability signaling of the terminal. In this way, a series of configuration procedures from the higher-layer configuration to the MAC CE configuration may be applied to a beamforming change command or a beamforming indication for at least one PDSCH in one TRP.

Multi-DCI Based Multi-TRP

As an embodiment of the disclosure, a multi-DCI-based multi-TRP transmission method is described. In the multi-DCI-based multi-TRP transmission method, a downlink control channel for NC-JT transmission may be configured based on a multi-PDCCH.

In multiple PDCCH-based NC-JT, when DCI for PDSCH scheduling for each TRP is transmitted, a CORESET or a search space differentiated for each TRP may be provided. The CORESET or search space for each TRP can be configured as at least one of the following cases.
Higher-layer index configuration for each CORESET: CORESET configuration information configured via a higher layer may include an index value, and a TRP for PDCCH transmission in a corresponding CORESET may be differentiated by a configured index value for each CORESET. That is, in a set of CORESETs having the same higher-layer index value, it may be considered that the same TRP transmits the PDCCH, or the PDCCH for scheduling of the PDSCH of the same TRP is transmitted. The aforementioned index for each CORESET may be named as CORESETPoolIndex, and for CORESETs for which the same CORESETPoolIndex value has been configured, it may be considered that PDCCHs are transmitted from the same TRP. For a CORESET for which no CORESETPoolIndex value has been configured, it may be considered that a default value of CORESETPoolIndex has been configured, where the default value is 0.
   In the disclosure, if there is more than one type of CORESETPoolIndex that each of multiple CORESETs has, that is, if each CORESET has a different CORESETPoolIndex, the multiple CORESETs being included in PDCCH-Config that is higher-layer signaling, the terminal may consider that the base station may use the multi-DCI-based multi-TRP transmission method.
   Unlike this, in the disclosure, if there is one type of CORESETPoolIndex that each of multiple CORESETs has, the multiple CORESETs being included in PDCCH-Config that is higher-layer signaling, that is, if all CORESETs have the same CORESETPoolIndex of 0 or 1, the terminal may consider that the base station performs transmission using a single-TRP without using the multi-DCI-based multi-TRP transmission method.
Multiple PDCCH-Config configuration: Multiple PDCCH-Configs in one BWP may be configured, and each PDCCH-Config may include a PDCCH configuration for each TRP. That is, a list of CORESETs for each TRP and/or a list of search spaces for each TRP may be configured in one PDCCH-Config, and one or more CORESETs and one or more search spaces included in one PDCCH-Config may be considered to correspond to a specific TRP.
CORESET beam/beam group configuration: A TRP corresponding to a corresponding CORESET may be differentiated via a beam or beam group configured for each CORESET. For example, if the same TCI state is configured in multiple CORESETs, it may be considered that the CORESETs are transmitted via the same TRP, or that the PDCCH for scheduling of a PDSCH of the same TRP is transmitted from the corresponding CORESET.
Search space beam/beam group configuration: Abeam or beam group may be configured for each search space, and a TRP for each search space may be differentiated based on the configured beam or beam group. For example, when the same beam/beam group or TCI state is configured in multiple search spaces, it may be considered that the same TRP transmits a PDCCH in the corresponding search space or that the PDCCH for scheduling of a PDSCH of the same TRP is transmitted in the corresponding search space.

By differentiating the CORESET or search space for each TRP as described above, it is possible to classify PDSCH and HARQ-ACK information for each TRP, and based on this, it is possible to independently generate an HARQ-ACK codebook and independently use a PUCCH resource for each TRP.

The aforementioned configuration may be independent for each cell or each BWP. For example, while two different CORESETPoolIndex values are configured for a PCell, a CORESETPoolIndex value may not be configured for a specific SCell. In this case, it may be considered that NC-JT transmission is configured for the PCell, whereas NC-JT transmission is not configured for the SCell in which the CORESETPoolIndex value is not configured.

A PDSCH TCI state activation/deactivation MAC-CE applicable to the multi-DCI-based multi-TRP transmission method may follow FIG. 7. If the terminal is not configured with CORESETPoolIndex for each of all CORESETs in higher-layer signaling of PDCCH-Config, the terminal may disregard the CORESET Pool ID field 755 in the corresponding MAC-CE 750. If the terminal is able to support the multi-DCI-based multi-TRP transmission method, that is, if the terminal has CORESETPoolIndex in which respective CORESETs in higher-layer signaling of PDCCH-Config are different, the terminal may activate the TCI state in DCI included in the PDCCHs transmitted from the CORESETs having the same CORESETPoolIndex value as the CORESET Pool ID field 755 value in the corresponding MAC-CE 750. For example, if the value of the CORESET Pool ID field 755 in the MAC-CE 750 is 0, the TCI state in DCI included in the PDCCHs transmitted from the CORESETs having a CORESETPoolIndex value of 0 may conform to activation information of the MAC-CE.

If the terminal is configured to use the multi-DCI-based multi-TRP transmission method from the base station, that is, if there is more than one type of CORESETPoolIndex that each of the multiple CORESETs included in higher-layer signaling of PDCCH-Config has, or if each CORESET has different CORESETPoolIndex, the terminal may recognize the presence of the following restrictions for PDSCHs scheduled from the PDCCHs in the respective CORESETs having two different CORESETPoolIndex values.
1) If PDSCHs indicated by the PDCCHs in the respective CORESETs, which have two different CORESETPoolIndex values, entirely or partially overlap, the terminal may apply the TCI states indicated by the respective PDCCHs to different CDM groups. That is, two or more TCI states may not be applied to one CDM group.
2) If PDSCHs indicated by the PDCCHs in the respective CORESETs, which have two different CORESETPoolIndex values, entirely or partially overlap, the terminal may expect that the actual number of front loaded DMRS symbols, the actual number of additional DMRS symbols, actual positions of the DMRS symbols, and DMRS types of the respective PDSCHs may not be different from each other.
3) The terminal may expect that BWPs indicated from the PDCCHs in the respective CORESETs having two different CORESETPoolIndex values are the same, and that subcarrier spacings thereof may also be the same.
4) The terminal may expect the respective PDCCHs to completely include information on the PDSCHs scheduled from the PDCCHs in the respective CORESETs having two different CORESETPoolIndex values.

Single-DCI-Based Multi-TRP

In a single-DCI-based multi-TRP transmission method, a downlink control channel for NC-JT transmission may be configured based on a single-PDCCH.

In the single-DCI-based multi-TRP transmission method, PDSCHs transmitted by multiple TRPs may be scheduled via one piece of DCI. In this case, the number of TCI states may be used for a method of indicating the number of TRPs which transmit corresponding PDSCHs. That is, if the number of TCI states indicated in DCI for scheduling of a PDSCH is two, single PDCCH-based NC-JT transmission may be considered, and if the number of TCI states is one, single-TRP transmission may be considered. The TCI states indicated by the DCI may correspond to one or two TCI states among TCI states activated via a MAC-CE. If the TCI states of the DCI correspond to two TCI states activated via the MAC-CE, a correspondence is established between a TCI codepoint indicated in the DCI and the TCI states activated via the MAC-CE, and there may be two TCI states activated via the MAC-CE, which correspond to the TCI codepoint.

As another example, if at least one codepoint among all the codepoints of a TCI state field in the DCI indicates two TCI states, the terminal may consider that the base station may perform transmission based on the single-DCI-based multi-TRP method. In this case, at least one codepoint indicating two TCI states in the TCI state field may be activated via an enhanced PDSCH TCI state activation/deactivation MAC-CE.

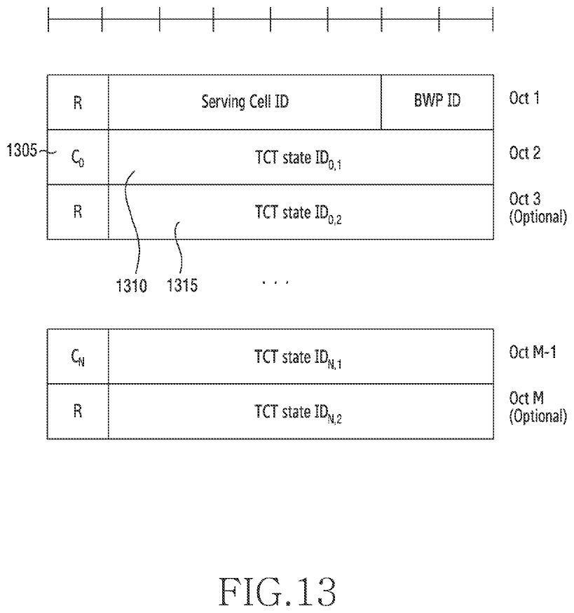

FIG. 13 is a diagram illustrating an enhanced PDSCH TCI state activation/deactivation MAC-CE structure. The meaning of each field in a corresponding MAC CE and a value configurable for each field are as shown in Table 39 below.

TABLE 39
Serving Cell ID: This field indicates the identity of the Serving Cell for which
the MAC CE applies. The length of the field is 5 bits. If the indicated Serving Cell
is configured as part of a simultaneousTCI-UpdateList1 or simultaneousTCI-
UpdateList2 as specified in TS 38.331 [5], this MAC CE applies to all the Serving Cells
configured in the set simultaneousTCI-UpdateList1 or simultaneousTCI-UpdateList2,
respectively;
BWP ID: This field indicates a DL BWP for which the MAC CE applies as the
codepoint of the DCI BWP indicator field as specified in TS 38.212 [9]. The length of
the BWP ID field is 2 bits;
Ci: This field indicates whether the octet containing TCI state IDi,2 is present.
If this field is set to “1”, the octet containing TCI state IDi,2 is present. If this field is
set to “0”, the octet containing TCI state IDi,2 is not present;
TCI state IDi,j: This field indicates the TCI state identified by TCI-StateId as
specified in TS 38.331 [5], where i is the index of the codepoint of the DCI Transmission
configuration indication field as specified in TS 38.212 [9] and TCI state IDi,j indicates
the j-th TCI state indicated for the i-th codepoint in the DCI Transmission Configuration
Indication field. The TCI codepoint to which the TCI States are mapped is determined
by its ordinal position among all the TCI codepoints with sets of TCI state IDi,j fields,
i.e., the first TCI codepoint with TCI state ID0,1 and TCI state ID0,2 shall be mapped to
the codepoint value 0, the second TCI codepoint with TCI state ID1,1 and TCI state
ID1,2 shall be mapped to the codepoint value 1 and so on. The TCI state IDi,2 is
optional based on the indication of the Ci field. The maximum number of activated
TCI codepoint is 8 and the maximum number of TCI states mapped to a TCI codepoint
is 2.
R: Reserved bit, set to “0”.

Referring to FIG. 13, if a value of a C0 field 1305 is 1, a corresponding MAC-CE may include field TCI state ID0,2 1315 in addition to field TCI state ID0,1 1310. This may indicate that TCI state ID0,1 and TCI state ID0,2 are activated for a zeroth codepoint of a TCI state field included in DCI, and if a base station indicates the corresponding codepoint to a terminal, the terminal may receive an indication of two TCI states. If a value of the C0 field 1305 is 0, a corresponding MAC-CE may not include field TCI state ID0,2 1315, and this indicates that one TCI state corresponding to TCI state ID0,1 is activated for the zeroth codepoint of the TCI state field included in the DCI.

The aforementioned configuration may be independent for each cell or each BWP. For example, a PCell may have up to two activated TCI states corresponding to one TCI codepoint, whereas a specific SCell may have up to one activated TCI state corresponding to one TCI codepoint. In this case, it may be considered that NC-JT transmission is configured for the PCell, whereas NC-JT transmission is not configured for the aforementioned SCell.

Method for Distinguishing Single-DCI-Based Multi-TRP Repeated PDSCH Transmission Scheme (TDM/FDM/SDM)

A method for distinguishing a single-DCI-based multi-TRP repeated PDSCH transmission scheme is described below. The terminal may be indicated with different single-DCI-based multi-TRP repeated PDSCH transmission schemes (e.g., TDM, FDM, and SDM) according to a higher-layer signaling configuration and a value indicated via a DCI field from the base station. Table 40 shows a method for distinguishing between a single-TRP-based scheme and a multi-TRP-based scheme indicated to the terminal according to a value of a specific DCI field and a higher-layer signaling configuration.

TABLE 40

| | | | repetitionNumber | | Transmission |
|---|---|---|---|---|---|
| | | | configuration | Relating to | scheme |
| | TCI state | CDM group | and indication | repetitionScheme | indicated to |
| Combination | Number | Number | condition | configuration | terminal |
| 1 | 1 | ≥1 | Condition 2 | Not | Single-TRP |
| | | | | configured | |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured | Single-TRP |
| | | | | or not | TDM scheme B |
| | | | | configured | |
| 5 | 2 | 2 | Condition 2 | Not | Multi-TRP |
| | | | | configured | SDM |
| 6 | 2 | 2 | Condition 3 | Not | Multi-TRP |
| | | | | configured | SDM |
| 7 | 2 | 2 | Condition 3 | Configured | Multi-TRP |
| | | | | | SDM |
| 8 | 2 | 2 | Condition 3 | Configured | Multi-TRP |
| | | | | | FDM scheme A/ |
| | | | | | FDM scheme B/ |
| | | | | | TDM scheme A |
| 9 | 2 | 2 | Condition 1 | Not | Multi-TRP |
| | | | | configured | TDM scheme B |

In Table 40, each column may be described as follows.
Number of TCI states (column 2): This refers to the number of TCI states indicated by the TCI state field in DCI, and the number of TCI states may be one or two.
Number of CDM groups (column 3): This refers to the number of different CDM groups of DMRS ports indicated by an antenna port field in DCI. The number of CDM groups may be 1,2 or 3.
repetitionNumber configuration and indication condition (column 4): There may be three conditions depending on whether repetitionNumber is configured for all TDRA entries which may be indicated by the time domain resource allocation field in DCI, and whether an actually indicated TDRA entry has a configuration of repetitionNumber.
   Condition 1: A case where at least one of all TDRA entries that may be indicated by the time domain resource allocation field includes a configuration for repetitionNumber, and a TDRA entry indicated by the time domain resource allocation field in DCI includes a configuration for repetitionNumber greater than 1
   Condition 2: A case where at least one of all TDRA entries which may be indicated by the time domain resource allocation field includes a configuration for repetitionNumber, and a TDRA entry indicated by the time domain resource allocation field in DCI does not include a configuration for repetitionNumber
   Condition 3: A case where all TDRA entries which may be indicated by the time domain resource allocation field do not include a configuration for repetitionNumber
Relating to a configuration of repetitionScheme (column 5): repetitionScheme indicates whether repetitionScheme that is higher-layer signaling is configured. One of “tdmSchemeA”, “fdmSchemeA”, and “fdmSchemeB” may be configured for repetitionScheme that is higher-layer signaling.
Transmission scheme indicated to the terminal (column 6): This refers to a single-TRP or multi-TRP scheme indicated according to each combination (column 1) shown in Table 42 above.
   Single-TRP: Single-TRP refers to single-TRP-based PDSCH transmission. If the terminal is configured with pdsch-AggegationFactor in higher-layer signaling PDSCH-config, the terminal may be scheduled with single-TRP-based repeated PDSCH transmission as many times as the configured number of times. Otherwise, the terminal may be scheduled with single-TRP-based single PDSCH transmission.
   Single-TRP TDM scheme B: This refers to repeated PDSCH transmission based on time resource division between slots based on a single TRP. According to the described condition 1 relating to repetitionNumber, the terminal repeatedly transmits PDSCHs on time resources as many times as repetitionNumber of slots, which is greater than 1 and configured in the TDRA entry indicated by the time domain resource allocation field. In this case, the same start symbol and symbol length of the PDSCH indicated by the TDRA entry are applied to each slot as many times as repetitionNumber, and the same TCI state is applied to each repeated PDSCH transmission. This scheme is similar to a slot aggregation scheme in view of performing repeated PDSCH transmission between slots on time resources, but is different from slot aggregation in that whether to indicate repeated transmission may be dynamically determined based on the time domain resource allocation field in DCI.
   Multi-TRP SDM: This refers to a PDSCH transmission scheme based on multi-TRP-based spatial resource division. Multi-TRP SDM is a method for reception from each TRP by dividing layers, and although not a repeated transmission scheme, multi-TRP SDM enables transmission at a low coding rate by increasing the number of layers, so as to increase the reliability of PDSCH transmission. The terminal may receive the PDSCH by applying two TCI states, which are indicated via the TCI state field in the DCI, to two CDM groups indicated by the base station, respectively.
   Multi-TRP FDM scheme A: This refers to a PDSCH transmission scheme based on multi-TRP-based frequency resource division, and although not for repeated transmission like multi-TRP SDM in view of having one PDSCH transmission occasion, multi-TRP FDM scheme A is a scheme that enables transmission with high reliability at a low coding rate by increasing the amount of frequency resources. In multi-TRP FDM scheme A, two TCI states indicated via the TCI state field in DCI may be applied to frequency resources that do not overlap each other, respectively. If a PRB bundling size is determined to be wideband, when the number of RBs indicated by the frequency domain resource allocation field is N, the terminal receives first ceil(N/2) RBs by applying a first TCI state and receives the remaining floor(N/2) RBs by applying a second TCI state. Here, ceil(·) and floor(·) are operators for rounding up and rounding off the first decimal place. If the PRB bundling size is determined to be 2 or 4, even-numbered PRGs are received by applying the first TCI state, and odd-numbered PRGs are received by applying the second TCI state.
   Multi-TRP FDM scheme B: This refers to a repeated PDSCH transmission scheme based on multi-TRP-based frequency resource division, wherein, when there are two PDSCH transmission occasions, multi-TRP FDM scheme B may enable repeated PDSCH transmission at each of the occasions. In multi-TRP FDM scheme B, as in multi-TRP FDM scheme A, two TCI states indicated via the TCI state field in DCI may be applied to frequency resources that do not overlap each other, respectively. If a PRB bundling size is determined to be wideband, when the number of RBs indicated by the frequency domain resource allocation field is N, the terminal receives first ceil(N/2) RBs by applying a first TCI state and receives the remaining floor(N/2) RBs by applying a second TCI state. Here, ceil(·) and floor(·) are operators for rounding up and rounding off the first decimal place. If the PRB bundling size is determined to be 2 or 4, even-numbered PRGs are received by applying the first TCI state, and odd-numbered PRGs are received by applying the second TCI state.
   Multi-TRP TDM scheme A: This refers to a repeated PDSCH transmission scheme in a multi-TRP-based time resource division slot. The terminal has two PDSCH transmission occasions in one slot, and a first reception occasion may be determined based on a start symbol and a symbol length of a PDSCH indicated via the time domain resource allocation field in DCI. A start symbol of a second reception occasion of the PDSCH may be a position to which a symbol offset is applied as much as StartingSymbolOffsetK, which is higher-layer signaling, from the last symbol of a first transmission occasion, and a transmission occasion may be determined according to a symbol length indicated therefrom. If StartingSymbolOffsetK that is higher-layer signaling is not configured, the symbol offset may be considered to be 0.
   Multi-TRP TDM scheme B: This refers to a repeated PDSCH transmission scheme between multi-TRP-based time resource division slots. The terminal has one PDSCH transmission occasion in one slot, and may receive repeated transmission based on the same start symbol and symbol length of the PDSCH during slots of the repetitionNumber number of times indicated via the time domain resource allocation field in DCI. If repetitionNumber is 2, the terminal may receive, with respect to repeated PDSCH transmissions in first and second slots, PDSCHs by applying first and second TCI states, respectively. If repetitionNumber is greater than 2, the terminal may use a different TCI state applying scheme depending on a configuration of tciMapping that is higher-layer signaling. If tciMapping is configured to be cyclicMapping, the first and second TCI states are applied to the first and second PDSCH transmission occasions, respectively, and this TCI state applying method is equally applied to the remaining PDSCH transmission occasions. If tciMapping is configured to be sequentialMapping, the first TCI state is applied to the first and second PDSCH transmission occasions, and the second TCI state is applied to third and fourth PDSCH transmission occasions, wherein this TCI state applying method is applied to the remaining PDSCH transmission occasions in the same manner.

Relating to RLM RS

A method of selecting or determining a radio link monitoring (RLM) reference signal (RS) is provided in which the RLM RS may be configured or may not be configured. The terminal may be configured with a set of RLM RSs from the base station via RadioLinkMonitoringRS in RadioLinkMonitoringConfig, which is higher-layer signaling, for each downlink BWP of SPCell, and a specific higher-layer signaling structure may follow Table 41 below.

```
TABLE 41
  RadioLinkMonitoringConfig ::= SEQUENCE {
    failureDetectionResourcesToAddModList SEQUENCE
(SIZE(1..maxNrofFailureDetectionResources)) OF RadioLinkMonitoringRS OPTIONAL,
-- Need N
    failureDetectionResourcesToReleaseList SEQUENCE
(SIZE(1..maxNrofFailureDetectionResources)) OF RadioLinkMonitoringRS-Id OPTIONAL, -
- Need N
    beamFailureInstanceMaxCount ENUMERATED {n1, n2, n3, n4, n5, n6, n8, n10}
```

OPTIONAL, -- Need R

beamFailureDetectionTimer ENUMERATED {pbfd1, pbfd2, pbfd3, pbfd4, pbfd5,

| | |
|---|---|
| pbfd6, pbfd8, pbfd10} | OPTIONAL, -- Need R |

```
  ...
  }
  RadioLinkMonitoringRS ::= SEQUENCE {
    radioLinkMonitoringRS-Id RadioLinkMonitoringRS-Id,
```

| | |
|---|---|
| purpose | ENUMERATED {beamFailure, rlf, both}, |
| detectionResource | CHOICE { |
| ssb-Index | SSB-Index, |
| csi-RS-Index | NZP-CSI-RS-ResourceId |

```
    },
  ...
  }
```

Table 42 may indicate the configurable or selectable number of RLM RSs for each specific use according to the maximum number (Lmax) of SSBs per half frame. As shown in Table 42, according to the Lmax value, NLR-RLM RSs may be used for link recovery or radio link monitoring, and NRLM RSs among NLR-RLM RSs may be used for radio link monitoring.

TABLE 42
N_{LR-RLM} and N_{RLM} as a function of maximum number
Lₘₐₓ of SS/PBCH blocks per half frame

| Lₘₐₓ | N_{LR-RLM} | N_{RLM} |
|---|---|---|
| 4 | 2 | 2 |
| 8 | 6 | 4 |
| 64 | 8 | 8 |

If the terminal is not configured with RadioLinkMonitoringRS that is higher-layer signaling, and the terminal is configured with a TCI state for receiving a PDCCH in a control resource set, and if at least one CSI-RS is included in the TCI state, the RLM RS may be selected according to the following RLM RS selection methods.
1) If an activated TCI state to be used for PDCCH reception has one reference RS (i.e., one activated TCI state has only one of QCL-TypeA, B, or C), the terminal may select, as the RLM RS, a reference RS of the activated TCI state to be used for PDCCH reception.
2) If an activated TCI state to be used for PDCCH reception has two reference RSs (i.e., one activated TCI state has one of QCL-TypeA, B, or C, and further has QCL-TypeD), the terminal may select a reference RS of QCL-TypeD as the RLM-RS. The terminal does not expect that two QCL-TypeDs are configured in one activated TCI state.
3) The terminal does not expect that an aperiodic or semi-persistent RS is selected as the RLM RS.
4) If Lmax=4, the terminal may select NRLM RSs (since Lmax is 4, two may be selected). The RLM RS is selected from among the reference RSs of the TCI state configured in the control resource set for PDCCH reception, based on RLM RS selection Methods 1 to 3, wherein a search space, to which the control resource set is linked, having a short period is determined to have a high priority, and the RLM RS is selected from the reference RS of the TCI state configured in the control resource set linked to a search space of a shortest period. If there are multiple control resource sets linked to multiple search spaces having the same period, the RLM RS is selected from the reference RS of the TCI state configured in a high control resource set index.

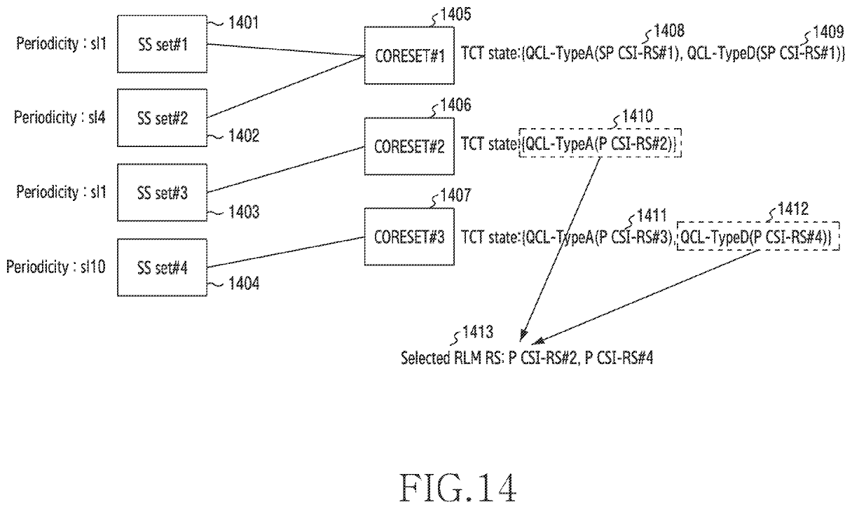

FIG. 14 is a diagram illustrating an RLM RS selection procedure, according to an embodiment. FIG. 14 illustrates control resource set #1 to control resource set #3 1405 to 1407 linked to search space #1 to search space #4 1401 to 1404 having different periods within an activated downlink BWP, and a reference RS of a TCI state configured in each CORESET. Based on RLM RS selection Method 4, RLM RS selection uses a TCI state configured in a control resource set linked to a search space with a shortest period, but since search space #1 1401 and search space #3 1403 have the same period, a reference RS of a TCI state configured in control resource set #2 having a higher index between control resource set #1 1405 and control resource set #2 1406 linked to respective search spaces may be used as a reference RS having a highest priority in the RLM RS selection. In addition, since the TCI state configured in control resource set #2 has only QCL-TypeA, and the reference RS thereof is a periodic RS, P CSI-RS #2 1410 may be first selected as the RLM RS according to RLM RS selection Methods 1 and 3. The reference RS of QCL-TypeD may be a selection candidate according to RLM RS selection Method 2 from among reference RSs of the TCI state configured in control resource set #1 having a subsequent priority, but the corresponding RS is a semi-persistent RS 1409 and therefore is not selected as the RLM RS according to RLM RS selection Method 3. Therefore, reference RSs of the TCI state configured in control resource set #3 may be considered as having the subsequent priority, and the reference RS of QCL-TypeD may be a selection candidate according to RLM RS selection Method 2, and since the corresponding reference RS is a periodic RS, P CSI-RS #4 1412 may be selected as a second RLM RS according to RLM RS selection Method 3. Therefore, finally selected RLM RSs 1413 may be P CSI-RS #2 and P CSI-RS #4.

In the following description of the disclosure, for convenience of description, a cell, a transmission point, a panel, a beam, a transmission direction, or/and the like, which may be distinguishable via higher layer/L1 parameters, such as TCI state or spatial relation information, or indicators, such as a cell ID, a TRP ID, and a panel ID, may be described as a transmission/reception point (TRP), a beam, or a TCI state in a unified manner. Therefore, in actual application, a TRP, a beam, or a TCI state may be appropriately replaced with one of the above terms.

Hereinafter, in the disclosure, in determining whether to apply cooperative communication, it is possible for a terminal to use various methods, in which a PDCCH(s) assigning a PDSCH to which the cooperative communication is applied has a specific format, a PDCCH(s) assigning a PDSCH to which the cooperative communication is applied includes a specific indicator indicating whether the cooperative communication is applied, a PDCCH(s) assigning a PDSCH to which the cooperative communication is applied is scrambled by a specific RNTI, applying of the cooperative communication in a specific section indicated by a higher layer is assumed, or the like. Hereinafter, for the convenience of description, a case in which a terminal receives a PDSCH to which cooperative communication has been applied based on conditions similar to the above is referred to as an NC-JT case.

Hereinafter, a base station is a subject that performs resource allocation to a terminal, and may be at least one of a gNode B, a gNB, an eNode B, a Node B, a BS, a radio access unit, a base station controller, or a node on a network. A terminal may include a UE, a MS, a cellular phone, a smartphone, a computer, or a multimedia system capable of performing a communication function. Hereinafter, an embodiment is described using the 5G system as an example, but the embodiment of the disclosure may also be applied to other communication systems having a similar technical background or channel type. For example, LTE or LTE-A mobile communication and a mobile communication technology developed after 5G may be included therein. Therefore, an embodiment of the disclosure may be applied to other communication systems via some modifications without departing from the scope of the disclosure, according to determination by those skilled in the art. Contents of the disclosure are applicable in frequency division duplex (FDD) and time division duplex (TDD) systems. Hereinafter, higher signaling (or higher-layer signaling) is a method of transferring a signal from a base station to a terminal by using a physical layer downlink data channel or transferring a signal from a terminal to a base station by using a physical layer uplink data channel, and may be referred to as RRC signaling, PDCP signaling, or a medium access control (MAC) control element (MAC CE).

Hereinafter, in the following description, higher-layer signaling may be signaling corresponding to at least one of or a combination of one or more of the following signaling types.
MIB
SIB or SIB X (X=1, 2, . . . )
RRC
MAC CE

In addition, L1 signaling may be signaling corresponding to at least one of signaling methods using the following physical layer channels or signaling types or a combination of one or more thereof.
PDCCH
DCI
Terminal-specific (UE-specific) DCI
Group common DCI
Common DCI
Scheduling DCI (e.g., DCI used for scheduling of downlink or uplink data)
Non-scheduling DCI (e.g., DCI not for the purpose of scheduling downlink or uplink data)
PUCCH
UCI

Hereinafter, determination of the priority between A and B may be mentioned in various ways, such as selecting one having a higher priority according to a predetermined priority rule so as to perform an operation corresponding thereto, or omitting or dropping an operation having a lower priority.

Hereinafter, the term “slot” is used as a general term that may refer to a specific time unit corresponding to a transmit time interval (TTI), and specifically, a slot may refer to a slot used in a 5G NR system and may also refer to a slot or subframe used in a 4G LTE system.

Hereinafter, descriptions of the examples are provided via multiple embodiments, but these are not independent of each other, and it is possible that one or more embodiments are applied simultaneously or in combination.

### First Embodiment: Single TCI State Activation and Indication Method Based on the Integrated TCI Scheme

According to an embodiment, a method of indicating and activating a single TCI state based on an integrated TCI scheme is described. The integrated TCI scheme may refer to a scheme of integrating and managing a transmission/reception beam management scheme which is distinguished by a spatial relation info scheme used in uplink transmission and a TCI state scheme used in downlink reception by the terminal in existing Rel-15 and Rel-16. Therefore, if the terminal is indicated with a TCI state from the base station, based on the integrated TCI scheme, beam management may be performed using the TCI state even for uplink transmission. If the terminal is configured with TCI-State that is higher-layer signaling having tci-stateId-r17 that is higher-layer signaling from the base station, the terminal may perform an operation based on the integrated TCI scheme by using the corresponding TCI-State. TCI-State may exist in two types of a joint TCI state or a separate TCI state.

The first type is a joint TCI state, and the terminal may be indicated, by the base station via one TCI-State, with TCI-State to be applied to both uplink transmission and downlink reception. If the terminal is indicated with joint TCI state-based TCI-State, the terminal may be indicated with a parameter to be used for downlink channel estimation by using an RS corresponding to qcl-Type1 in the joint TCI state-based TCI-State and a parameter to be used as a downlink reception beam or reception filter by using an RS corresponding to qcl-Type2. If the terminal is indicated with joint TCI state-based TCI-State, the terminal may be indicated with a parameter to be used as an uplink transmission beam or transmission filter by using an RS corresponding to qcl-Type2 in corresponding joint DL/UL TCI state-based TCI-State. In this case, if the terminal is indicated with joint TCI state-based TCI-State, the terminal may apply the same beam to both uplink transmission and downlink reception.

The second type is a separate TCI state, and the terminal may be individually indicated, by the base station, with UL TCI-State to be applied to uplink transmission and DL TCI-State to be applied to downlink reception. If the terminal is indicated with a UL TCI state, the terminal may be indicated with a parameter to be used as an uplink transmission beam or transmission filter by using a reference RS or a source RS configured within the UL TCI state. If the terminal is indicated with a DL TCI state, the terminal may be indicated with a parameter to be used for downlink channel estimation by using an RS corresponding to qcl-Type1 and a parameter to be used as a downlink reception beam or reception filter by using an RS corresponding to qcl-Type2, the parameters being configured in the DL TCI state.

If the terminal is indicated with both DL TCI state and UL TCI state, the terminal may be indicated with a parameter to be used as an uplink transmission beam or transmission filter by using a reference RS or a source RS configured within the UL TCI state, and may be indicated with a parameter to be used for downlink channel estimation by using an RS corresponding to qcl-Type1 and a parameter to be used as a downlink reception beam or reception filter by using an RS corresponding to qcl-Type2, the parameters being configured in the DL TCI state. In this case, if the DL TCI state indicated to the terminal and the reference RS or source RS configured within the UL TCI state are different, the terminal may apply an uplink transmission beam based on the indicated UL TCI state and apply a downlink reception beam based on the DL TCI state.

The terminal may be configured with up to 128 joint TCI states for each specific BWP in a specific cell via higher-layer signaling by the base station, up to 64 or 128 DL TCI states among separate TCI states may be configured for each specific BWP in a specific cell, based on a UE capability report, via higher-layer signaling, and the DL TCI states and the joint TCI states in the separate TCI states may use the same higher-layer signaling structure. For example, if 128 joint TCI states are configured, and 64 DL TCI states are configured among separate TCI states, the 64 DL TCI states may be included in the 128 joint TCI states.

Up to 32 or 64 UL TCI states among the separate TCI states may be configured for each specific BWP in a specific cell, based on the UE capability report, via higher-layer signaling, and like the relationship between the joint TCI states and the DL TCI states among the separate TCI states, the joint TCI states and the UL TCI states among the separate TCI states may also use the same higher-layer signaling structure, wherein the UL TCI states among the separate TCI states may use a higher-layer signaling structure different from that of the joint TCI states and the DL TCI states among the separate TCI states. As described above, using different higher-layer signaling structures or using the same higher-layer signaling structure may be defined in the standards, and based on the UE capability report including information on whether there is a use scheme supportable by the terminal among the two types, the use of the scheme may be distinguished via another higher-layer signaling configured by the base station.

The terminal may receive a transmission/reception beam-related indication in an integrated TCI scheme by using one scheme among the joint TCI state and the separate TCI state configured by the base station. The terminal may be configured with whether to use one of the joint TCI state and the separate TCI state, by the base station via higher layer signaling.

The terminal may receive a transmission/reception beam-related indication by using one scheme selected from among the joint TCI state and the separate TCI state via higher-layer signaling, wherein a method of transmission/reception beam indication from the base station may include two methods of a MAC-CE-based indication method and a MAC-CE-based activation and DCI-based indication method.

If the terminal is configured, via higher layer signaling, to receive a transmission/reception beam-related indication by using the joint TCI state scheme, the terminal may receive a MAC-CE indicating the joint TCI state from the base station and perform a transmission/reception beam applying operation, and the base station may schedule, for the terminal, reception of a PDSCH including the MAC-CE via a PDCCH. If there is one joint TCI state included in the MAC-CE, the terminal may transmit, to the base station, a PUCCH including HARQ-ACK information indicating whether reception of the PDSCH including the MAC-CE is successful, and may determine an uplink transmission beam or transmission filter and a downlink reception beam or reception filter by using the indicated joint TCI state from 3 ms after transmission of the PUCCH. If there are two or more joint TCI states included in the MAC-CE, the terminal may transmit, to the base station, the PUCCH including HARQ-ACK information indicating whether reception of the PDSCH including the MAC-CE is successful, identify, from 3 ms after transmission of the PUCCH, that multiple joint TCI states indicated by the MAC-CE correspond to each codepoint of a TCI state field of DCI format 1_1 or 1_2, and activate the joint TCI states indicated by the MAC-CE. Thereafter, the terminal may receive DCI format 1_1 or 1_2 and apply one joint TCI state indicated by a corresponding TCI state field in the DCI to uplink transmission and downlink reception beams. In this case, DCI format 1_1 or 12 may include downlink data channel scheduling information (with DL assignment) or may not include the same (without DL assignment).

If the terminal is configured, via higher layer signaling, to receive a transmission/reception beam-related indication by using the separate TCI state scheme, the terminal may receive a MAC-CE indicating the separate TCI state from the base station and perform a transmission/reception beam applying operation, and the base station may schedule, for the terminal, reception of a PDSCH including the MAC-CE via a PDCCH. If there is one separate TCI state set included in the MAC-CE, the terminal may transmit, to the base station, a PUCCH including HARQ-ACK information indicating whether reception of the PDSCH is successful, and may determine an uplink transmission beam or transmission filter and a downlink reception beam or reception filter by using separate TCI states included in the indicated separate TCI state set from 3 ms after transmission of the PUCCH. In this case, the separate TCI state set may refer to a single separate TCI state or multiple separate TCI states that one codepoint of the TCI state field in DCI format 1_1 or 1_2 may have, and one separate TCI state set may include one DL TCI state, include one UL TCI state, or include one DL TCI state and one UL TCI state. If there are two or more separate TCI state sets included in the MAC-CE, the terminal may transmit, to the base station, the PUCCH including HARQ-ACK information indicating whether reception of the PDSCH is successful, identify, from 3 ms after transmission of the PUCCH, that multiple separate TCI state sets indicated by the MAC-CE correspond to each codepoint of the TCI state field of DCI format 1_1 or 1_2, and activate the indicated separate TCI state sets. In this case, each codepoint of the TCI state field of DCI format 1_1 or 1_2 may indicate one DL TCI state, indicate one UL TCI state, or indicate one DL TCI state and one UL TCI state. The terminal may receive DCI format 1_1 or 1_2 and apply a separate TCI state set indicated by a corresponding TCI state field in the DCI to uplink transmission and downlink reception beams. In this case, DCI format 1_1 or 1_2 may include downlink data channel scheduling information (i.e., with DL assignment) and may not include same (i.e., without DL assignment).

The MAC-CE used to activate or indicate the single joint TCI state and the separate TCI state described above may exist for each of the joint and separate TCI state schemes, and a TCI state may be activated or indicated based on one of the joint TCI state scheme or the separate TCI state scheme by using one MAC-CE. Various MAC-CE structures for activation and indication of the joint or separate TCI state may be considered.

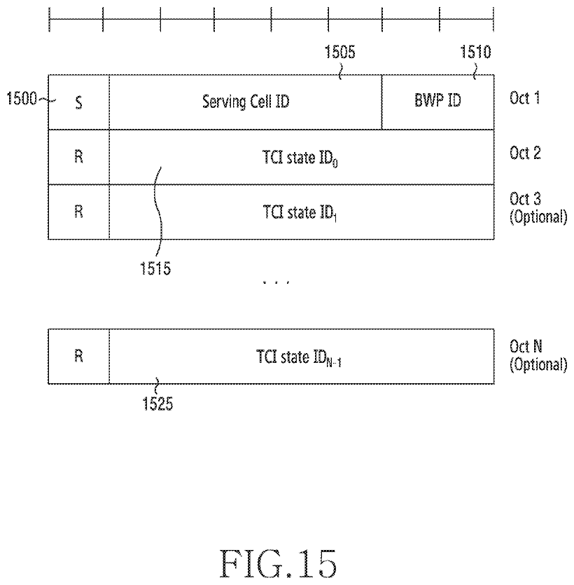

FIG. 15 is a diagram illustrating a MAC-CE structure for activation and indication of a joint TCI state in the wireless communication system, according to an embodiment.

Referring to FIG. 15, an S field 1500 may indicate the number of pieces of joint TCI state information included in an MAC-CE. If a value of the S field 1500 is 1, the MAC-CE may indicate one joint TCI state and may have a length of only up to a second octet. If the value of the S field 1500 is 0, the MAC-CE may include two or more pieces of joint TCI state information, each joint TCI state may be activated at each codepoint of a TCI state field of DCI format 1_1 or 1_2, and up to 8 joint TCI states may be activated. Configuring the values of 0 and 1 of the S field 1500 is not limited to the configuration method, wherein value 0 may indicate to include one joint TCI state, and value 1 may indicate to include two or more pieces of joint TCI state information. This interpretation of the S field may also be applied to other embodiments of the disclosure. TCI states indicated via a TCI state ID0 field 1515 to a TCI state IDN−1 field 1525 may correspond to a zeroth codepoint to an (N−1)th codepoint of the TCI state field of DCI format 1_1 or 1_2, respectively. A serving cell ID field 1505 may indicate a serving cell identifier (ID), and a BWP ID field 1510 may indicate a BWP ID. An R field may be a 1-bit reserve field that does not include indication information.

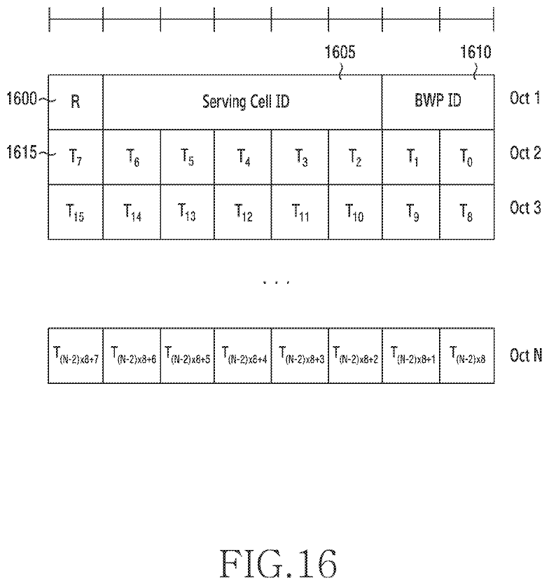

FIG. 16 is a diagram illustrating another MAC-CE structure for activation and indication of a joint TCI state in the wireless communication system, according to an embodiment.

In FIG. 16, a serving cell ID field 1605 may indicate a serving cell identifier (ID), and a BWP ID field 1610 may indicate a BWP ID. An R field 1600 may be a 1-bit reserve field that does not include indication information. Each field present in a second octet to an Nth octet is a bitmap indicating each joint TCI state configured via higher-layer signaling. As an example, T7 1615 may be a field indicating whether an eighth joint TCI state configured via higher-layer signaling is indicated. If a TN value is 1, it may be interpreted that a corresponding joint TCI state is indicated or activated, and if the TN value is 0, it may be interpreted that a corresponding joint TCI state is not indicated or activated. Configuring values 0 and 1 is not limited to the above configuration method. If there is one joint TCI state transmitted via the MAC-CE structure of FIG. 16, the terminal may apply the joint TCI state indicated via the MAC-CE to uplink transmission and downlink reception beams. If there are two or more joint TCI states transferred via the MAC-CE structure, the terminal may identify that each joint TCI state indicated via the MAC-CE corresponds to each codepoint of a TCI state field of DCI format 1_1 or 1_2, and may activate each joint TCI state, and starting from a joint TCI state having the lowest index from among the indicated joint TCI states, the joint TCI states sequentially corresponding to codepoints with low indexes of the TCI state field of DCI format 1_1 or 1_2 may be activated in order.

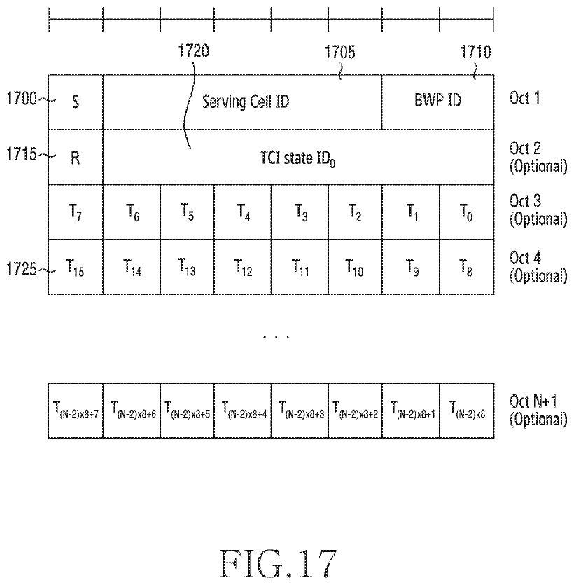

FIG. 17 is a diagram illustrating another MAC-CE structure for activation and indication of a joint TCI state in the wireless communication system, according to an embodiment.

In FIG. 17, a serving cell ID field 1705 may indicate a serving cell identifier (ID), and a BWP ID field 1710 may indicate a BWP ID.

An S field 1700 may indicate the number of pieces of joint TCI state information included in an MAC-CE. If, for example, a value of the S field 1700 is 1, the MAC-CE may indicate one joint TCI state and may include only up to a second octet, and the joint TCI state may be indicated to a terminal via a TCI state ID0 field 1720. If the value of the S field 1700 is 0, the MAC-CE may include two or more pieces of joint TCI state information, each codepoint of a TCI state field of DCI format 1_1 or 1_2 may activate each joint TCI state, up to 8 joint TCI states may be activated, no second octet may exist, and there may be a first octet and a third octet to an (N+1)th octet on the MAC-CE structure of FIG. 17. Respective fields present in the third octet to the (N+1)th octet are bitmaps indicating respective joint TCI states configured via higher-layer signaling. As an example, T15 1725 may be a field indicating whether a 16th joint TCI state configured via higher-layer signaling is indicated. An R field 1715 may be a 1-bit reserve field that does not include indication information.

If there is one joint TCI state transmitted via the MAC-CE structure of FIG. 17, the terminal may apply the joint TCI state indicated via the MAC-CE to uplink transmission and downlink reception beams. If there are two or more joint TCI states transferred via the MAC-CE structure of FIG. 17, the terminal may identify that each joint TCI state indicated via the MAC-CE corresponds to each codepoint of a TCI state field of DCI format 1_1 or 12, and may activate each joint TCI state, and starting from a joint TCI state having the lowest index from among the indicated joint TCI states, the joint TCI states sequentially corresponding to codepoints with low indexes of the TCI state field of DCI format 1_1 or 1_2 may be activated in order.

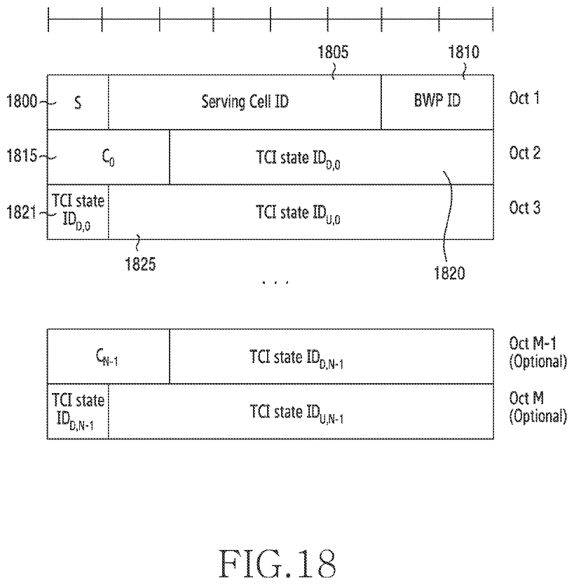

FIG. 18 is a diagram illustrating a MAC-CE structure for activation and indication of a separate TCI state in the wireless communication system, according to an embodiment.

In FIG. 18, a serving cell ID field 1805 may indicate a serving cell ID, and a BWP ID field 1810 may indicate a BWP ID.

An S field 1800 may indicate the number of pieces of joint TCI state set information included in an MAC-CE. If, for example, a value of the S field 1800 is 1, the MAC-CE may indicate one separate TCI state set and may include only up to a third octet. If the value of the S field 1800 is 0, the MAC-CE may include two or more pieces of separate TCI state set information, each codepoint of a TCI state field of DCI format 1_1 or 1_2 may activate each separate TCI state set, and up to 8 separate TCI state sets may be activated. A C0 field 1815 may be a field indicating which separate TCI states are included in an indicated separate TCI state set. For example, a C0 field value of “00” may indicate reserve, the C0 field value of “01” may indicate one DL TCI state, the C0 field value of “10” may indicate one UL TCI state, and the C0 field value of “11” may indicate one DL TCI state and one UL TCI state. However, this is merely an example of interpretation of C0 field 1815, and the interpretation of C0 field 1815 is not limited thereto. A TCI state IDD,0 field 1820 and a TCI state IDU,0 field 1825 may refer to a DL TCI state and a UL TCI state which may be included in a zeroth separate TCI state set so as to be indicated, respectively. If the value of the C0 field is “01”, the TCI state IDD,0 field 1820 may indicate the DL TCI state, and the TCI state IDU,0 field 1825 may be ignored. If the value of the C0 field is “10”, the TCI state IDD,0 field 1820 may be ignored, and the TCI state IDU,0 field 1825 may indicate the UL TCI state. If the value of the C0 field is “11”, the TCI state IDD,0 field 1820 may indicate the DL TCI state, and the TCI state IDU,0 field 1825 may indicate the UL TCI state.

FIG. 18 may illustrate an example of an MAC-CE when a UL TCI state among separate TCI states uses a higher-layer signaling structure, such as a DL TCI state and a joint TCI state among the separate TCI states, as described above. Accordingly, lengths of the TCI state IDD,0 field 1820 and the TCI state IDU,0 field 1825 may be 7 bits to express up to 128 TCI states. Therefore, in order to use 7 bits for the TCI state IDD,0 field 1820, 6 bits 1820 may be assigned to a second octet and 1 bit 1821 may be assigned to a third octet. In addition, FIG. 18 may indicate a case in which a UL TCI state among separate TCI states uses a higher-layer signaling structure different from that of a DL TCI state and of a joint TCI state among the separate TCI states, as described above. Accordingly, since the UL TCI state requires 6 bits to enable expression up to 64 UL TCI states, a first bit of the TCI state IDU,0 field 1825 may be fixed to 0 or 1, and bits expressing an actual UL TCI state may correspond to only a total of 6 bits from a second bit to a seventh bit.

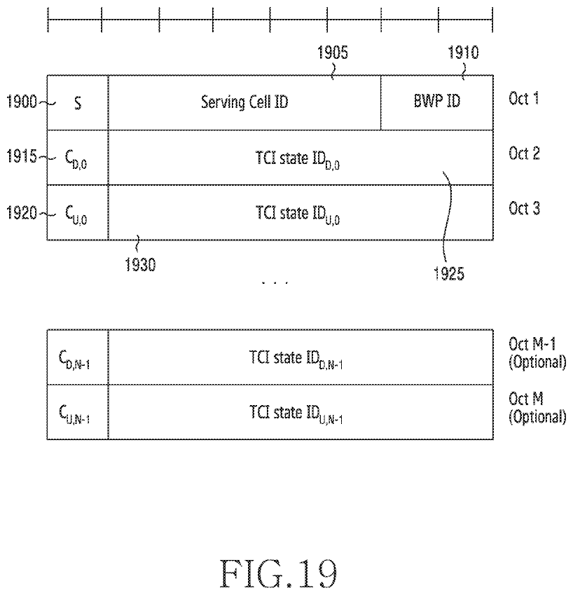

FIG. 19 is a diagram illustrating another MAC-CE structure for activation and indication of a separate TCI state in the wireless communication system, according to an embodiment.

In FIG. 19, a serving cell ID field 1905 may indicate a serving cell ID, and a BWP ID field 1910 may indicate a BWP ID. An S field 1900 may indicate the number of pieces of separate TCI state set information included in an MAC-CE. If, for example, a value of the S field 1900 is 1, the MAC-CE may indicate one separate TCI state set and may include only up to a third octet. If, for example, the value of the S field 1900 is 0, the MAC-CE may include two or more pieces of separate TCI state set information, each codepoint of a TCI state field of DCI format 1_1 or 1_2, which corresponds to each separate TCI state set, may activate each separate TCI state set, and up to 8 separate TCI state sets may be activated. A CD,0 field 1915 may be a field indicating whether an indicated separate TCI state set includes a DL TCI state, wherein if a value of the CD,0 field 1915 is 1, a DL TCI state may be included and the DL TCI state may be indicated via a TCI state IDD,0 field 1925, and if the value of the CD,0 field 1915 is 0, no DL TCI state is included and the TCI state IDD,0 field 1925 may be ignored. Similarly, a CU,0 field 1920 may be a field indicating whether an indicated separate TCI state set includes a UL TCI state, wherein if a value of the CU,0 field 1920 is 1, a UL TCI state may be included and the UL TCI state may be indicated via a TCI state IDU,0 field 1930, and if the value of the CU,0 field 1920 is 0, no UL TCI state is included and the TCI state IDU,0 field 1930 may be ignored.

FIG. 19 may illustrate an example of an MAC-CE when a UL TCI state among separate TCI states uses the same higher-layer signaling structure as that of a DL TCI state and of a joint TCI state among the separate TCI states, as described above. Accordingly, lengths of the TCI state IDD,0 field 1925 and the TCI state IDU,0 field 1930 may be 7 bits to express up to 128 TCI states. In addition, FIG. 19 may illustrate an example of an MAC-CE when a UL TCI state among separate TCI states uses a higher-layer signaling structure different from that of a DL TCI state and of a joint TCI state among the separate TCI states, as described above. Accordingly, since the UL TCI state requires 6 bits to enable expression up to 64 UL TCI states, a first bit of the TCI state IDU,0 field 1925 may be fixed to 0 or 1, and bits expressing an actual UL TCI state may correspond to only a total of 6 bits from a second bit to a seventh bit.

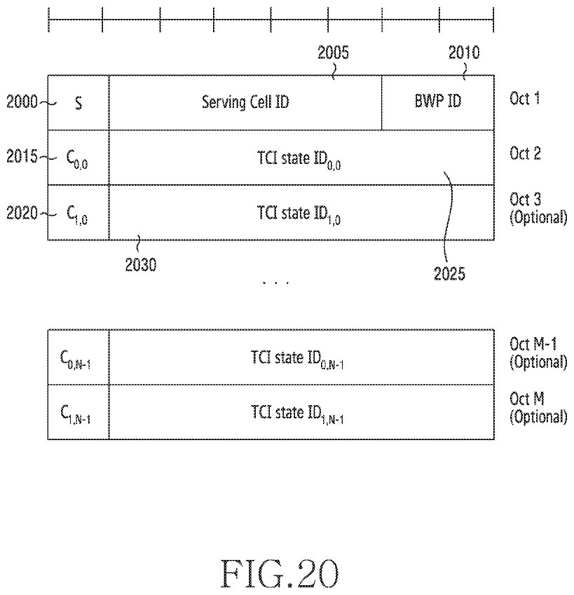

FIG. 20 is a diagram illustrating another MAC-CE structure for activation and indication of a separate TCI state in the wireless communication system, according to an embodiment.

In FIG. 20, a serving cell ID field 2005 may indicate a serving cell ID, and a BWP ID field 2010 may indicate a BWP ID. An S field 2000 may indicate the number of pieces of separate TCI state set information included in an MAC-CE. If, for example, a value of the S field 2000 is 1, the MAC-CE may indicate one separate TCI state set and may include only up to a third octet. The MAC-CE structure of FIG. 20 may indicate one separate TCI state set by using two octets, if the separate TCI state set includes a DL TCI state, a first octet of the two octets may indicate the DL TCI state, and a second octet may indicate a UL TCI state. Alternatively, this order may be changed.

If the value of the S field 2000 is 0, the MAC-CE may include two or more pieces of separate TCI state set information, each codepoint of a TCI state field of DCI format 1_1 or 1_2 may activate each separate TCI state set, and up to 8 separate TCI state sets may be activated. A C0,0 field 2015 may have a meaning for distinguishing whether a TCI state indicated by a TCI state ID0,0 field 2025 is a DL TCI state or a UL TCI state. A C0,0 field 2015 value of 1 may indicate a DL TCI state, the DL TCI state may be indicated via the TCI state ID0,0 field 2025, and a third octet may exist. In this case, if a value of a C1,0 field 2020 is 1, a UL TCI state may be indicated via a TCI state ID1,0 field 2030, and if the value of the C1,0 field 2020 is 0, the TCI state ID1,0 field 2030 may be ignored. If the value of the C0,0 field 2015 is 0, a UL TCI state may be indicated via the TCI state ID0,0 field 2025, and the third octet may not exist. This interpretation of the C0,0 field 2015 field and the C1,0 field 2020 is merely an example, and opposite interpretation of the C0,0 field 2015 field values of 0 and 1, or opposite interpretation of the DL TCI state and UL TCI state values is not excluded.

FIG. 20 may illustrate an example of an MAC-CE when a UL TCI state among separate TCI states uses the same higher-layer signaling structure as that of a DL TCI state and of a joint TCI state among the separate TCI states, as described above, and accordingly, lengths of the TCI state ID0,0 field 2025 and the TCI state ID1,0 field 2030 may be 7 bits to express up to 120 TCI states. In addition, FIG. 20 may illustrate an example of an MAC-CE when a UL TCI state among separate TCI states uses a higher-layer signaling structure different from that of a DL TCI state and of a joint TCI state among the separate TCI states, as described above. Accordingly, the TCI state ID0,0 field 2025 may be 7 bits enabling expression of both 6 bits to express up to 64 possible UL TCI states and 7 bits to express up to 120 possible DL TCI states. If the value of the C1,0 field 2015 is 1 and thus the TCI state ID0,0 field 2025 indicates a UL TCI state, a first bit of the TCI state ID0,0 field 2025 may be fixed to 0 or 1, and bits expressing an actual UL TCI state may correspond to only a total of 6 bits from a second bit to a seventh bit.

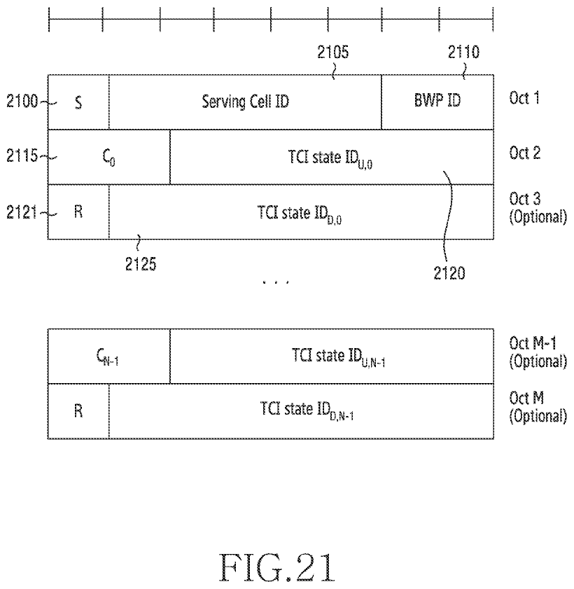

FIG. 21 is a diagram illustrating another MAC-CE structure for activation and indication of a separate TCI state in the wireless communication system, according to an embodiment.

In FIG. 21, a serving cell ID field 2105 may indicate a serving cell ID, and a BWP ID field 2110 may indicate a BWP ID. An S field 2100 may indicate the number of pieces of separate TCI state set information included in an MAC-CE. If, for example, a value of the S field 2100 is 1, the MAC-CE may indicate one separate TCI state set and may include only up to a third octet.

If the value of the S field 2100 is 0, the MAC-CE may include two or more pieces of separate TCI state set information, each codepoint of a TCI state field of DCI format 1_1 or 1_2 may activate each separate TCI state set, and up to 8 separate TCI state sets may be activated. A C0 field 2115 may be a field indicating which separate TCI states are included in an indicated separate TCI state set, a C0 field 2115 value of “00” may indicate reserve, the C0 field 2115 value of “01” may indicate one DL TCI state, the C0 field 2115 value of “10” may indicate one UL TCI state, and the C0 field 2115 value of “11” may indicate one DL TCI state and one UL TCI state. However, this is merely an example of interpretation of the C0 field 2115, and the interpretation of C0 field 2125 is not limited thereto. A TCI state IDU,0 field 2120 and a TCI state IDD,0 field 2125 may refer to a UL TCI state and a DL TCI state which may be included in a zeroth separate TCI state set so as to be indicated, respectively. If the value of the C0 field 2115 is “01”, the TCI state IDD,0 field 2125 may indicate the DL TCI state, and the TCI state IDU,0 field 2120 may be ignored. If the value of the C0 field 2115 is “10”, a third octet may be ignored, and the TCI state IDU,0 field 2120 may indicate the UL TCI state. If the value of the C0 field 2115 is “11”, the TCI state IDD,0 field 2125 may indicate the DL TCI state, and the TCI state IDU,0 field 2120 may indicate the UL TCI state. An R field 2121 may be a 1-bit reserve field that does not include indication information.

FIG. 21 may illustrate an example of an MAC-CE used when a UL TCI state among separate TCI states uses a higher-layer signaling structure different from that of a DL TCI state and of a joint TCI state among the separate TCI states, as described above. Accordingly, 7 bits may be used to express up to 128 TCI states for a length of the TCI state IDD,0 field 2125, and 6 bits may be used to express up to 64 TCI states for a length of the TCI state IDU,0 field 2120.

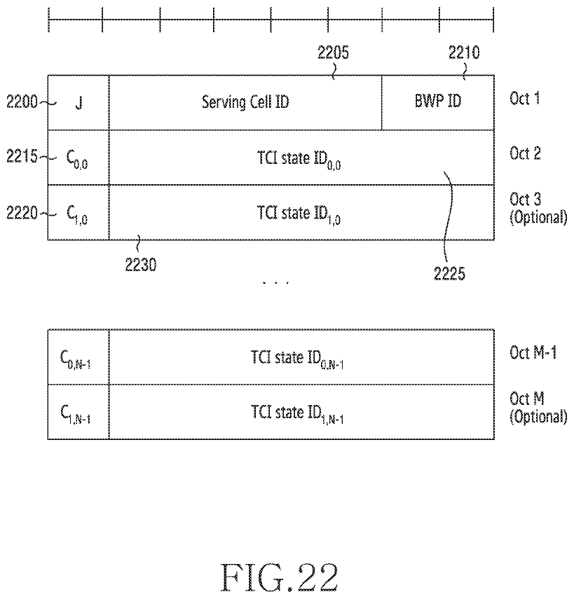

FIG. 22 is a diagram illustrating a MAC-CE structure for joint and separate TCI state activation and indication in the wireless communication system, according to an embodiment.

In FIG. 22, a serving cell ID field 2205 may indicate a serving cell ID, and a BWP ID field 2210 may indicate a BWP ID. A J field 2200 may indicate whether a TCI state indicated via a MAC CE is a joint TCI state or a separate TCI state set. For example, if a value of the J field 2200 is 1, the MAC-CE may indicate a joint TCI state and if the value of the J field 2200 is 0, the MAC-CE may indicate a separate TCI state set. The above interpretation of the J field 2200 is merely an example, and opposite interpretation is not excluded.

If the MAC-CE indicates the joint TCI state, all odd-numbered octets (a third octet, a fifth octet, . . . ) other than a first octet may be ignored. A C0,0 field 2215 may indicate whether the MAC-CE indicates one joint TCI state or includes two or more pieces of TCI state information, and may indicate whether each codepoint of a TCI state field of DCI format 1_1 or 1_2 activates each TCI state. If a value of the C0,0 field 2215 is 1, the MAC-CE may indicate one joint TCI state, and a third octet and more may not exist. If the value of the C0,0 field 2215 is 0, two or more joint TCI states indicated by the MAC-CE correspond to each codepoint of the TCI state field of DCI format 1_1 or 1_2 and may be activated. A TCI state ID0,0 may refer to a first indicated joint TCI state.

If the MAC-CE indicates a separate TCI state set, for example, the C0,0 field 2215 may have a meaning of distinguishing whether a TCI state indicated by the TCI state ID0,0 field 2225 is a DL TCI state or a UL TCI state, a value of 1 may indicate a DL TCI state, the DL TCI state may be indicated via the TCI state IDD,0 field 2225, and the third octet may exist. In this case, if a value of a C1,0 field 2220 is 1, a UL TCI state may be indicated via a TCI state ID1,0 field 2230, and if the value of the C1,0 field 2220 is 0, the TCI state ID1,0 field 2230 may be ignored. If the value of the C0,0 field 2215 is 0, a UL TCI state may be indicated via the TCI state ID0,0 field 2225, and the third octet may not exist. FIG. 22 may illustrate an example of an MAC-CE used when a UL TCI state among separate TCI states uses the same higher-layer signaling structure as that of a DL TCI state and of a joint TCI state among the separate TCI states, as described above. Accordingly, lengths of the TCI state ID0,0 field 2225 and the TCI state ID1,0 field 2230 may be 7 bits to express up to 128 TCI states. In addition, FIG. 22 may illustrate an example of an MAC-CE used when a UL TCI state among separate TCI states uses a higher-layer signaling structure different from that of a DL TCI state and of a joint TCI state among the separate TCI states, as described above. Accordingly, the TCI state ID0,0 field 2225 use 7 bits enabling expression of both 6 bits to express up to 64 possible UL TCI states and 7 bits to express up to 128 possible DL TCI states. If the value of the C0,0 field 2215 is 1 and thus the TCI state ID0,0 field 2225 indicates a UL TCI state, a first bit of the TCI state ID0,0 field 2225 may be fixed to 0 or 1, and bits expressing an actual UL TCI state may correspond to only a total of 6 bits from a second bit to a seventh bit.

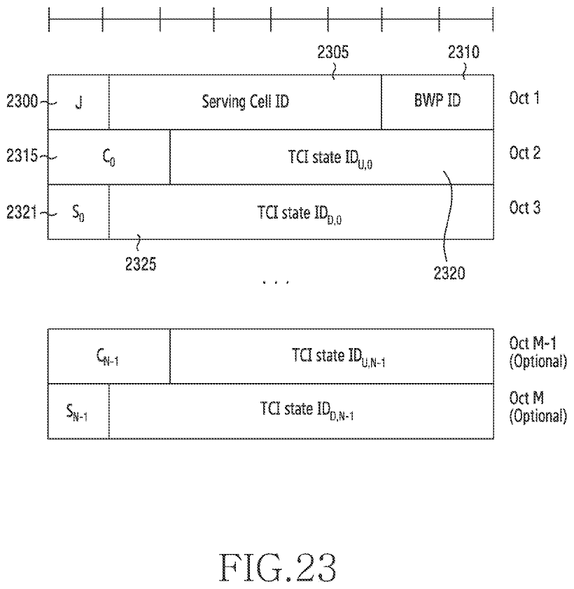

FIG. 23 is a diagram illustrating another MAC-CE structure for joint and separate TCI state activation and indication in the wireless communication system, according to an embodiment.

In FIG. 23, a serving cell ID field 2305 and a BWP ID field 2310 may indicate a serving cell ID and a BWP ID, respectively. A J field 2300 may indicate whether a TCI state indicated via a MAC CE is a joint TCI state or a separate TCI state set. For example, if a value of the J field 2300 is 1, the MAC-CE may indicate a joint TCI state and if the value of the J field 2300 is 0, the MAC-CE may indicate a separate TCI state set. The above interpretation of the J field 2300 is merely an example, and opposite interpretation is not excluded.

If the MAC-CE indicates the joint TCI state, all even-numbered octets (a second octet, a fourth octet, . . . ) other than a first octet may be ignored. An S0 field 2321 may indicate whether the MAC-CE indicates one joint TCI state or whether two or more TCI states correspond to each codepoint of a TCI state field of DCI format 1_1 or 1_2 and are activated. If a value of the S0 field 2321 is 1, the MAC-CE may indicate one joint TCI state, and a third octet and more may not exist. If the value of the S0 field 2321 is 0, the MAC-CE may include two or more pieces of joint TCI state information, and each codepoint of the TCI state field of DCI format 1_1 or 1_2 may activate each joint TCI state. A TCI state IDD,0 may refer to a first indicated joint TCI state.

If the MAC-CE indicates a separate TCI state set, a C0 field 2315 may be a field indicating which separate TCI states are included in the indicated separate TCI state set. A C0 field 2315 value of “00” may indicate reserve, the C0 field 2315 value of “01” may indicate one DL TCI state, the C0 field 2315 value of “10” may indicate one UL TCI state, and the C0 field 2315 value of “11” may indicate one DL TCI state and one UL TCI state. These values are merely examples and the disclosure is not limited by these examples. A TCI state IDU,0 field 2320 and a TCI state IDD,0 field 2325 may refer to a UL TCI state and a DL TCI state which may be included in a zeroth separate TCI state set so as to be indicated, respectively. If the value of the C0 field 2315 is “01”, the TCI state IDD,0 field 2325 may indicate the DL TCI state and the TCI state IDU,0 field 2320 may be ignored, if the value of the C0 field 2315 is “10”, the TCI state IDU,0 field 2320 may indicate the UL TCI state, and if the value of the C0 field 2315 is “11”, the TCI state IDD,0 field 2325 may indicate the DL TCI state, and the TCI state IDU,0 field 2320 may indicate the UL TCI state. If the value of the S0 field 2321 is 1, the MAC-CE may indicate one separate TCI state set, and a fourth octet and more may not exist. If the value of the S0 field 2321 is 0, the MAC-CE may include two or more pieces of separate TCI state set information, each codepoint of the TCI state field of DCI format 1_1 or 1_2 may activate each separate TCI state set, and up to 8 separate TCI state sets may be activated. For example, if the value of the S0 field 2321 is 0, if values of C1, . . . , CN−1 fields are “10”, this indicates that only UL TCI states are indicated, so that a fifth octet, a seventh octet, . . . , an Mth octet may be ignored. Alternatively, an Sn field may indicate whether an octet for a subsequent separate TCI state set exists. For example, if the value of the Sn field is 1, a subsequent octet may not exist, and if the value of the Sn field is 0, subsequent octets including Cn+1 and TCI state IDU,n+1 may exist. These Sn field values are merely examples, and the disclosure is not limited by these examples.

FIG. 23 may illustrate an example of an MAC-CE when a UL TCI state among separate TCI states uses a higher-layer signaling structure different from that of a DL TCI state and of a joint TCI state among the separate TCI states, as described above. Accordingly, a length of the TCI state IDD,0 field 2325 may be 7 bits to express up to 128 TCI states, and a length of the TCI state IDU,0 field 2320 may be 6 bits to express up to 64 TCI states.

If a terminal receives a transmission/reception beam-related indication by using a joint TCI state scheme or a separate TCI state scheme via higher-layer signaling, the terminal may receive a PDSCH including a MAC-CE indicating the joint TCI state or the separate TCI state from a base station so as to perform application to a transmission/reception beam. If there are two or more joint TCI states or separate TCI state sets included in the MAC-CE, as described above, from 3 ms after transmission of a PUCCH including HARQ-ACK information indicating the success or failure in reception of a corresponding PDSCH, the terminal may identify that multiple joint TCI states or separate TCI state sets indicated via the MAC-CE correspond to each codepoint of the TCI state field of DCI format 1_1 or 1_2, and may activate the indicated joint TCI states or separate TCI state sets. Thereafter, the terminal may receive DCI format 1_1 or 1_2 and apply one joint TCI state or separate TCI state set indicated by a corresponding TCI state field in DCI to uplink transmission and downlink reception beams. In this case, DCI format 1_1 or 1_2 may include downlink data channel scheduling information (with DL assignment) or may not include the same (without DL assignment).

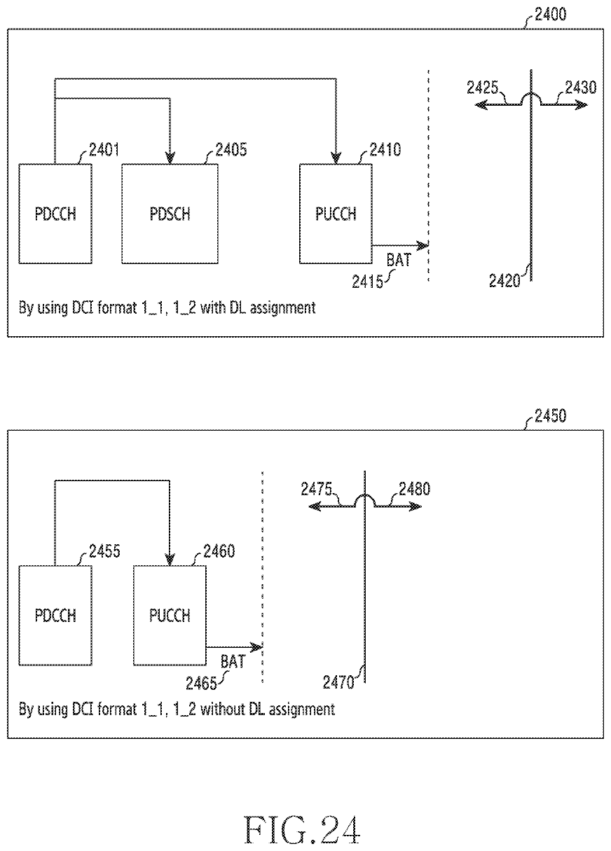

FIG. 24 is a diagram for a beam application time that may be considered when an integrated TCI scheme is used in the wireless communication system, according to an embodiment.

As described above, a terminal may receive DCI format 1_1 or 1_2 which includes downlink data channel scheduling information (with DL assignment) or does not include downlink data channel scheduling information (without DL assignment) from a base station, and apply one joint TCI state or separate TCI state set indicated by a corresponding TCI state field in DCI to uplink transmission and downlink reception beams.

DCI format 1_1 or 1_2 with DL assignment 2400: If the terminal receives 2401 DCI format 1_1 or 1_2 including downlink data channel scheduling information from the base station and indicates one joint TCI state or separate TCI state set based on an integrated TCI scheme, the terminal may receive 2405 a PDSCH scheduled based on the received DCI, and transmit 2410, to the base station, a PUCCH including HARQ-ACK indicating the success or failure in reception of the DCI and the PDSCH. In this case, the HARQ-ACK may include the success or failure in reception of both the DCI and the PDSCH, the terminal may transmit NACK if at least one of the DCI and the PDSCH cannot be received, and the terminal may transmit ACK if both have been successfully received.

DCI format 1_1 or 1_2 without DL assignment 2450: If the terminal receives 2455 DCI format 1_1 or 12 including no downlink data channel scheduling information from the base station and indicates one joint TCI state or separate TCI state set based on the integrated TCI scheme, the terminal may assume the following for the DCI.
CRC scrambled using CS-RNTI is included.
Values of all bits assigned to all fields used as a redundancy version (RV) field are 1.
Values of all bits assigned to all fields used as a modulation and coding scheme (MCS) field are 1.
Values of all bits assigned to all fields used as a new data indication (NDI) field are 0.
Values of all bits assigned to a frequency domain resource allocation (FDRA) field are 0 for FDRA type 0, values of all bits assigned to the FDRA field are 1 for FDRA type 1, and if an FDRA scheme is dynamicSwitch, values of all bits assigned to the FDRA field are 0.

The terminal may transmit 2460, to the base station, a PUCCH including HARQ-ACK indicating the success or failure in reception of DCI format 1_1 or 1_2 for which the above matters have been assumed.

With respect to both DCI format 1_1 or 1_2 with DL assignment 2400 and without DL assignment 2450, if a new TCI state indicated via the DCI 2401 or 2455 is the same as the TCI state previously indicated and applied to uplink transmission and downlink reception beams, the terminal may maintain the previously applied TCI state. If the new TCI state is different from the previously indicated TCI state, the terminal may determine that a time point of applying the joint TCI state or separate TCI state set, which may be indicated from the TCI state field included in the DCI, is applied (interval of 2430 or 2480) from a start point 2420 or 2470 of a first slot after a beam application time (BAT) 2415 or 2465 subsequent to PUCCH transmission, and may use the previously indicated TCI-state until the interval 2425 or 2475 before the start point 2420 or 2470 of the slot.

With respect to both DCI format 1_1 or 1_2 with DL assignment 2400 and without DL assignment 2450, a BAT is a specific number of OFDM symbols and may be configured via higher-layer signaling based on UE capability report information. The BAT and a numerology for the first slot after the BAT may be determined based on a smallest numerology among all cells to which the joint TCI state or separate TCI state set indicated via the DCI is applied.

The terminal may apply one joint TCI state indicated via the MAC-CE or DCI to reception of control resource sets linked to all UE-specific search spaces, reception of a PDSCH scheduled via a PDCCH transmitted from a corresponding control resource set, transmission of a PUSCH, and transmission of all PUCCH resources.

If one separate TCI state set indicated via the MAC-CE or DCI includes one DL TCI state, the terminal may apply the one separate TCI state set to reception of control resource sets linked to all UE-specific search spaces and reception of a PDSCH scheduled via a PDCCH transmitted from a corresponding control resource set, and based on a previously indicated UL TCI state, may apply the same to all PUSCH and PUCCH resources.

If one separate TCI state set indicated via the MAC-CE or DCI includes one UL TCI state, the terminal may apply the separate TCI state set to all PUSCH and PUCCH resources, and based on the previously indicated DL TCI state, may apply the same to reception of control resource sets linked to all UE-specific search spaces and reception of a PDSCH scheduled via a PDCCH transmitted from a corresponding control resource set.

If one separate TCI state set indicated via the MAC-CE or DCI includes one DL TCI state and one UL TCI state, the terminal may apply the DL TCI state to reception of control resource sets linked to UE-specific search spaces and reception of a PDSCH scheduled via a PDCCH transmitted from a corresponding control resource set, and may apply the UL TCI state to all PUSCH and PUCCH resources.

In the aforementioned examples of the MAC CE in FIG. 15 to FIG. 23, it is possible that one or more elements are coupled to each other.

### Second Embodiment: Multi-TCI State Indication and Activation Method Based on the Integrated TCI Scheme

According to an embodiment, a method of indicating and activating a multi-TCI state based on an integrated TCI scheme is described. A multi-TCI state indication and activation method may refer to a case in which the number of indicated joint TCI states is extended to two or more and a case in which each of a DL TCI state and a UL TCI state included in one separate TCI state set is expanded to two or more. If one separate TCI state set can include up to two DL TCI states and up to two UL TCI states, a total of 8 combinations of DL TCI states and UL TCI states that one separate TCI state set can have may be possible ({DL,UL}={0,1}, {0,2}, {1,0}, {1,1}, {1,2}, {2,0}, {2,1}, {2,2}, where numbers indicate the number of TCI states).

If the terminal is indicated with the multi-TCI state based on the MAC-CE by the base station, the terminal may receive two or more joint TCI states or one separate TCI state set from the base station via the MAC-CE. The base station may schedule reception of a PDSCH including the MAC-CE for the terminal via a PDCCH, and from 3 ms after transmission of a PUCCH including HARQ-ACK information indicating the success or failure of reception of the PDSCH including the MAC-CE, the terminal may determine an uplink transmission beam or transmission filter and a downlink reception beam or reception filter, based on the indicated two or more joint TCI states or one separate TCI state set.

If the terminal is indicated with the multi-TCI state based on DCI format 1_1 or 1_2 from the base station, each codepoint of one TCI state field in DCI format 1_1 or 1_2 may indicate two or more joint TCI states or two or more separate TCI state sets. In this case, the terminal may receive the MAC-CE from the base station and activate two or more joint TCI states or two or more separate TCI state sets corresponding to each codepoint of one TCI state field in DCI format 1_1 or 1_2. The base station may schedule reception of a PDSCH including the MAC-CE for the terminal via a PDCCH, and the terminal may activate TCI state information included in the MAC-CE from 3 ms after transmission of a PUCCH including HARQ-ACK information indicating the success or failure of reception of the PDSCH including the MAC-CE.

If the terminal is indicated with the multi-TCI state based on DCI format 1_1 or 1_2 from the base station, two or more TCI state fields may exist in DCI format 1_1 or 1_2, and one of two or more joint TCI states or two or more separate TCI state sets may be indicated based on each TCI state field. In this case, the terminal may receive the MAC-CE from the base station and activate the joint TCI states or separate TCI state sets corresponding to each codepoint of two TCI state fields in DCI format 1_1 or 1_2. The base station may schedule reception of the PDSCH including the MAC-CE for the terminal via the PDCCH. The terminal may activate TCI state information included in the MAC-CE from 3 ms after transmission of the PUCCH including HARQ-ACK information indicating the success or failure of reception of the PDSCH including the MAC-CE. The terminal may be configured for the presence or absence of one or more additional TCI state fields via higher-layer signaling, the bit length of the additional TCI state fields may be the same as that of an existing TCI state field, or the length may be adjusted based on higher-layer signaling.

The terminal may receive a transmission/reception beam-related indication in an integrated TCI scheme by using one scheme among the joint TCI state and the separate TCI state configured by the base station. The terminal may be configured for using one of the joint TCI state or the separate TCI state, by the base station via higher-layer signaling. With respect to the separate TCI state indication, the terminal may be configured via higher-layer signaling so that a bit length of the TCI state field in DCI format 1_1 or 12 is up to 4.

The MAC-CE used to activate or indicate multiple joint TCI states and separate TCI states described above may exist for each of the joint and separate TCI state schemes, the TCI states may be activated or indicated based on one of the joint or separate TCI state schemes by using one MAC-CE, and the MAC-CE used for a MAC-CE-based indication scheme and a MAC-CE-based activation scheme may share one MAC-CE structure and may use an individual MAC-CE structure. Various MAC-CE structures for activation and indication of multiple joint or separate TCI states may be considered. A case in which two TCI states are activated or indicated is considered, but the disclosure may be applied to a case of three or more TCI states in a similar manner.

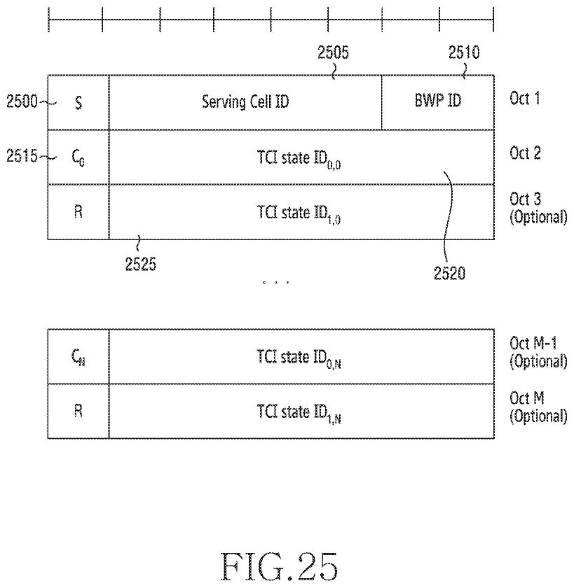

FIG. 25 is a diagram illustrating a MAC-CE structure for activation and indication of multiple joint TCI states in the wireless communication system, according to an embodiment.

In FIG. 25, a serving cell ID field 2505 may indicate a serving cell ID), and a BWP ID field 2510 may indicate a BWP ID. An R field may be a 1-bit reserve field that does not include indication information. An S field 2500 may indicate the number of pieces of joint TCI state set information included in an MAC-CE. If, for example, a value of the S field 2500 is 1, the MAC-CE may indicate one or two joint TCI states and may have a length of only up to a third octet. In this case, if a value of a C0 field 2515 is 0, a third octet may not exist, and one joint TCI state may be indicated via a TCI state ID0,0 field 2520, and if the value of the C0 field 2515 is 1, the third octet may exist, and two joint TCI states may be indicated via the TCI state ID0,0 field 2520 and a TCI state ID1,0 field 2525, respectively.

If, for example, the value of the S field 2500 is 0, the MAC-CE may activate one or two joint TCI states corresponding to each codepoint of the TCI state field of DCI format 1_1 or 1_2, or may activate one joint TCI state corresponding to each codepoint of two TCI state fields of DCI format 1_1 or 1_2, and joint TCI states for up to 8 codepoints may be activated. If one or two joint TCI states are activated for one codepoint of one TCI state field, a TCI state ID0,Y field and a TCI state ID1,Y field may refer to first and second joint TCI states among two joint TCI states activated at a Y-th codepoint of the TCI state field, respectively. If one joint TCI state is activated for one codepoint of two TCI state fields, the TCI state ID0,Y field and the TCI state ID1,Y field may refer to respective joint TCI states activated at the Y-th codepoint of the first and second TCI state fields.

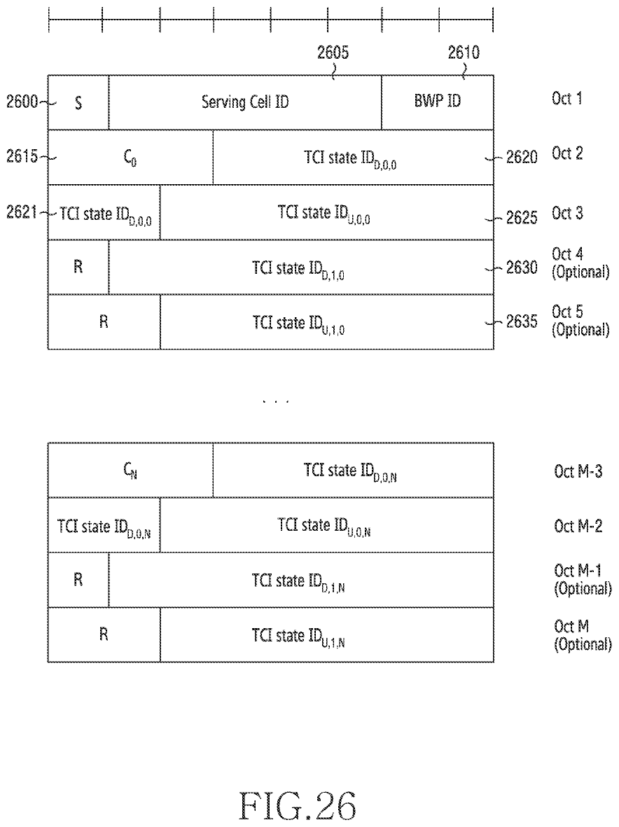

FIG. 26 is a diagram illustrating a MAC-CE structure for activation and indication of multiple separate TCI states in the wireless communication system, according to an embodiment.

In FIG. 26, a serving cell ID field 2605 may indicate a serving cell ID, and a BWP ID field 2610 may indicate a BWP ID. An R field may be a 1-bit reserve field that does not include indication information. An S field 2600 may indicate the number of pieces of separate TCI state set information included in an MAC-CE. If a value of the S field 2600 is 1, the MAC-CE may indicate one separate TCI state set and may include only up to a fifth octet. If the value of the S field 2600 is 0, the MAC-CE may include information on multiple separate TCI state sets, the MAC-CE may activate one separate TCI state set corresponding to each codepoint of a TCI state field of DCI format 1_1 or 1_2 or may activate one separate TCI state set corresponding to each codepoint of two TCI state fields of DCI format 1_1 or 1_2, and may activate, as described above, separate TCI states for up to 8 or 16 codepoints via higher-layer signaling.

In the MAC-CE structure of FIG. 26, from a second octet, every 4 octets may correspond to one separate TCI state set. For example, a C0 field 2615 may have a total of 8 values from “000” to “111”, and as described above, the values may correspond to 8 number of cases that one separate TCI state set may have, respectively.

The C0 field having a value of “000” indicates that one separate TCI state set includes one UL TCI state, TCI state IDD,0,0 fields 2620 and 2621 may be ignored, and a TCI state IDU,0,0 field 2625 may include one piece of UL TCI state information. In addition, fourth and fifth octets may be ignored.

The C0 field having a value of “001” indicates that one separate TCI state set includes two UL TCI states, the TCI state IDD,0,0 fields 2620 and 2621 may be ignored, and the TCI state IDU,0,0 field 2625 may include first UL TCI state information among the two UL TCI states. In addition, the fourth octet may be ignored, and a TCI state IDU,1,0 field 2635 may include second UL TCI state information among the two UL TCI states.

The C0 field having a value of “010” indicates that one separate TCI state set includes one DL TCI state, the TCI state IDD,0,0 fields 2620 and 2621 may include one piece of DL TCI state information, and the TCI state IDU,0,0 fields 2625 and the fourth and fifth octets may be ignored.

The C0 field having a value of “011” indicates that one separate TCI state set includes one DL TCI state and one UL TCI state, the TCI state IDD,0,0 fields 2620 and 2621 may have one piece of DL TCI state information, and the TCI state IDU,0,0 field 2625 may include one piece of UL TCI state information. The fourth and fifth octets may be ignored.

The C0 field having a value of “100” indicates that one separate TCI state set includes one DL TCI state and two UL TCI states, the TCI state IDD,0,0 fields 2620 and 2621 may include one piece of DL TCI state information, and the TCI state IDU,0,0 field 2625 may include first UL TCI state information among the two UL TCI states. In addition, the fourth octet may be ignored, and a TCI state IDU,1,0 field 2635 may include second UL TCI state information among the two UL TCI states.

The C0 field having a value of “101” indicates that one separate TCI state set includes two DL TCI states, the TCI state IDD,0,0 fields 2620 and 2621 may include first DL TCI state information among the two DL TCI states, and the TCI state IDU,0,0 field 2625 and the fifth octet may be ignored. The TCI state IDD,1,0 field 2630 may include second DL TCI state information among the two DL TCI states.

The C0 field having a value of “110” indicates that one separate TCI state set includes two DL TCI states and one UL TCI state, the TCI state IDD,0,0 fields 2620 and 2621 may include first DL TCI state information among the two DL TCI states, the TCI state IDU,0,0 field 2625 may include one piece of UL TCI state information, the TCI state IDD,1,0 field 2630 may include second DL TCI state information among the two DL TCI states, and the fifth octet may be ignored.

The C0 field having a value of “111” indicates that one separate TCI state set includes two DL TCI states and two UL TCI states, the TCI state IDD,0,0 fields 2620 and 2621 may include first DL TCI state information among the two DL TCI states, the TCI state IDU,0,0 field 2625 may include first UL TCI state information among the two UL TCI states, the TCI state IDD,1,0 field 2630 may include second DL TCI state information among the two DL TCI states, and the TCI state IDU,1,0 field 2635 may include second UL TCI state information among the two UL TCI states.

FIG. 26 may illustrate an example of an MAC-CE used when a UL TCI state among separate TCI states uses a higher-layer signaling structure different from that of a DL TCI state and of a joint TCI state among the separate TCI states, as described above. Accordingly, since a UL TCI state requires 6 bits enabling expression of up to 64 UL TCI states, the TCI state IDU,0,0 to TCI state IDU,1,N fields expressing the UL TCI state may be expressed with 6 bits, whereas the TCI state IDD,0,0 to TCI state IDD,1,N fields expressing a DL TCI state may be expressed with 7 bits.

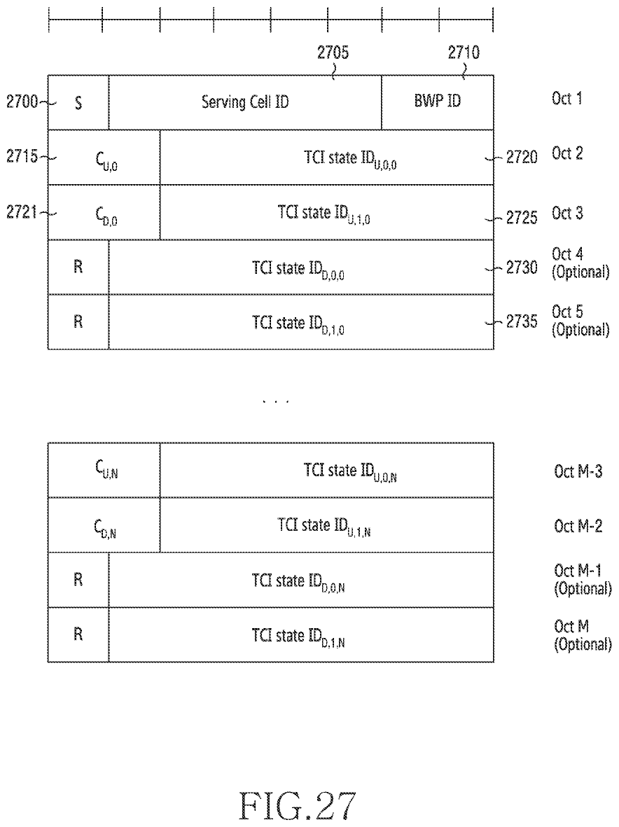

FIG. 27 is a diagram illustrating another MAC-CE structure for activation and indication of multiple separate TCI states in the wireless communication system, according to an embodiment.

In FIG. 27, a serving cell ID field 2705 may indicate a serving cell identifier (ID), and a BWP ID field 2710 may indicate a BWP ID. An R field may be a 1-bit reserve field that does not include indication information. An S field 2700 may indicate the number of pieces of separate TCI state set information included in an MAC-CE. If, for example, a value of the S field 2700 is 1, the MAC-CE may indicate one separate TCI state set and may have a length of only up to a fifth octet.

If, for example, the value of the S field 2700 is 0, the MAC-CE may include information on multiple separate TCI state sets, the MAC-CE may activate one separate TCI state set corresponding to each codepoint of a TCI state field of DCI format 1_1 or 1_2 or may activate one separate TCI state set corresponding to each codepoint of two TCI state fields of DCI format 1_1 or 1_2, and may activate, as described above, separate TCI state sets corresponding up to 8 or 16 codepoints via higher-layer signaling.

In the MAC-CE structure of FIG. 27, from a second octet, every 4 octets may correspond to one separate TCI state set. A CU,0 field 2715 and a CD,0 field 2721 may refer to the number of UL TCI states and DL TCI states included in one separate TCI state set, respectively, and may have meanings for each codepoint as follows.

The CU,0 field having a value of “00” indicates including no UL TCI state, and thus, a TCI state IDU,0,0 2720 and a TCI state IDU,1,0 2725 may be ignored.

The CU,0 field having a value of “01” indicates including one UL TCI state, and thus the TCI state IDU,0,0 2720 may include one piece of UL TCI state information and the TCI state IDU,1,0 2725 may be ignored.

The CU,0 field having a value of “10” indicates including two UL TCI states, and thus, the TCI state IDU,0,0 2720 may include first UL TCI state information among the two UL TCI states, and the TCI state IDU,1,0 2725 may include second UL TCI state information among the two UL TCI states.

The CU,0 field having a value of “00” indicates including no DL TCI state, and thus, fourth and fifth octets may be ignored.

The CU,0 field having a value of “01” indicates including one DL TCI state, and thus, the TCI state IDU,0,0 2730 may include one piece of DL TCI state information, and the fifth octet may be ignored.

The CU,0 field having a value of “10” indicates including two DL TCI states, and thus, the TCI state IDU,0,0 2730 may include first DL TCI state information among the two DL TCI states, and a TCI state IDU,1,0 field 2735 may include second DL TCI state information among the two DL TCI states.

FIG. 27 may illustrate an example of the MAC-CE used when a UL TCI state among separate TCI states uses a higher-layer signaling structure different from that of a DL TCI state and of a joint TCI state among the separate TCI states, as described above, and therefore since the UL TCI state requires 6 bits enabling expression of up to 64 UL TCI states, the TCI state IDU,0,0 to TCI state IDU,1,N fields expressing the UL TCI state may be expressed with 6 bits, whereas the TCI state IDD,0,0 to TCI state IDU,1,N fields expressing the DL TCI state may be expressed with 7 bits.

In the aforementioned examples of the MAC CE in FIG. 25 to FIG. 27, one or more elements may be coupled to each other.

### Third Embodiment: Method of Transmitting Uplink Control Information Included in Uplink Channels Having the Same Priority when Supporting Simultaneous Uplink Transmission Using Multiple Panels

According to an embodiment, a method is provided for, when multiple uplink channels are simultaneously transmitted using multiple panels, multiplexing UCI on the simultaneously transmitted uplink channels. It may be assumed that the UCI to be multiplexed is information included (or multiplexed) in a PUSCH or a PUCCH having the same priority.

Up to NR release 17, a method of transmitting multiple uplink channels (e.g., a PUSCH, a PUCCH, or an SRS may be included in the uplink channels) in the same time resource with respect to one serving cell was not supported. In order to support such an operation, multiple panels capable of transmitting different uplink channels may be required. Here, a panel may be interpreted in various ways. For example, a panel may be defined to be a set of one or more transmission and reception units or transceiver units (TXRUs) capable of receiving or transmitting a signal by using one downlink reception beam or one uplink transmission beam and antenna elements associated with the TXRUs. Alternatively, multiple antenna elements may be configured as one panel regardless of the number of supportable reception beams or transmission beams. Alternatively, a certain number of TXRUs may be configured as one panel according to capability of a terminal or a base station, and one or more antenna elements may be connected for one TXRU. In addition, various panel implementation schemes may be considered. As in an example of a first panel configuration, a panel is assumed to be a set of a TXRU capable of receiving or transmitting a signal by using one downlink reception beam or one uplink transmission beam and antenna elements associated therewith.

In NR release 18 phase, in order to support simultaneous transmission in time resources, a transmission scheme using multiple panels is discussed, and specific schemes, operations, etc. may be introduced into the standards. In NR release 17, improvements have been made for integrated beam management for a downlink and an uplink. As a separate scheme improvement, NR release 17 has introduced PUCCH and PUSCH transmission methods in consideration of multiple TRPs (hereinafter, referred to as multi-TRP (mTRP)). In this case, a PUCCH or a PUSCH may be repeatedly transmitted to mTRP by using a multiplexing scheme divided in the time domain (e.g., TDM). Since a PUCCH or a PUSCH transmitted to each TRP is transmitted in different time domains, a terminal supports time-division repeated transmission rather than simultaneous transmission. However, in NR release 18, simultaneous uplink transmission (UL simultaneous transmission with multi-panel (UL STxMP), hereinafter, STxMP) using multiple panels may be supported, wherein the STxMP is to transmit different uplink beams (or the same uplink beam) to different TRPs (or the same TRP) on corresponding uplink channels in the same time domain by using two or more panels in consideration of FDM, SDM, a single frequency network (SFN) (e.g., single frequency broadcast network), or the like, rather than a TDM scheme.

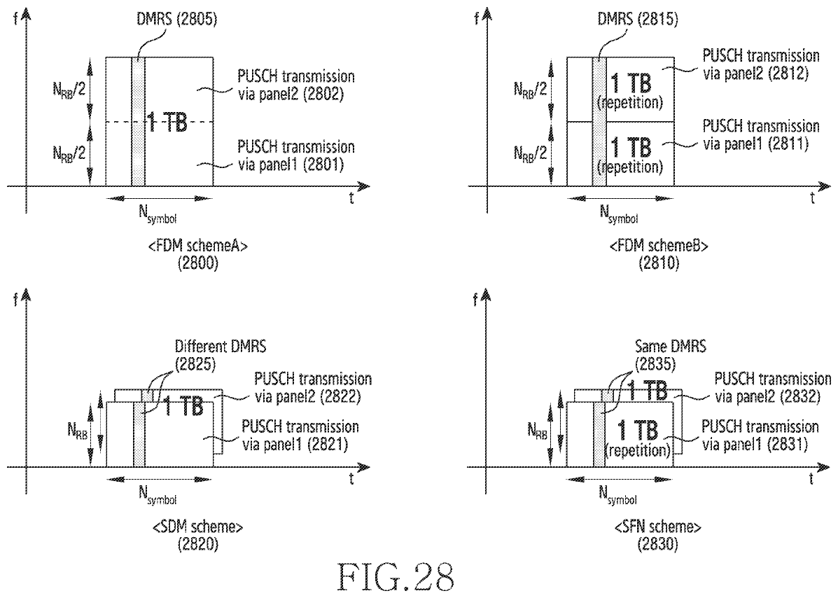

FIG. 28 is a diagram illustrating resource allocation and a transmission panel for uplink transmission in FDM, SDM, and an SFN scheme for supporting STxMP. A PUSCH is described as an example herein, but contents disclosed hereinafter may be similarly applied to a PUCCH, an SRS, or other uplink channels.

FDM scheme A 2800 is for configuring all resources of one scheduled PUSCH to be one TB, and encoding information bits based thereon. Thereafter, according to the FDM scheme, resources may be divided in half in the frequency domain so as to be simultaneously transmitted at the same time by using each panel. For example, a terminal may transmit 2801 a first part (a part including an RB of a low index) of all the PUSCH resources via a first panel, and may transmit 2802 a second part (a part other than the first part) of all the PUSCH resources via a second panel. Respective parts may be mapped to panels so as to be transmitted in a sequence different from that in the example (e.g., the first part of all the PUSCH resources may be transmitted via the second panel, and the second part of all the PUSCH resources may be transmitted via the first panel). In this case, if one TB is divided in half and transmitted via respective panels, and the transmission is performed to different TRPs by using the respective panels, a part of one TB is received in one TRP. Thereafter, according to an implementation of a base station, the base station may collect the parts into one and perform joint decoding or separate decoding, thereby receiving a signal transmitted by the terminal. DMRSs may be transmitted 2805 over all the PUSCH resources in FDM scheme A 2800. Alternatively, the DMRSs may be transmitted on respective PUSCH parts transmitted to different TRPs, wherein, for the DMRSs transmitted to different TRPs, different DMRS ports may be configured or different DMRS sequences may be used.

FDM scheme B 2810 is a scheme of first dividing one scheduled PUSCH resource in half in the frequency domain according to the FDM scheme, configuring, to be one TB, each of the divided PUSCH resources to be transmitted using each panel, and then encoding information bits. Thereafter, the terminal transmits the same TB via each panel. In this case, the TB transmitted via each panel may have the same redundancy version (RV) sequence or may have a different RV sequence. Since a result is obtained by rate matching according to each RV sequence in one buffer of encoded bits encoded via one TB, the FDM scheme 2810 may be referred to as repeated transmission. For example, the terminal may transmit 2811 the first repeatedly transmitted part via the first panel, and transmit 2812 the second repeatedly transmitted part via the second panel. In this case, if repeatedly transmitted TBs are transmitted via respective panels and the transmission is performed to different TRPs by using the respective panels, the repeatedly transmitted TBs are received into one TRP. Thereafter, the base station may, according to implementation of the base station, collect the parts into one and perform joint decoding or separate decoding, thereby receiving a signal transmitted by the terminal. DMRSs may be transmitted 2815 over all the PUSCH resources in FDM schemeB. Alternatively, the DMRSs may be transmitted on respective PUSCH parts transmitted to different TRPs, wherein, for the DMRSs transmitted to different TRPs, different DMRS ports may be configured or different DMRS sequences may be used.

SDM scheme 2820 is a scheme of configuring, to be one TB, all resources of one scheduled PUSCH in consideration of the number of the all layers, and encoding information bits based thereon. Thereafter, according to the SDM scheme, the terminal may divide the resources in half in the spatial domain so as to simultaneously transmit the resources at the same time point by using respective panels. That is, the terminal transmits different layers by dividing the layers into respective panels. For example, the terminal may transmit a first part 2821 (a part including a layer of a low index) via a first panel, and may transmit a second part 2822 (a part other than the first part) via a second panel. This is merely an example, and respective parts may be mapped to panels so as to be transmitted in a sequence different from that in the example (e.g., the first part may be transmitted via the second panel, and the second part may be transmitted via the first panel). For DMRSs 2825 of the PUSCH transmitted via respective panels, different DMRS ports may be configured, and the different DMRS ports may be included in different CDM groups. Alternatively, the DMRSs may be included in the same CDM group with different DMRS ports. In this case, if one TB is divided in half and transmitted via respective panels, and the transmission is performed to different TRPs by using the respective panels, a part of one TB is received in one TRP. Thereafter, the base station may, according to implementation of the base station, collect the parts into one and perform joint decoding or separate decoding, thereby receiving a signal transmitted by the terminal.

The SFM scheme 2830 is a scheme of performing transmission by configuring the same DMRS and exactly the same TB in the same frequency resource and the same time resource. PUSCHs transmitted via respective panels may include the same data and the same DMRS. That is, the terminal may transmit 2831 the first part via the first panel, and transmit 2832 the second part via the second panel. This is merely an example, and respective parts may be mapped to panels so as to be transmitted in a sequence different from that in the example (for example, the first part may be transmitted via the second panel, and the second part may be transmitted via the first panel). In this case, if the same TB is transmitted via respective panels and transmitted to different TRPs by using the respective panels, the same TB is received into one TRP. Thereafter, the base station may, according to implementation of the base station, collect the parts into one and perform joint decoding or separate decoding, thereby receiving a signal transmitted by the terminal. In the SFN scheme 2830, DMRSs transmitted to respective panels may be configured with the same DMRS port 2835.

In addition to the transmission method described above in FIG. 28, repeated transmission of transmitting the same TB based on the SDM scheme may be supported. That is, any scheme capable of simultaneous transmission in the time domain by using different panels may follow the UCI multiplexing method according to the embodiment.

In consideration of various transmission schemes for supporting STxMP as described above, transmission channel configuration methods in two directions may be considered. In a first transmission channel configuration method, the terminal may repeatedly transmit the same information by using respective panels. In a second transmission channel configuration method, the terminal may transmit different information by using different panels via spatial multiplexing (SM). According to the second transmission channel configuration method, the terminal may configure the same transport block (TB) and perform resource mapping to different frequency domains or different layers so as to transmit the same, and the terminal may configure different TBs according to respective panels and map the TBs to different frequency domains or different layers so as to transmit the same. Up to NR Release 17, transmission using only one TB (or may be expressed as a codeword (CW)) has been supported for uplink support, so that, in order to support a TB greater than the one TB, a higher-layer configuration therefor and a new DCI field configuration within DCI may be required.

The terminal may perform UCI multiplexing by considering whether UCI included in the PUCCH or PUSCH has the same priority index (indicator) or different priority indexes. UCI having the same priority index may be assumed, and a method of multiplexing the UCI accordingly by the terminal may be as follows.

Example 1) If the terminal:
needs to multiplex UCI on PUCCH transmission overlapping PUSCH transmission, and
as described above with respect to UCI rate matching multiplexed to the PUSCH, if the PUSCH and PUCCH satisfy the condition (timeline condition specified in clause 9.2.5 of 3GPP standard TS 38.213) for multiplexing UCI,

The terminal:
if the terminal multiplexes an aperiodic or semi-persistent CSI report on the PUSCH, multiplexes only HARQ-ACK information from the UCI on the PUSCH transmission and does not transmit the PUCCH.
if the terminal does not multiplex the aperiodic or semi-persistent CSI report on the PUSCH, multiplexes the HARQ-ACK and CSI report (if any) of the UCI on the PUSCH transmission and does not transmit the PUCCH.

Example 2) If the terminal multiplexes the aperiodic CSI on the PUSCH and multiplexes the UCI including the HARQ-ACK information on the PUCCH overlapping with the PUSCH, and the timeline condition specified in clause 9.2.5 of standard TS 38.213 is satisfied, the terminal multiplexes the HARQ-ACK information on the PUSCH and does not transmit the PUCCH.

In addition to the aforementioned operation of multiplexing the UCI by the terminal, the terminal may multiplex the UCI and transmit only some uplink channels according to specific operations described in clause 9 of 3GPP standard TS 38.213.

In NR Release 17, if the terminal multiplexes the UCI on the PUSCH in a situation where the timeline condition and the condition for UCI multiplexing are satisfied as described above, the terminal may multiplex the UCI on the PUSCH in the following sequence:
The terminal may identify resources of the PUSCH on which the UCI is multiplexed. In this case, for a PUSCH transmitted based on a DCI format received by the terminal, the amount of PUSCH resources (or TB size) may be identified based on scheduling information (e.g., a time domain resource allocation area, a frequency domain resource allocation area, an MCS area, an SRI area, a TPMI area, an antenna port area for indicating a DMRS port, etc.) included in DCI. If the PUSCH corresponds to PUSCH transmission according to a configured grant-based configuration, the amount of PUSCH resources (or TB size) may be identified by referring to the higher-layer configuration, a DCI format for activation of the transmission or a DCI format including scheduling information other than the higher-layer configuration, and the like.
The terminal calculates the number of coded modulation symbols per layer according to a UCI type, as described above for rate matching of the UCI multiplexed on the PUSCH. In this case, the terminal calculates the number of coded modulation symbols per layer, based on information, such as the resource amount (or TB size) of the scheduled PUSCH, the number of bits of UCI information, such as HARQ-ACK information and CSI information, a beta offset value for the UCI type, and a code rate for a code block.
The terminal performs channel encoding in consideration of the number of coded bits for encoded UCI.
The terminal multiplexes, on the PUSCH, the coded bits for the UCI. In this case, according to each piece of information of the UCI, the terminal maps and multiplexes the coded bits for the UCI on the PUSCH resources according to the following sequence.
   The terminal multiplexes HARQ-ACK information first. In this case, if frequency hopping is not performed on the PUSCH, the HARQ-ACK information is multiplexed on the PUSCH while increasing each index in a sequence of layer-frequency-symbol, with respect to all layers of the scheduled PUSCH from an OFDM symbol having a first OFDM symbol index l⁽¹⁾ after a first set (i.e., an OFDM symbol including a first DMRS in the time domain of the PUSCH) of OFDM symbols including DMRSs and from a subcarrier having a lowest index among subcarriers of the scheduled PUSCH. That is, the terminal sequentially maps the HARQ-ACK information over all layers for the corresponding subcarrier and symbol, and then sequentially maps the HARQ-ACK information for a subsequent subcarrier index over all layers. When the HARQ-ACK information has been mapped over all layers and subcarriers in the corresponding symbol, the same multiplexing procedure is performed for the subsequent OFDM symbol index. If there is CG-UCI after the terminal first multiplexes all the HARQ-ACK information on the PUSCH, the CG-UCI may be multiplexed on the PUSCH in the same way as the method of multiplexing the HARQ-ACK information. If there is CSI information after multiplexing both the HARQ-ACK information and the CG-UCI information, the CSI information is multiplexed on the PUSCH in a similar manner. Here, the CSI information includes both CSI part1 and CSI part2, and the terminal multiplexes CSI part1 on the PUSCH first and then multiplexes CSI part2 on the PUSCH. The terminal multiplexes the CSI information on the PUSCH in a similar manner. However, unlike l⁽¹⁾, an OFDM symbol index l_{CSI}⁽¹⁾, which is a reference for first mapping the CSI information, is defined to be an index of the first OFDM symbol that does not include a DMRS. The terminal identifies whether the CSI information can be multiplexed from a symbol having the OFDM symbol index of l_{CSI}⁽¹⁾, and maps the CSI information while increasing the index in a sequence of layer-frequency-symbol similarly to the mapping of the HARQ-ACK information described above.
   Even when frequency hopping is performed on the PUSCH, the UCI is multiplexed on the PUSCH similarly to the case where frequency hopping is not performed on the PUSCH as described above, but with respect to each frequency hopping, the HARQ-ACK, CG-UCI, or CSI information is divided into two parts for each frequency hop, and each part is multiplexed on the PUSCH transmitted on each frequency hop. In this case, an index serving as a reference for an OFDM symbol on which the HARQ-ACK information and the CSI information are mapped is defined for each frequency hop. l⁽¹⁾ may be defined as an index of the first OFDM symbol after the first set of OFDM symbols including a DMRS on a first frequency hop, and l⁽²⁾ may be defined as an index of the first OFDM symbol after the first set of OFDM symbols including a DMRS in a second frequency hop. l_{CSI}⁽¹⁾ may be defined as an index of the first OFDM symbol including no DMRS in the first frequency hop, and l_{CSI}⁽²⁾ may be defined as an index of the first OFDM symbol including no DMRS in the second frequency hop. The terminal multiplexes, on the PUSCH, each piece of the UCI information divided for each hop by referring to l⁽¹⁾, l⁽²⁾, l_{CSI}⁽¹⁾, or l_{CSI}⁽²⁾ with respect to each frequency hop.

As described above, up to NR Release 17, the terminal multiplexes the UCI in consideration of all resources of the scheduled PUSCH. This may indicate that the UCI is multiplexed for all TBs for PUSCH transmission. If the UCI is multiplexed in this way, since simultaneous transmission using multiple panels is not considered, the multiplexed UCI may be transmitted to different TRPs via different panels. For example, if one TB is divided in the frequency domain and transmitted via respective panels as in FDM scheme A 2800, the multiplexed UCI may be transmitted to different TRPs over different frequency domains. In order to decode the UCI, the base station may need to perform joint decoding by combining, into one, the received UCI which has been divided into respective TRPs, so as to successfully receive the UCI information. For another example, as in the SDM scheme 2820, if one TB is divided in the spatial domain and the divided layers are transmitted via respective panels, the multiplexed UCI may be transmitted to different TRPs over different layers. Similarly, in order to decode the UCI, the base station may need to perform joint decoding by combining, into one, the received UCI which has been divided into respective TRPs, so as to successfully receive the UCI information.

However, blockage may occur in a specific direction between the base station and the terminal, and a channel state in the corresponding direction may not be good. As a result, if a signal transmitted via a specific panel is not successfully received by a corresponding TRP or the base station due to the blockage, the base station may ultimately fail to receive the entire UCI. Since UCI information, which may include HARQ-ACK or a CSI report, has a relatively higher importance than data, more reliable transmission may be required. Therefore, even if blockage occurs with a small probability, a transmission method capable of ensuring high reliability may be required to transmit UCI information, so as to prevent a problem of a decoding failure due to the blockage. As a UCI multiplexing method capable of ensuring high reliability, the following methods may be considered.

[Method 1] By introducing a new type of beta offset value, UCI may be transmitted so that highly reliable encoding is possible at a lower code rate. Up to NR Release 17, configuration of a different beta offset value has been possible according to each UCI type (e.g., HARQ-ACK, CSI part1, or CSI part2). By extending this, when the PUSCH including the UCI is transmitted via multiple panels, the UCI may be encoded according to an extended beta offset configuration value.

In this case, the base station and the terminal may operate as in the following example. First, the terminal may report, to the base station, UE capability for multi-panel transmission. In this case, the terminal may report supportable multi-panel-based STxMP transmission methods and detailed information necessary therefor. The terminal may additionally report capability to use a new beta offset in consideration of STxMP. For example, the terminal may report the capability to use a new beta offset to the base station by configuring the UE capability of “betaoffsetforSTxMP” to be “enable”. Alternatively, the terminal may perform UE reporting to the base station by configuring a corresponding function to be enabled, via a UE capability area with a different name for a similar or identical function. Alternatively, the capability to use a new beta offset may be implicitly included as a part of the UE capability report indicating that STxMP transmission is possible. The base station may determine whether to support STxMP, based on the UE capability received from the terminal, and if STxMP is supported for the terminal, the base station may configure a related higher-layer parameters for the terminal. As an example of a new higher-layer parameter, a configuration, such as new “BetaOffsets2” or “BetaOffsetsforSTxMP”, may be considered. Table 43 describes “BetaOffsets2”, which is an example of the new higher-layer parameter.

TABLE 43
BetaOffsets2 ::= SEQUENCE
betaOffsetACK-Index1 INTEGER(0..xx) OPTIONAL, -- Need S
betaOffsetACK-Index2 INTEGER(0..xx) OPTIONAL, -- Need S
betaOffsetACK-Index3 INTEGER(0..xx) OPTIONAL, -- Need S
betaOffsetCSI-Part1-Index1 INTEGER(0..xx) OPTIONAL, -- Need S
betaOffsetCSI-Part1-Index2 INTEGER(0..xx) OPTIONAL, -- Need S
betaOffsetCSI-Part2-Index1 INTEGER(0..xx) OPTIONAL, -- Need S
betaOffsetCSI-Part2-Index2 INTEGER(0..xx) OPTIONAL -- Need S
}

Similar to higher-layer parameter “BetaOffsets” up to NR Release 17, depending on the number of bits of each HARQ-ACK, CSI part1, or CSI part2, different index values, for example, “betaOffsetACK-Index1”, “betaOffsetACK-Index2”, or “betaOffsetACK-Index3”, may be configured. Here, a candidate value may be expressed by 0 to xx, and a value of xx may be 31 as in NR Release 17. Alternatively, the value of xx may be any value of the exponent of 2-1, and 16−1=15, for example, may be configured to be xx. As the new beta offset is introduced, a new table for determination of a beta value via an index configured in the higher-layer parameter may be defined. Up to NR Release 17, the terminal determines a beta value for multiplexing HARQ-ACK, by mapping an index value configured in “BetaOffsets” to Table 9.3-1 (Table 44 below) in 3GPP standard TS 38.213. As an example, if the configured index value offbetaOffsetACK-Index2 is 6 for a case where the number of bits of HARQ-ACK information is greater than 2 and less than or equal to 11, the beta value is determined to be 6.250 that is a value corresponding to the index of 6 in Table 44] below, and the terminal may use the beta value for rate matching of corresponding HARQ-ACK, as described above. The contents described in Table 44 below are merely an example, and beta offset values may be determined according to other references and values.

TABLE 44

| I_{offset, 0}^{HARQ-ACK} or I_{offset, 1}^{HARQ-ACK} or | |
|---|---|
| I_{offset, 2}^{HARQ-ACK} or I_{offset}^{CG-UCI} or | β_{offset}^{HARQ-ACK} or |
| I_{offset, 0}^{HARQ-ACK, 0} or I_{offset, 1}^{HARQ-ACK, 0} or | β_{offset}^{CG-UCI} or |
| I_{offset, 2}^{HARQ-ACK, 0} or I_{offset, 0}^{HARQ-ACK, 1} or | β_{offset}^{HARQ-ACK, 0} or |
| I_{offset, 1}^{HARQ-ACK, 1} or I_{offset, 2}^{HARQ-ACK, 1} | β_{offset}^{HARQ-ACK, 1} |
| 0 | 1.000 |
| 1 | 2.000 |
| 2 | 2.500 |
| 3 | 3.125 |
| 4 | 4.000 |
| 5 | 5.000 |
| 6 | 6.250 |
| 7 | 8.000 |
| 8 | 10.000 |
| 9 | 12.625 |
| 10 | 15.875 |
| 11 | 20.000 |
| 12 | 31.000 |
| 13 | 50.000 |
| 14 | 80.000 |
| 15 | 126.000 |
| 16 | 0.6 |
| 17 | 0.4 |
| 18 | 0.2 |
| 19 | 0.1 |
| 20 | 0.05 |
| 21 | Reserved |
| 22 | Reserved |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

If the terminal transmits the PUSCH including HARQ-ACK via STxMIP, the terminal may determine a beta value for HARQ-ACK for STxMIP transmission by referring to new higher-layer parameter “betaOffsets2” (or may be any higher-layer parameter having the same function) and Table 45 below, instead of determining the beta value for the HARQ-ACK by referring to higher-layer parameter “betaOffsets” and Table 44, and may use the determined beta value for UCI multiplexing. Similar to the example described above, if the configured index value of betaOffsetACK-Index2 in “betaOffsets2” is 6 for the case where the number of bits of the HARQ-ACK information is greater than 2 and less than or equal to 11, the terminal determines “Value 7 for STxMIP” as a beta value by referring to Table 45 below. The terminal may then calculate the number of coded modulation symbols per layer and perform multiplexing in the same manner. Even for CSI part1 and CSI part2, the terminal may determine a beta value by referring to Table 45 and anew higher-layer parameter for each UCI. The contents described in Table 45 are merely an example, and beta offset values may be determined according to other references and values.

TABLE 45

| I_{offset, 0}^{HARQ-ACK} or I_{offset, 1}^{HARQ-ACK} or | |
|---|---|
| I_{offset, 2}^{HARQ-ACK} or I_{offset}^{CG-UCI} or | β_{offset}^{HARQ-ACK} or |
| I_{offset, 0}^{HARQ-ACK, 0} or I_{offset, 1}^{HARQ-ACK, 0} or | β_{offset}^{CG-UCI} or |
| I_{offset, 2}^{HARQ-ACK, 0} or I_{offset, 0}^{HARQ-ACK, 1} or | β_{offset}^{HARQ-ACK, 0} or |
| I_{offset, 1}^{HARQ-ACK, 1} or I_{offset, 2}^{HARQ-ACK, 1} | β_{offset}^{HARQ-ACK, 1} |
| 0 | Value 1 for STxMP |
| 1 | Value 2 for STxMP |
| 2 | Value 3 for STxMP |
| 3 | Value 4 for STxMP |
| 4 | Value 5 for STxMP |
| 5 | Value 6 for STxMP |
| 6 | Value 7 for STxMP |
| 7 | Value 8 for STxMP |
| 8 | Value 9 for STxMP |
| 9 | Value 10 for STxMP |
| 10 | Value 11 for STxMP |
| 11 | Value 12 for STxMP |
| 12 | Value 13 for STxMP |
| 13 | Value 14 for STxMP |
| . . . | . . . |
| xx (the exponent of 2 - 1) | Value xx + 1 for STxMP |

The method described above is merely an example, and a new higher-layer parameter may be introduced and a beta value may be determined by referring to Table 44 as in NR Release 17. Alternatively, as in NR Release 17, higher-layer parameter “betaOffsets” may be configured, and a beta value may be determined by referring to Table 45. Alternatively, based on any combination using the above configuration and Table 45, the terminal may determine a beta value for corresponding UCI. Table 45 and the higher-layer parameter newly defined according to the method 1 may be applied for the terminal to determine the beta value only when the PUSCH on which the UCI is multiplexed is transmitted via STxMP using multiple panels, and if the PUSCH is not transmitted via PUSCH STxMP, the beta value may be determined in the same manner as the terminal operation up to NR Release 17. Alternatively, the terminal may determine the beta value, based on Table 45 and the newly defined higher-layer parameter for all cases, instead of following the terminal operation up to NR Release 17.

[Method 2] The terminal may identify resources of a PUSCH on which UCI is multiplexed, and repeatedly transmit the UCI in both of two panel transmissions according to conditions. Before multiplexing the UCI on the PUSCH, the terminal identifies the amount of PUSCH resources (or TBs) simultaneously transmitted via respective panels. In this case, the amount of PUSCH resources (or TBs) simultaneously transmitted via respective panels may be determined according to a MCS (e.g., may refer to a modulation order and a target code rate), the number of layers, the number of allocated PRBs, the number of allocated OFDM symbols, DMRS overhead, and the like. If the amount of PUSCH resources (or TBs) transmitted via respective panels is the same, the terminal may repeatedly multiplex the same UCI on each PUSCH. In this case, the terminal may perform multiplexing so that repeatedly multiplexed UCI coded bits may be mapped to the same position of the PUSCH.

In this way, by mapping the same UCI coded bits to the same location of the PUSCH, the terminal may multiplex the UCI so that the UCI received by each TRP (or base station) may be combine and decoded. This is because the UCI is channel-coded differently from data mapped to the PUSCH. While data is encoded/decoded based on a low density parity check (LDPC) code, UCI information may be encoded/decoded using a repetition code, a Reed-Muller code, a polar code, or the like according to the number of UCI bits. In particular, for coded bits of the UCI encoded based on the polar code, the same coded bit length and the same multiplex position need to be ensured to enable performance gain and decoding using combining. If the UCI bits are repeatedly transmitted in this way, although an uplink signal including UCI transmitted via one panel is not received by the base station due to blockage, an uplink signal including UCI transmitted via another panel may be successfully received by the base station. Thereafter, the base station may understand UCI information by decoding the uplink signal successfully received from one panel. That is, even if the base station fails to receive data included in the PUSCH, since each UCI is repeatedly transmitted, even if only the PUSCH transmitted from one panel is successfully received, the UCI may be successfully decoded and UCI information may be identified. When UCI is multiplexed on a PUSCH according to the method 2, the base station and the terminal may perform the following operations. The terminal may report, to the base station, UE capability for multi-panel transmission. In this case, the terminal may report supportable multi-panel-based STxMP transmission methods and detailed information necessary therefor.

In addition, whether it is possible, as in the method 2, to repeatedly multiplex UCI in two panel transmissions according to the amount of PUSCH resources (or TBs) transmitted via each of panels may be notified as a UE report to the base station. As such, the UE report for reporting whether the method 2 is supported may be explicitly reported via a new UE report parameter. Alternatively, when the terminal reports, to the base station, UE capability indicating that STxMP transmission is supported, the base station and the terminal may define a rule in advance that the capability for the method 2 should also be necessarily supported. In this case, whether the terminal supports the capability for the method 2 is reported via the UE capability report for STxMP transmission support, and therefore it may be defined that whether the capability for the method 2 is supported is implicitly reported. If the terminal explicitly or implicitly reports, to the base station, that the terminal is able to support the method 2, the base station may first determine, based on the report, whether STxMP is supported, and then additionally determine whether the method 2 is supported. Alternatively, if STxMP is supported, it may be determined that the method 2 is supported without an additional condition.

If the base station supports STxMP and the method 2 for the terminal, the base station may configure a higher-layer parameter for supporting STxMP and a higher-layer parameter for supporting the method 2 for the terminal. The higher-layer parameter for supporting STxMP may report supported STxMP transmission methods and detailed information required therefor in the same manner, as described in the method 1. The higher-layer parameter for supporting the method 2 may be an indicator for indicating whether the terminal is to repeatedly multiplex UCI on two PUSCHs using two panels according to the method 2. For example, new higher-layer parameter “UCIrepetition_forSTxMP” (or may be a higher-layer parameter with a different name for a similar/identical function) may be configured to be “enable” (or any value, such as “1”, for indication of being supported). Although new higher-layer parameter “UCIrepetition_forSTxMP” has been introduced, if the higher-layer parameter is not configured (absent) for the terminal, the terminal may identify that the base station does not support the method 2, and may multiplex the UCI on the PUSCH in the same way as in NR Release 17. Alternatively, if the base station and the terminal define, in advance, a rule that the method 2 is implicitly supported when STxMP is supported, the terminal may identify that the method 2 is supported, by identifying that the higher-layer parameter for supporting of STxMP has been configured for the terminal, even without introducing separate new higher-layer parameter “UCIrepetition_forSTxMP”.

Thereafter, for the UCI and uplink data to be transmitted to the base station, the terminal may transmit a scheduling request (SR) for PUSCH transmission to the base station, and based on the SR, the base station may transmit a DCI format for scheduling of a PUSCH for the terminal. The terminal may identify the scheduled PUSCH by receiving the DCI format, and the scheduled PUSCH may be assumed to be a PUSCH transmitted via STxMP. Alternatively, PUSCH resources may be scheduled based on a higher-layer parameter based on a configured grant, and the scheduled PUSCH may be identified according to the configured higher-layer parameter (for a type 2 configured grant PUSCH, the scheduled PUSCH may be identified only when the DCI format is received along with a higher-layer parameter). In this case, another uplink channel, etc. overlapping with the scheduled PUSCH (hereinafter, simply expressed as a scheduled PUSCH) transmitted via STxMP may also be identified. If there is another uplink channel overlapping with the scheduled PUSCH in the time domain, an uplink channel to be transmitted and UCI to be multiplexed may be determined via the same procedure as in NR Release 17. In this case, it is assumed that the scheduled PUSCH is transmitted by the terminal and the UCI is multiplexed on the PUSCH, and operations of the terminal and the base station according to the method 2 are described in greater detail below. The terminal identifies whether the resource amounts of PUSCHs (or TBs) transmitted via respective panels are the same. If the amounts of PUSCH resources (or TBs) transmitted via respective panels are the same, the terminal calculates the number of coded modulation symbols per layer for UCI and performs rate matching in consideration of the amounts of PUSCH resources (or TBs) for respective panels. In order for the amounts of PUSCH resources (or TBs) transmitted via respective panels to be the same, precedent conditions may be required according to the FDM scheme or the SDM scheme. For example, in FDM-based STxMP, for the same amount of resources, all PUSCH resources need to be scheduled with even-numbered RBs. This is because, when RBs are divided in half, only even-numbered RBs can be allocated as PUSCH resources in which an integer number of RBs are transmitted via respective panels. Similarly, in SDM-based STxMP, in order to allocate the same amount of resources, all PUSCH resources need to be scheduled with even-numbered layers (or ranks).

As described above, if the precedent condition is satisfied according to the STxMP transmission scheme, and the resource amounts of the PUSCHs (or TBs) transmitted via respective panels are the same, a parameter value considered for calculating the number of coded modulation symbols per layer may vary according to the STxMP transmission method of the scheduled PUSCH. For example, if the scheduled PUSCH is transmitted in the FDM-based STxMP scheme, the terminal may consider, in order to calculate the number of coded modulation symbols per layer, the number M_{sc}^{UCI}(l)/2 of subcarriers in the frequency domain for the PUSCH transmitted via one panel according to the FDM scheme, instead of considering the number of subcarriers M_{sc}^{UCI}(l) in the frequency domain scheduled for the PUSCH. For a specific example, as described in Equation (6) above, in the equation for calculating coded modulation symbols per layer for HARQ-ACK that is multiplexed on the PUSCH for a case other than repeated PUSCH transmission type B including a UL-SCH, if modification is made in consideration of the subcarriers of the PUSCH transmitted via one panel when transmission is performed in the FDM-based STxMP scheme, Equation (18) may be obtained.

$${Q}_{ACK}^{′} = min \{ ⌈ \frac{( {O}_{ACK} + {L}_{ACK} ) * {β}_{offset}^{PUSCH} * {\sum }_{l = 0}^{{N}_{symb , all}^{PUSCH} - 1} {M}_{sc}^{UCI} ( l ) / 2}{{\sum }_{r = 0}^{{C}_{UL - SCH} - 1} {K}_{r}} ⌉ , \qquad ( 18 )$$

$$⌈ α * {\sum }_{l = {l}_{0}}^{{N}_{symb , all}^{PUSCH} - 1} {M}_{sc}^{UCI} ( l ) / 2 ⌉ \}$$

Equation (18) is for calculating coded modulation symbols per layer for HARQ-ACK in case of two divided PUSCHs in which, according to the FDM scheme, all scheduled PUSCH resources are divided in half in the frequency domain so as to be transmitted via respective panels. Similarly, even for CG-UCI, CSI part1, or CSI part2, M_{sc}^{UCI}(l)/2 may be considered instead of M_{sc}^{UCI}(l) when calculating coded modulation symbols per layer in consideration that resources are divided in half in the frequency domain according to the FDM scheme.

If the scheduled PUSCH is transmitted in the SDM-based STxMP scheme, the terminal may calculate coded modulation symbols per layer in consideration of M_{sc}^{UCI}(l) as described above. Then, when determining the number E_{UCI} (N_{L}*Q′*Qₘ) of UCI bits, the terminal may calculate the number of UCI bits by using N_{L}/2 instead of N_{L} in consideration of the number of layers divided in half according to the SDM scheme.

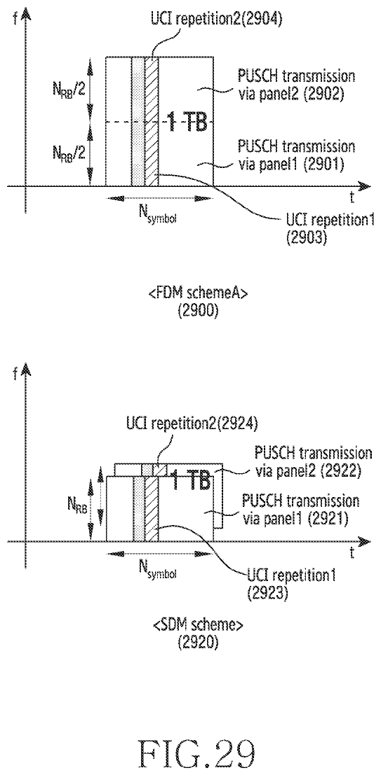

Thereafter, the terminal may encode UCI information according to the calculated number of UCI bits, generate modulation symbols, and repeatedly multiplex the same on two PUSCHs transmitted via respective panels. Since the amounts of resources (or TBs) of two PUSCHs transmitted via respective panels are the same, and modulation symbols for the same UCI are multiplexed, the terminal multiplexes the UCI modulation symbols at the same position in the two PUSCHs. Here, the same position may refer to positions determined to be the same or correspond to each other in a resource area during multiplexing on each PUSCH in consideration of a frequency in FDM and in consideration of a layer in SDM, as in FIG. 29 showing an example of multiplexing UCI in FDM and SDM-based STxMP transmission situations.

Specifically, according to a scheme of FDM scheme A 2900, a terminal may multiplex 2903 UCI while transmitting a first part 2901 (e.g., a part including an RB of a low index) of all PUSCH resources via a first panel. In addition, the terminal may multiplex 2904 UCI while transmitting a second part 2902 (e.g., a part including an RB of a high index) of all PUSCH resources via a second panel. Since the UCI transmitted via different parts of the entire PUSCH is the same UCI modulation symbol, the same UCI may be repeatedly transmitted. Unlike the above embodiment, it is certainly possible that the first part of all PUSCH resources is transmitted via the second panel, and the second part of all PUSCH resources is transmitted via the first panel. In this case, if one TB is divided in half and transmitted via respective panels, and the transmission is performed to different TRPs by using the respective panels, a part of one TB is received in one TRP. Thereafter, the base station may, according to implementation of the base station, collect TBs and UCI into one and perform joint decoding or separate decoding, thereby receiving a signal transmitted by the terminal.

According to an SDM scheme 2920, the terminal may divide resources in half in the spatial domain so as to simultaneously transmit the resources at the same time point via respective panels. Specifically, the terminal may multiplex 2923 the UCI while transmitting a first resource part 2921 (e.g., a part including a layer of a low index) via the first panel. In addition, the terminal may multiplex 2924 the UCI while transmitting a second resource part 2922 (e.g., a part including a layer of a high index, or a part other than the first part) via the second panel. Since the UCI transmitted via different layers of all resources is the same UCI modulation symbol, the same UCI may be repeatedly transmitted. Unlike the above embodiment, it is certainly possible that the first resource part is transmitted via the second panel, and the second resource part is transmitted via the first panel. For DMRSs of the PUSCH transmitted via respective panels, different DMRS ports may be configured, and the different DMRS ports may be included in different CDM groups. Alternatively, the DMRSs may be included in the same CDM group with different DMRS ports. In this case, if one TB is divided in half and transmitted via respective panels, and the transmission is performed to different TRPs by using the respective panels, a part of one TB is received in one TRP. Thereafter, the base station may, according to implementation of the base station, collect TBs and UCI into one and perform joint decoding or separate decoding, thereby receiving a signal transmitted by the terminal.

[Method 3] The method 3 is a method for operations of the terminal and the base station when the resource amounts of PUSCHs (or TBs) transmitted by the terminal via respective panels in the method 2 are different. When the terminal identifies that the resource amounts of the PUSCHs (or TBs) transmitted via respective panels are the same, a method of multiplexing UCI on PUSCHs having the same amount of resources may be defined to be the method 2. On the other hand, the terminal has identified whether the resource amounts of the PUSCHs (or TBs) transmitted via respective panels are the same, but if the resource amounts of respective PUSCHs are not the same, a method of multiplexing UCI on PUSCHs having the same amount of resources may be defined as in the method 3. In the method 3, a higher-layer parameter configuration and a UE capability report between the base station and the terminal may be defined in the same way as in the method 2. Likewise, if a higher-layer parameter (e.g., “UCIrepetition_forSTxMP”) is configured or STxMP is supported explicitly in the method 2 and the method 3, the base station and the terminal may understand that the method 2 and the method 3 are implicitly supported. Thereafter, according to PUSCH scheduling based on a configured grant or a DCI format including PUSCH scheduling information for STxMP transmission, the amount of PUSCH resources (or TBs) that the terminal is to transmit may be identified. In this case, if there is another uplink channel overlapping scheduled PUSCHs (hereinafter, simply expressed as scheduled PUSCHs) transmitted via STxMP, the uplink channel is processed in the same way as in the method 2. Then, if UCI is multiplexed on the scheduled PUSCHs, the terminal identifies whether the resource amounts of the PUSCHs (or TBs) transmitted via respective panels are the same. If the resource amounts of the PUSCHs (or TBs) transmitted via respective panels are not the same, the UCI may be multiplexed on the PUSCH according to one of or a combination of multiple methods described below.

[Method 3-1] UCI multiplexes only on PUSCH transmitted via one panel. If the amounts of resources of two PUSCHs simultaneously transmitted via two panels are different, the terminal may select one PUSCH transmitted via one panel, multiplex UCI on the corresponding PUSCH, and transmit the UCI to the base station. In this case, in order to select one PUSCH, the terminal may consider one or multiple combinations of the following items.
Performing UCI multiplexing by selecting a PUSCH including a PRB resource of a lower or higher index (for the FDM scheme);
Performing UCI multiplexing by selecting a PUSCH including a layer of a lower or higher index (for the SDM scheme);
Comparing the amount of resources of PUSCHs transmitted via respective panels, and performing UCI multiplexing by selecting a PUSCH with a larger resource amount or a PUSCH with a smaller resource amount; and
If MCSs of PUSCHs transmitted via multiple panels are different, performing UCI multiplexing by selecting a PUSCH having a higher or lower code rate.

[Method 3-2] UCI multiplexes in the same way as in NR release 17. If the amounts of resources of two PUSCHs simultaneously transmitted in two panels are different, the terminal multiplexes UCI on the PUSCHs in the same way as in the method of multiplexing UCI up to NR release 17. That is, the UCI is multiplexed over subcarriers in the entire frequency domain and layers in the spatial domain by considering the amount of all scheduled PUSCH resources without considering resource division due to each panel transmission. In this way, if the PUSCH on which the UCI is multiplexed is transmitted using each panel, the base station may need to decode UCI information by joint-decoding each transmitted PUSCH.

[Method 3-4] In order to repeatedly multiplex UCI on PUSCHs transmitted via respective panels, the following prerequisites need to be satisfied. That is, if the terminal transmits PUSCHs in the STxMP scheme and needs to multiplex UCI on the PUSCHs, the terminal does not expect that the following conditions are not satisfied. The following is an example of conditions required to be met when PUSCHs are transmitted in the STxMP scheme and UCI is multiplexed on the PUSCHs.
If PUSCHs are transmitted in the FDM-based STxMP scheme and UCI is multiplexed on the PUSCHs, two or more even-numbered PRBs are scheduled as PUSCH resources.
If PUSCHs are transmitted in the SDM-based STxMP scheme and UCI is multiplexed on the PUSCHs, two or more even-numbered layers (or ranks) are scheduled for the PUSCHs.
If PUSCHs are transmitted in the STxMP scheme and UCI is multiplexed on the PUSCHs, scheduling is performed so that MCSs for respective PUSCH transmissions are the same.
If PUSCHs are transmitted in the STxMP scheme and UCI is multiplexed on the PUSCHs, the same number of OFDM symbols are scheduled for the PUSCHs in the time domain.

In addition to the above-described example, any additional conditions enabling the resource amounts of the PUSCHs, which are transmitted via respective panels, to be equally scheduled may be included, and the terminal may not expect that the conditions are not satisfied.

### Fourth Embodiment: Overlapping Rules for Processing Overlapping Uplink Channels when Supporting Simultaneous Uplink Transmission Using Multiple Panels

The fourth embodiment provides detailed descriptions of, when uplink channels simultaneously transmitted via multiple panels and another scheduled uplink channel overlap in the time domain, a method of determining an uplink channel for transmission, and a method of determining an uplink channel on which UCI is multiplexed.

Up to NR release 17, if a PUCCH and a PUSCH overlap in the time domain, the terminal determines an uplink channel to be transmitted according to a timeline condition and UCI multiplexed on an uplink channel, and performs uplink channel transmission according to an overlapping rule for determination of whether to multiplex UCI, which is multiplexed on an uplink channel that is not transmitted, on the uplink channel to be transmitted. Up to NR release 17, since a method of transmitting multiple uplink channels simultaneously in the time domain by using multiple panels was not supported, the overlapping rule up to NR release 17 cannot provide a method of performing UCI multiplexing and a method of determining a transmission channel by considering STxMP transmission.

Up to NR release 17, if a PUCCH is repeatedly transmitted, and the PUCCH overlaps a PUSCH in the time domain, the terminal does not transmit the PUSCH in an overlapped slot (for repeated PUSCH transmission type A) or does not perform overlapping actual repeated PUSCH transmission (for repeated PUSCH transmission type B). Similarly, since the overlapping rule between repeated PUCCH transmission and PUSCHs up to NR release 17 does not consider STxMP transmission, an operation in consideration of the STxMP transmission cannot be provided.

According to embodiment 4-1, detailed descriptions are provided for a reinforced overlapping rule which is to handle a case in which PUSCHs transmitted in the STxMP scheme using multiple panels and repeated PUCCH transmission overlap in the time domain. According to embodiment 4-2, detailed descriptions are provided for a method of, when a PUCCH and PUSCHs transmitted in the STxMP scheme overlap in the time domain, and UCI in the PUCCH is multiplexed on a PUSCH, determining the PUSCH on which the UCI is multiplexed from among the multiple PUSCHs.

### Embodiment 4-1: Reinforced Overlapping Rule to Solve a Case in which PUSCHs Transmitted in the STxMP Scheme and Repeated PUCCH Transmission Overlap in the Time Domain

In the embodiment 4-1, a terminal operation of processing a case in which PUSCHs transmitted in the STxMP scheme using multiple panels and repeated PUCCH transmission overlap in the time domain are described in greater detail below.

As described above, up to NR release 17, if a repeatedly transmitted PUCCH and a PUSCH overlap in the time domain, the terminal transmits the PUCCH and does not transmit the overlapping PUSCH regardless of the priority of UCI included in each channel. However, if the PUSCH can be transmitted simultaneously via multiple panels, and reliability is obtainable via sufficient diversity gain by enabling transmission to different TRPs, a new overlapping rule may be defined so that the terminal multiplexes UCI in the PUCCH on the PUSCH and transmits the PUSCH, instead of dropping the PUSCH and transmitting only the PUCCH. That is, for a repeatedly transmitted PUCCH and PUSCHs overlapping in the time domain, the PUSCHs being simultaneously transmitted in the STxMP scheme by using multiple panels, the terminal may simultaneously transmit the PUSCHs and may not transmit the PUCCH according to one of the following detailed methods or a combination of multiple detailed methods.

[Method 4-1-1] For a repeatedly transmitted PUCCH and PUSCHs overlapping in the time domain, the PUSCHs being simultaneously transmitted in the STxMP scheme by using multiple panels, the terminal identifies whether UCI can be multiplexed on all PUSCHs according to the amount of PUSCH resources (or TBs) transmitted via all panels, as in method 2 of the embodiment 3 described above. Then, if the UCI can be multiplexed on the PUSCHs transmitted via all panels according to method 2 of the embodiment 3, the terminal repeatedly multiplexes the UCI on the PUSCHs transmitted via all panels and does not transmit the PUCCH in the same way as in the method 2. That is, if the resource amounts of the PUSCHs transmitted via all panels are the same, the terminal repeatedly multiplexes the UCI in the PUCCH on all the PUSCHs and does not transmit the PUCCH. In this case, the UCI multiplexed on the PUSCHs may be determined in the same way as in NR release 17. That is, if no CSI information is multiplexed on the PUSCHs, the terminal may repeatedly multiplex HARQ-ACK information and CSI information included in the PUCCH on the PUSCHs transmitted via all panels. On the other hand, if CSI information is multiplexed on the PUSCHs, the terminal may repeatedly multiplex only HARQ-ACK information included in the PUCCH on the PUSCHs transmitted via all panels. Alternatively, regardless of operations in NR release 17, the terminal may repeatedly multiplex, on the PUSCHs transmitted via all panels, all UCI information except for SR information included in the PUCCH. The terminal may repeatedly apply the operation of multiplexing the UCI on the PUSCHs to all slots in which the PUCCH and the PUSCHs overlap. Alternatively, the terminal may multiplex the UCI only for a first overlapping slot, and then may perform neither UCI multiplexing nor repeated PUCCH transmission.

If the resource amounts of the PUSCHs transmitted via respective panels are not the same, the terminal may not transmit the PUSCHs simultaneously transmitted in the STxMP scheme by using multiple panels, wherein the PUSCHs and the repeatedly transmitted PUCCH overlap in the time domain. Alternatively, like multiplexing UCI on PUSCHs in NR release 17 rather than dropping the PUSCHs, the terminal may multiplex and transmit UCI over all scheduled subcarriers and all layers in consideration of all scheduled PUSCH resources without repeatedly multiplexing the UCI.

[Method 4-1-2] For a repeatedly transmitted PUCCH and PUSCHs overlapping in the time domain, the PUSCHs being simultaneously transmitted in the STxMP scheme by using multiple panels, the terminal may select one PUSCH (or multiple PUSCHs), on which UCI is to be multiplexed, from among the multiple PUSCHs, multiplex the UCI on the selected PUSCH, and may not transmit the PUCCH. Alternatively, the terminal may multiplex the UCI only for a first overlapping slot, and then may perform neither UCI multiplexing nor repeated PUCCH transmission.

The method 4-1-2 may be applied to all slots in which the PUCCH and the PUSCHs overlap during repeated transmission. In this case, a method of selecting a PUSCH on which UCI is multiplexed may be one of the methods described in greater detail below in embodiment 4-2 or a combination of multiple methods.

### Embodiment 4-2: PUSCH Selection and Multiplexing Method for Multiplexing UCI on a PUSCH when PUSCHs Transmitted in the STxMP Scheme and a PUCCH Overlap in the Time Domain

According to the embodiment 4-2, detailed descriptions are provided for a method of, when a PUCCH and PUSCHs simultaneously transmitted using multiple panels overlap in the time domain, and UCI multiplexed on the PUCCH is multiplexed on a PUSCH, selecting and multiplexing the PUSCH on which the UCI is multiplexed from among multiple simultaneously transmitted PUSCHs.

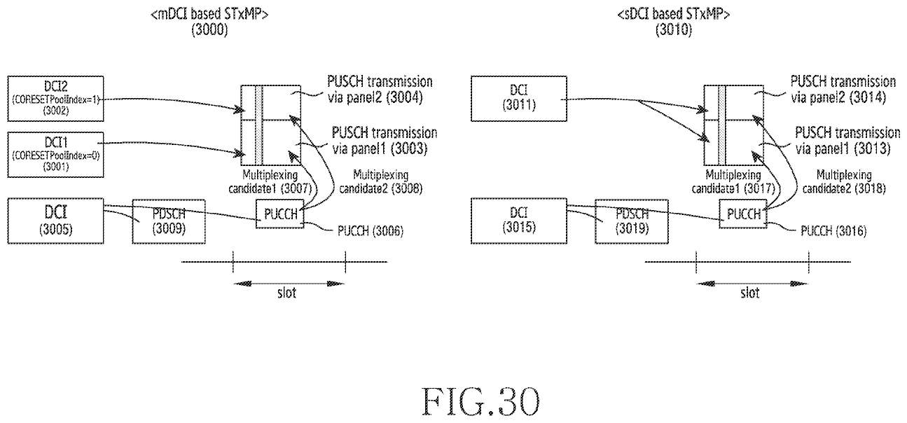

As described above, since simultaneous uplink transmission using multiple panels is not supported up to NR release 17, only one uplink channel has been allowed to be transmitted for one serving cell at one time occasion. Therefore, when a PUCCH and PUSCHs overlap, and UCI included in the PUCCH is multiplexed on the PUSCH, the terminal multiplexes the UCI on the overlapping PUSCH without a separate PUSCH selection procedure. However, if multiple PUSCHs can be simultaneously transmitted at the same time occasion by using multiple panels, the terminal may need to select a PUSCH on which the UCI is to be multiplexed from among the multiple simultaneously transmitted PUSCHs. FIG. 30 shows diagrams illustrating an example of PUSCHs simultaneously transmitted through multiple panels scheduled via multi-DCI (mDCI) or single-DCI (sDCI) and an example of scheduled PUSCHs and a PUCCH overlapping in the time domain.

If simultaneous PUSCH transmission is scheduled 3000 based on mDCI 3000, a base station may schedule, for a terminal, simultaneous PUSCH transmission 3003 and 3004 using multiple panels via multiple pieces of DCI 3001 and 3002 associated with different CORESETPoolIndex values. In addition, DCI 3005, which is received at a time satisfying a timeline condition that needs to be satisfied to apply the aforementioned overlapping rule, may be used to schedule a PDSCH 3009 and a PUCCH 3006 for HARQ-ACK transmission therefor. In this case, since the scheduled PUSCHs 3003 and 3004 and the PUCCH 3006 overlap in the time domain, the terminal may determine one PUSCH among the PUSCHs 3003 and 3004, on which UCI included in the PUCCH 3006 is to be multiplexed, by applying the overlapping rule. In this case, since the STxMP-based simultaneous transmission method is not supported up to NR release 17, in this situation, there is no rule for determining the PUSCHs 3003 and 3004 on which the UCI within the PUCCH 3006 is to be multiplexed by the terminal. Similarly, even when simultaneous PUSCH transmission is scheduled based on sDCI 3010, there is no rule for the terminal to determine a PUSCH on which UCI in a PUCCH 3016, overlapping in the time domain, is to be multiplexed from among PUSCHs 3013 and 3014 simultaneously transmitted via multiple panels.

As such, a method for determining a PUSCH on which the UCI included in the PUCCH is to be multiplexed is required. Accordingly, a PUSCH on which UCI is to be multiplexed may be determined via one of the following methods or a combination of multiple methods.
[Selection method 1] The terminal may repeatedly multiplex UCI on all simultaneously transmitted PUSCHs. In this case, the method of multiplexing UCI to all PUSCHs may be configured in the same way as the method 2 of the embodiment 3. That is, the terminal may identify whether the resource amounts (or TBs) of the simultaneously transmitted PUSCHs are the same, and if the resource amounts are the same, the UCI may be repeatedly multiplexed on all the PUSCHs as in the method 2. On the other hand, the terminal may identify whether the resource amounts (or TBs) of the simultaneously transmitted PUSCH are the same, and if the resource amounts are not the same, operations may be performed in method 3-1 or method 3-2 of method 3.
[Selection method 2] UCI may be multiplexed on a PUSCH transmitted on the same uplink transmission beam as the uplink transmission beam of the scheduled PUCCH. The uplink transmission beams of the PUCCH and PUSCH may be activated according to an integrated TCI scheme and determined based on an indicated TCI state. For multiple PUSCHs simultaneously transmitted via multiple panels, as many TCI states as the number of the simultaneously transmitted PUSCHs may be indicated. The terminal may multiplex the UCI on PUSCH transmission indicated with the same TCI state as that for the scheduled PUCCH from among the indicated multiple TCI states. Selection method 2 may be used for both a case where simultaneous transmission using multiple panels is scheduled based on mDCI and a case where simultaneous transmission using multiple panels is scheduled based on sDCI.

If the overlapping PUCCH is scheduled to be transmitted to mTRP, a PUSCH on which UCI is multiplexed may be determined or the PUCCH may be transmitted without transmitting the PUSCH according to the following methods. Here, the PUCCH being scheduled to be transmitted to mTRP may include a case where the PUCCH is also scheduled to be simultaneously transmitted using multiple panels or is scheduled to perform repeated TDM-based mTRP PUCCH transmission, and the like.
1) The terminal may repeatedly multiplex UCI on all simultaneously transmitted PUSCHs. In this case, the method of multiplexing UCI to all PUSCHs may be configured in the same way as the method 2 of the embodiment 3.
2) Performing UCI multiplexing by selecting a PUSCH including a PRB resource of a lower or higher index (for the FDM scheme)
3) Performing UCI multiplexing by selecting a PUSCH including a layer of a lower or higher index (for the SDM scheme)
4) If the PUCCH is scheduled to be transmitted to mTRP, transmitting the PUCCH without transmitting an overlapping PUSCH
[Selection method 3] The terminal may multiplex UCI in a PUCCH on a PUSCH scheduled via DCI associated with the same CORESETPoolIndex as DCI for scheduling of the PUCCH. Selection method 3 is a method available when simultaneous mDCI-based STxMP-based PUSCH transmission is scheduled. As a specific example, it is assumed that the base station schedules the PUCCH including UCI via DCI associated with a CORESET in which CORESETPoolIndex is 0 or is not configured, schedules first simultaneous PUSCH transmission via DCI associated with a CORESET in which CORESETPoolIndex is 0 or is not configured, and schedules second simultaneous PUSCH transmission via DCI associated with a CORESET in which CORESETPoolIndex is 1. In this case, if the PUCCH, the first simultaneous PUSCH transmission, and the second simultaneous PUSCH transmission overlap in the time domain, the terminal may multiplex the UCI on the first simultaneous PUSCH transmission scheduled from the CORESET having the same CORESETPoolIndex as that of the DCI for scheduling of the PUCCH. If the DCI for scheduling of the PUCCH is received from the CORESET with a CORESETPoolIndex value of 1, the terminal may multiplex the UCI on the second simultaneous PUSCH transmission instead of the first simultaneous PUSCH transmission.
[Selection method 4] The terminal may determine a PUSCH on which UCI included in a PUCCH is to be multiplexed, by referring to a field included in DCI. Here, the field in the DCI, which is referred to by the terminal to determine the PUSCH, may be a previously existing field included in the DCI up to NR release 17. As an example, if mDCI-based STxMP PUSCH transmission is scheduled, the terminal may determine a PUSCH by referring to a downlink assignment index (DAI) included in each DCI. Specifically, the terminal may compare DAIs included in multiple pieces of DCI for scheduling of PUSCHs with DAIs included in DCI for scheduling of a PDSCH and the PUCCH, so as to multiplex the UCI in the PUCCH on a PUSCH scheduled via DCI for PUSCH scheduling, which has the same DAI value.

Alternatively, the base station may add a new DCI field instead of the existing DCI field so as to indicate, to the terminal, the PUSCH on which the UCI is multiplexed. For example, if an mDCI-based STxMP PUSCH is scheduled, a new field of 1 bit may be added in each DCI. In this case, the terminal may multiplex the UCI on a PUSCH in which the bit value of the new field is configured to be “1”, and may not multiplex the UCI on a PUSCH in which the bit value of the new field is configured to be “0”. If new fields in both two pieces of DCI are configured to be “1” and the resource amounts of the two scheduled PUSCHs are the same, the terminal may repeatedly multiplex the UCI on both the PUSCHs. As another example, if sDCI-based STxMP PUSCH is scheduled, the new field of 1 bit may be added in DCI. If the bit value of the new field is “0”, the terminal may multiplex the UCI on first PUSCH transmission (alternatively, this may be replaced with an expression, such as a PUSCH transmitted via a first panel, or a PUSCH transmitted according to a first TCI state among multiple indicated TCI states based on the integrated TCI scheme) from among simultaneously transmitted PUSCHs. Similarly, if the bit value of the new field is “1”, the terminal may multiplex the UCI on second PUSCH transmission (alternatively, this may be replaced with an expression, such as a PUSCH transmitted via a second panel, or a PUSCH transmitted according to a second TCI state among multiple indicated TCI states based on the integrated TCI scheme) from among simultaneously transmitted PUSCHs. As another example, if sDCI-based STxMP PUSCH is scheduled, a new field of 2 bits may be added in DCI. If the bit value of the new field is “00”, an operation may be performed in the same way as that for the case of the bit value being “0” in the previous case where the new field is 1 bit. If the bit value of the new field is “01”, an operation may be performed in the same way as that for the case of the bit value being “1” in the previous case where the new field is 1 bit. If the bit value of the new field is “11” and the resource amounts of PUSCHs transmitted via respective panels are the same, the terminal may repeatedly multiplex the UCI on all the PUSCHs.

### Fifth Embodiment: Method of Transmitting Uplink Channels Scheduled to be Transmitted Via Different Panels

In the fifth embodiment, detailed descriptions are provided for a method in which, when different uplink channels overlapping in the time domain are scheduled to be transmitted via different panels, the terminal performs uplink transmission in consideration of the same.

Up to NR release 17, if different uplink channels overlap in the time domain for one serving cell, the terminal transmits only one uplink channel after applying an overlapping rule to solve this overlapping problem. However, if simultaneous transmission is possible using multiple panels, a method of transmitting multiple uplink channels by using multiple panels, instead of transmitting only one uplink channel, may be considered.

As in the fifth embodiment, in order to transmit different uplink channels via multiple panels, UE capability reporting may need to be performed in advance. The terminal may transmit, to the base station, a UE capability report indicating that simultaneous transmission using multiple panels is possible. In this case, the terminal may report, to the base station, that different uplink channels may be transmitted using multiple panels, via one component of the UE capability report or a separate new UE capability report. Thereafter, the base station configures a higher-layer parameter for the terminal, based on the UE capability report transmitted by the terminal. In this case, if the base station uses STxMP using multiple panels, the base station configures, for the terminal, higher-layer parameters for supporting STxMP. In this case, in order to indicate that STxMP is supported, any new higher-layer parameter (e.g., “SupportSTxMP” or any higher-layer parameter with the same/similar function) may be configured to be available (e.g., “enable”, “support”, or the like), and a higher-layer parameter (e.g., “SupportDiff_ULChannelforSTxMP” or any higher-layer parameter with the same/similar function) for supporting simultaneous transmission of different uplink channels may be additionally configured.

Then, the terminal may identify scheduled uplink channels, based on DCI for scheduling of the uplink channels (PUSCH, PUCCH, or SRS, etc.), and the terminal may identify scheduled uplink channels, based on configured higher-layer parameters for a configured grant PUSCH, a semi-persistent/periodic PUCCH, an SRS, or the like. In this case, it may be identified that multiple scheduled uplink channels overlap in the time domain. If the uplink channels do not overlap in the time domain, the terminal may transmit each uplink channel. If the uplink channels overlap in the time domain, the terminal may identify whether the uplink channels are transmitted via the same panel or transmitted via different panels. In this case, whether the uplink channels are transmitted via the same panel or transmitted via different panels may be identified by the terminal via indicated TCI states according to the integrated TCI scheme for each uplink channel. This may be based on an uplink transmission implementation method of the terminal, and therefore only the terminal may understand corresponding information.

Alternatively, the terminal may report a combination of group-based TCI state information to the base station in order to notify the base station of whether simultaneous transmission using multiple panels is possible. Alternatively, during CSI reporting, some additional information for indicating that simultaneous transmission using multiple panels is possible may be added to the CSI reporting. If it is identified that the scheduled uplink channels may be transmitted via different panels according to the uplink transmission implementation method of the terminal, the terminal may simultaneously transmit the scheduled uplink channels via respective panels.

As a specific example, the base station schedules a PUCCH for the terminal via DCI, and the PUCCH may be scheduled to be transmitted based on joint TCI state ID 1. In this case, joint TCI state ID 1 may indicate transmission via a first panel among the panels (alternatively, it may be defined to be a panel having a lower ID during panel operation of the terminal, or a panel associated with a lower SRS resource set ID if an SRS resource set is associated with transmission via respective panels). On the other hand, the PUSCH may be scheduled to be transmitted based on joint TCI state ID 2. In this case, joint TCI state ID 2 may indicate transmission via a second panel among the panels (alternatively, it may be defined to be a panel having a higher ID during panel operation of the terminal, or a panel associated with a higher SRS resource set ID if an SRS resource set is associated with transmission via respective panels). In this case, if the terminal identifies that the PUCCH and the PUSCHs may be transmitted via different panels, even if the PUCCH and the PUSCHs overlap in the same time domain, the terminal may simultaneously transmit both uplink channels by using multiple panels instead of determining one uplink channel to be transmitted, according to the overlapping rule up to NR Release 17.

If the uplink channels are scheduled to be transmitted via the same panel, the terminal may determine one uplink channel to be transmitted, may accordingly multiplex UCI and transmit the uplink channel determined to be transmitted, and may not transmit other uplink channels, according to the overlapping rule up to NR Release 17.

Some or all of the specific embodiments disclosed above may be performed in combination with some or all of one or more other embodiments.

### Sixth Embodiment: Overlapping Rules for a Case where SFN-Based STxMP PUCCH Transmission Based on Multi-Panel and PUSCH Transmission Overlap

In the sixth embodiment, detailed descriptions are provided for a method of, if time/frequency resources for PUCCH transmission in the SFN scheme via multi-panel-based simultaneous uplink transmission method overlap with time/frequency resources (especially, in time resources) for PUSCH transmission (for example, both repeated transmission or single transmission may be included), determining an uplink channel to be transmitted from among the overlapping uplinks, and performing UCI multiplexing if the UCI is multiplexed.

As described above, the same data and the same RS may be simultaneously transmitted to respective TRPs by using respective panels, via the SFN scheme from among simultaneous uplink transmission schemes using multiple panels. The SFN-based simultaneous transmission with multi-panel (STxMP) is a method for improving reliability of the uplink to be transmitted, and scheduling may be performed by considering both repeated uplink transmission and SFN-based STxMP transmission schemes or by considering only one of the two schemes. In the sixth embodiment, for convenience of description, descriptions are provided for a case where SFN-based STxMP PUCCH transmission (which may be used to express SFN PUCCH, for convenience of description) is scheduled without considering repeated PUCCH transmission up to NR Release 17, which is not the SFN-based STxMP scheme. However, the sixth embodiment may be applied not only to a corresponding scheduling environment, but also to a scheduling case in which both repeated PUCCH transmission and SFN-based STxMP transmission methods are considered via a simple extension of the schemes, or other cases.

In order to schedule SFN-based STxMP for simultaneous transmission of the same data and RS to different TRPs (or may be the same TRP) by using multiple panels, the terminal may perform UE capability reporting (UE capability report, for example, a parameter for UE reporting for a feature group such as “enable SFN PUCCH” may be configured to be an indicator, such as “enable” or “disable”, to perform reporting, or indication values for components included in the feature group may be configured and reported (e.g., the number of repeated transmissions, etc. if SFN PUCCH can be repeatedly transmitted) to report the support of the corresponding function to the base station, and the base station may configure a higher-layer parameter based on the reported UE capability. In this case, the following examples may be considered for higher-layer parameters and configured information elements (IEs) which may be considered to perform SFN-based STxMP PUCCH transmission. In this case, the terminal may identify, among the examples, that the SFN-based STxMP transmission method has been scheduled via a single candidate or a combination of multiple candidates.
“unifiedTCI-StateType-r17” (or any parameter to support an enhanced unified TCI framework of NR Release 18 scheme) is configured in “MIMOParam-r17” (or “MIMOparam-r18” for NR Release 18 or any other IE that may be associated with an unified TCI framework) within “ServingCellConfig” of a support cell (serving cell).
In order to indicate whether SFN-based STxMP is supported, a higher-layer parameter (e.g., “sfnSchemePUCCH”) is configured in “MIMOParam-r17” (or “MIMOparam-r18” for NR Release 18 or any associated higher-layer parameter) in “ServingCellConfig” of the serving cell configuration. Or,
In order to indicate whether SFN-based STxMP is supported, a higher-layer parameter (e.g., “sfnSchemePUCCH”) is configured in PUCCH configuration “PUCCH-Config”, “PUCCH-FormatConfig”, or a higher-layer parameter related to other PUCCH configurations. Or,
In order to indicate whether SFN-based STxMP is supported, a higher-layer parameter (e.g., “sfnSchemePUCCH”) is configured in the configuration for a PUCCH resource “PUCCH-Resource” or configuration for a PUCCH resource set “PUCCH-ResourceSet”

Among these configurations, the base station may configure, for the terminal, one candidate or a combination of multiple candidates, and the terminal determines whether SFN-based STxMP PUCCH transmission may be performed, based on the received higher-layer parameter. Thereafter, the terminal may or may not perform SFN-based STxMP PUCCH transmission, based on PUCCH scheduling information scheduled by the base station. For example, if a higher-layer parameter for SFN-based STxMP PUCCH transmission is configured in units of “PUCCH-Resource”, SFN-based STxMP PUCCH transmission is performed if the parameter for SFN STxMP transmission is configured (or if an indicator or indication value for supporting is configured) for a PUCCH resource indicated by DCI (or a higher-layer parameter for supporting of periodic/semi-persistent PUCCH), and SFN-based STxMP transmission is not performed if the parameter for SFN STxMP transmission is not configured (or if an indicator or indication value for not supporting is configured).

When it is assumed that the SFN-based STxMP PUCCH transmission method is not scheduled with repeated transmission, transmission is performed in different spatial domains (or may be the same or similar spatial areas if transmission is performed to a single TRP) by using only PUCCH resources in one time/frequency resource domain, in the same way as that for a previously scheduled PUCCH. Even if the SFN-based STxMP PUCCH transmission scheme uses only a single time resource area in terms of transmitting the same data and RS (for example, it may be the same in terms of generating the same information bit and the same sequence, and precoding methods of physical channels transmitted via respective panels may be the same or different. That is, the data and RS are the same in terms of information, but this indicates that a different precoding/beamforming method for each panel may be supported also by the SFN scheme in consideration of a channel condition), SFN-based STxMP PUCCH transmission may be regarded as repeated transmission (Approach 1). Alternatively, since the existing method (“nrofSlots” (NR Release 15/16) in “PUCCH-FormatConfig” for configuration per PUCCH format or “pucch-RepetitionNrofSlots” in “PUCCH-ResourceExt” (IE for additional configuration information along with “PUCCH-Resource” configuration) for configuration per PUCCH resource) of indicating repeated PUCCH transmission is not configured, or repeated transmission is not indicated, SFN-based STxMP PUSCCH transmission may not be regarded as repeated transmission (Approach Method 2). The 6-1st embodiment, which is described below, describes an overlapping rule between SFN PUCCH transmission and PUSCH transmission in an assumption of Approach 1 in which SFN-based STxMP PUCCH transmission is regarded as repeated transmission. The 6-2nd embodiment, which is described below, describes an overlapping rule between SFN PUCCH transmission and PUSCH transmission in an assumption of Approach 2 in which SFN-based STxMP PUCCH transmission is not regarded as repeated transmission. In the 6-1st embodiment and 6-2nd embodiment which are described below, it is assumed that overlapping PUCCH transmission and PUSCH transmission satisfy the overlapping rule or the timeline condition (e.g., clause 9.2.5 of standard TS 38.213) for performing UCI multiplexing. If the timeline condition cannot be satisfied for two overlapping PUCCH and PUSCH transmissions, the base station cannot be certain of how the terminal has handled uplink channel transmission. This indicates that it cannot be ensured that the terminal performs operations specified in the standards or according to the embodiments disclosed herein.

### 6-1st Embodiment: Overlapping Rules Between SFN PUCCH Transmission and PUSCH Transmission when SFN-Based STxMP PUCCH Transmission is Regarded as Repeated Transmission

In the embodiment 6-1, descriptions are provided for a handling method between SFN PUCCH and PUSCH overlapping in the time domain (additionally, the SFN PUCCH and PUSCH may overlap in the frequency domain) when the SFN PUCCH transmission method is regarded as a scheme of repeated PUCCH transmission (or may be interpreted as a case where SFN PUCCH transmission is considered to have the same priority as repeated PUCCH transmission).

Up to NR Release 16/17, the terminal may not transmit a PUSCH in a slot where repeated PUCCH transmission and the PUSCH (corresponding to both single transmission or repeated transmission) overlap (for PUSCH for performing TB processing (TBoMS) over multiple slots or PUSCH repetition type A), or may not transmit actual PUSCH repetition overlapping in the slot (for PUSCH performing PUSCH repetition type B). If the SFN PUCCH transmission method is also regarded as the same as repeated PUCCH transmission or has the same priority as the repeated PUCCH transmission, the overlapping PUSCH may be handled in the same way as the repeated PUCCH transmission. That is, for the SFN PUCCH and the overlapping PUSCH, the terminal may not transmit the overlapping PUSCH in the slot (for PUSCH for performing TB processing (TBoMS) over multiple slots or PUSCH repetition type A), or may not transmit overlapping actual PUSCH repetition in the slot (for PUSCH performing PUSCH repetition type B). Based on this, repeated PUCCH transmission or overlapping SFN PUCCH and PUSCH, and handling methods for the same may be defined as follows:
If the terminal transmits the PUCCH over a first number N_{PUCCH}^{repeat} of slots (in this case, N_{PUCCH}^{repeat} is a value greater than 1, N_{PUCCH}^{repeat}>1) for one PUCCH, or the terminal transmits the PUCCH by the SFN-based STxMP method for one PUCCH (here, examples of candidates for supporting and scheduling the SFN PUCCH above may be considered, and as an example, a case where higher-layer parameter “sfnSchemePUCCH” is configured may be considered. Alternatively, as an example, the terminal may consider a case where higher-layer parameter “sfnSchemePUCCH” is configured for PUCCH resources scheduled via DCI (or a higher-layer parameter configuration for periodic/semi-persistent PUCCH transmission)), the PUSCH needs to be transmitted via TB processing (TBoMS) over multiple slots or repetition type A over a second number of slots, the PUCCH transmission overlaps with the PUSCH transmission in one or multiple slots, and the conditions in clause 9.2.5 of standard TS 38.213 for multiplexing UCI on PUSCH are satisfied for overlapping slot(s), then the terminal transmits the PUCCH and does not transmit the PUSCH in the overlapping slot(s).
If the terminal transmits the PUCCH over a first number N_{PUCCH}^{repeat} of slots (in this case, N_{PUCCH}^{repeat} is a value greater than 1, N_{PUCCH}^{repeat}>1) for one PUCCH, or the terminal transmits the PUCCH by the SFN-based STxMP method for one PUCCH (here, examples of candidates for supporting and scheduling the SFN PUCCH above may be considered, and as an example, a case where higher-layer parameter “sfnSchemePUCCH” is configured may be considered. Alternatively, as an example, the terminal may consider a case where higher-layer parameter “sfnSchemePUCCH” is configured for PUCCH resources scheduled via DCI (or a higher-layer parameter configuration for periodic/semi-persistent PUCCH transmission)), the terminal needs to transmit the PUSCH via repetition type B over a second number of slots, the PUCCH transmission overlaps with actual PUSCH repetition in one or multiple slots, and the conditions in clause 9.2.5 of standard TS 38.213 for multiplexing UCI on PUSCH are satisfied for overlapping slot(s), then the terminal transmits the PUCCH and does not transmit overlapping actual PUSCH repetition(s).

### 6-2nd Embodiment: Overlapping Rules Between SFN PUCCH Transmission and PUSCH Transmission when SFN-Based STxMP PUCCH Transmission is not Regarded as Repeated Transmission

In the 6-2nd embodiment, descriptions are provided for a handling method between SFN PUCCH and PUSCH overlapping in the time domain (additionally, the SFN PUCCH and PUSCH may overlap in the frequency domain) when the SFN PUCCH transmission method is not regarded as repeated PUCCH transmission or does not have the same priority as repeated PUCCH transmission.

Unlike the 6-1st embodiment, since SFN PUCCH transmission uses only one time resource, the corresponding method may not be regarded as repeated PUCCH transmission (if repeated PUCCH transmission in the time domain is not supported at the same time in addition to SFN PUCCH). In this way, if the SFN PUCCH transmission scheme is not regarded as repeated PUCCH transmission, transmission of the SFN PUCCH may be determined according to an overlapping rule in consideration of a PUSCH overlapping in the time domain in the same manner as non-repeated PUCCH transmission. Alternatively, in consideration of the purpose of the SFN PUCCH and features of transmission to multiple TRPs, an uplink channel to be transmitted and whether to multiplex UCI may be determined by considering an additional rule in addition to the overlapping rule between non-repeated PUCCH transmission and the PUSCH overlapping in the time domain up to NR Release 17. Specifically, in order to determine an uplink channel to be transmitted and whether to multiplex UCI or a method of multiplexing UCI according to a case where the SFN PUCCH and the PUSCH overlap, one of the following methods or a combination of multiple methods may be considered. Here, it is assumed that the overlapping SFN PUCCH and PUSCH have the same priority index.

(Method 1: UCI in an SFN PUCCH May be Multiplexed on an Overlapping PUSCH in the Time Domain):

In the method 1, an uplink channel to be transmitted and whether to multiplex UCI may be determined in the same manner as (or similar manner to) the case where the PUSCH and PUCCH defined in NR Release 17 overlap in the time domain. For example, if a PUCCH including UCI overlaps with a PUSCH in the time domain, and conditions (e.g., the conditions specified in clause 9.2.5 of standard TS 38.213) for UCI multiplexing are satisfied, the terminal may determine, depending on whether an aperiodic or semi-persistent CSI report is multiplexed within the overlapping PUSCH, whether to multiplex, on the overlapping PUSCH, only HARQ-ACK in the UCI included in the PUCCH, or whether to multiplex, on the PUSCH, the HARQ-ACK and CSI report in the UCI included in the PUCCH. If the aperiodic or semi-persistent CSI report is multiplexed within the overlapping PUSCH, the terminal transmits the PUSCH by multiplexing only HARQ-ACK in the UCI included in the PUCCH on the overlapping PUSCH, and does not transmit the PUCCH. If the aperiodic or semi-persistent CSI report is not multiplexed within the overlapping PUSCH, the terminal transmits the PUSCH by multiplexing, on the PUSCH, the HARQ-ACK and CSI report in the UCI included in the PUCCH, and does not transmit the PUCCH. In this case, the overlapping PUSCH may be the PUSCH defined up to NR Release 17 or may be the PUSCH (may include, for example, repeated mTRP TDMed PUSCH transmission based on a unified TCI framework, an SDM PUSCH supporting simultaneous uplink transmission based on multiple panels, an SFN PUSCH supporting simultaneous uplink transmission based on multiple panels, or the like) defined in NR Release 18. In PUSCH transmission methods other than the multi-panel based SFN PUSCH, the UCI in the SFN PUCCH may be multiplexed on the overlapping PUSCH according to the same UCI multiplexing rule as that defined in the existing NR Release 17. For the multi-panel-based SFN PUSCH transmission method, the UCI included in the PUCCH is repeatedly multiplexed on the same TB transmitted via two panels, and the PUSCH may be rate matched in consideration thereof. That is, the UCI included in the SFN PUCCH may be multiplexed on a PUSCH transmitted via a first panel, and the UCI included in the SFN PUCCH may also be multiplexed on a PUSCH transmitted via a second panel in the same manner (in this case, the multiplexed UCI may be channel-encoded in the same way as the UCI transmitted via the first panel. Alternatively, the same information bit is transmitted, but encoding may be performed differently). As another method, the terminal may multiplex the UCI included in the SFN PUCCH on the PUSCH transmitted via the first panel, and may not multiplex the UCI included in the SFN PUCCH on the PUSCH transmitted via the second panel. As another method, the terminal may multiplex the UCI included in the SFN PUCCH over the entire SFN PUSCH transmission performed via the first panel and the second panel. In this case, some of all UCI bits may be transmitted via the first panel, and the remaining bits may be transmitted via the second panel. Specifically, the terminal may divide all UCI bits into the same number of information bits and transmit the same on the PUSCH transmitted via each panel, or may divide all UCI bits into the same number of information bits or into the different numbers of information bits by referring to a certain value (e.g., a beta offset value configured (or two SRS resource sets in which usage associated with the PUSCH is configured to be “codebook” or “nonCodebook”) for each panel, etc. may be considered) configured via a higher-layer parameter so as to transmit the same. As another method, the terminal may perform multiplexing on the overlapping PUSCH in consideration of all transmitted PUSCH resources in the same manner as defined in NR Release 17.

As another method of using the method 1, different UCI multiplexing methods may be applied depending on whether the PUSCH overlapping with the SFN PUCCH is transmitted based on a single TRP or multiple TRPs. For example, if the PUSCH overlapping with the SFN PUCCH is transmitted to a single TRP (including both repeated transmission or single transmission) and the conditions for UCI multiplexing are satisfied, the terminal may multiplex the UCI in the SFN PUCCH on the PUSCH by the same UCI multiplexing method as in NR Release 17. If the PUSCH overlapping with the SFN PUCCH is transmitted to multiple TRPs, and the conditions for UCI multiplexing are satisfied, the terminal may repeatedly multiplex the UCI on first PUSCH transmission transmitted to each TRP. In this case, additionally, only when the number of symbols of a first PUSCH transmitted (or transmitted in association with a first SRS resource set (or SRS resource set having an SRS resource set ID with a small value) among SRS resource sets in which usage is “codebook” or “nonCodebook”) to a first TRP and the number of symbols of the first PUSCH transmitted (or transmitted in association with a second SRS resource set (or SRS resource set having an SRS resource set ID with a large value) among the SRS resource sets in which usage is “codebook” or “nonCodebook”) to a second TRP are the same, the UCI may be repeatedly multiplexed, and if the condition for the same number of symbols cannot be satisfied, the UCI may be multiplexed only on the first PUSCH transmitted to the first TRP.

(Method 2: Depending on a PUSCH Transmission Method, UCI in an SFN PUCCH May be Selectively Multiplexed on an Overlapping PUSCH in the Time Domain):

In the method 2, an uplink channel to be transmitted and whether to perform UCI multiplexing may be determined in a similar way to the method 1, but a PUSCH transmission method may be additionally considered. Although an SFN PUCCH is not regarded as repeated PUCCH transmission, since the SFN PUCCH transmission method is a method for improving reliability of a PUCCH, taking this into account, an overlapping rule allowing UCI multiplexing only on a PUSCH transmitted by a specific PUSCH transmission method capable of improving reliability may be added. That is, when the terminal identifies that the SFN PUCCH is scheduled, and a PUSCH overlapping with the SFN PUCCH in the time domain is scheduled, the terminal may additionally identify a transmission scheme of the overlapping PUSCH along with rules up to NR Release 17 for multiplexing UCI in the PUCCH, and then may determine whether to multiplex the UCI in the SFN PUCCH on the overlapping PUSCH, may transmit the PUSCH on which the UCI is multiplexed, and may not transmit the PUCCH, or the terminal may not be able to multiplex the UCI on the PUSCH, may transmit the SFN PUCCH, and may not transmit the PUSCH.

A specific example of the conditions additionally identified by the terminal according to Method 2 may be as follows. As a specific example, if the PUSCH overlapping with the SFN PUCCH corresponds to a transmission method for improving reliability (for example, the PUSCH transmission method for improving reliability may include repeated single-TRP TDM PUSCH transmission based on NR Release 17 (or 18), repeated multi-TRP TDM PUSCH transmission based on NR Release 17 (or 18), an SFN PUSCH supporting simultaneous uplink transmission based on multiple panels, or the like), the terminal may multiplex the UCI in the SFN PUCCH on the overlapping PUSCH and then (as described above, if the conditions for UCI multiplexing specified in the standards are also satisfied) transmit the PUSCH without transmitting the SFN PUCCH. In this case, as a specific method of multiplexing the UCI on the PUSCH, as in some of the methods described in Method 1, with respect to the multi-panel-based SFN PUSCH transmission method, the UCI included in the PUCCH is repeatedly multiplexed on the same TB transmitted via two panels, and the PUSCH may be rate matched in consideration thereof. Alternatively, for a PUSCH repeatedly transmitted via TDM, a method of multiplexing UCI on all repeated transmissions may be supported. Alternatively, repeated single-TRP PUSCH transmission as in NR Release 17 may include multiplexing the UCI in the SFN PUCCH only on a first slot among overlapping slots or on earliest actual repeated PUSCH transmission among overlapping actual PUSCHs. Alternatively, repeated multi-TRP PUSCH transmission as in NR Release 17 (or 18) may include multiplexing the UCI in the SFN PUCCH only on earliest actual repeated PUSCH transmission among overlapping actual PUSCHs or overlapping slots, or may multiplex the UCI in the SFN PUCCH on first repeated transmission to each TRP. In this case, the UCI may be multiplexed on multiple PUSCHs transmitted to respective TRPs only when the numbers of symbols of first repeatedly transmitted PUSCHs transmitted to respective TRPs are the same, and if the numbers of the symbols are not the same, the UCI may be multiplexed only on first repeated PUSCH transmission (alternatively, even if the condition for the same number of symbols is not satisfied, the UCI may be multiplexed on the first PUSCH transmitted to each TRP).

Unlike the description in Method 2, if the PUSCH overlapping with the SFN PUCCH does not correspond to a method of improving reliability (as described above, repeated single- or multi-TRP-based TDM PUSCH transmission, an SFN PUSCH, or the like), the terminal may transmit the SFN PUCCH without transmitting the PUSCH.

(Method 3: An Uplink Channel to be Transmitted May be Determined and UCI May be Multiplexed According to a New DCI Area, in Scheduling DCI, for Indicating UCI Multiplexing.)

When a PUCCH overlaps with another PUSCH in the time domain, according to the method 3, a new DCI field may be added in DCI (e.g., DCI format 1_1 or DCI format 1_2) for scheduling of an SFN PUCCH, so as to indicate whether to multiplex UCI on the overlapping PUSCH or to transmit only the SFN PUCCH without transmitting the overlapping PUSCH. For example, a bit configuration of the new DCI field may include N bits (e.g., 1 bit). If N=1, the base station may indicate, to the terminal via the new DCI field, whether to multiplex UCI in the SFN PUCCH on the overlapping PUSCH (e.g., configuring a value of the DCI field to be “1”) or whether to transmit only the SFN PUCCH without multiplexing on the overlapping PUSCH and without transmitting the overlapping PUSCH (e.g., configuring the value of the DCI field to be “0”). As another example, a new DCI field may be added in DCI (e.g., DCI format 0_1 or DCI format 0_2) for scheduling of the PUSCH overlapping with the SFN PUCCH, rather than DCI for scheduling of the SFN PUCCH, so as to indicate whether to multiplex the UCI on the overlapping PUSCH, or (if overlapping with the SFN PUCCH) whether to transmit only the SFN PUCCH without transmitting the overlapping PUSCH. Alternatively, a new DCI field may be added in DCI (e.g., DCI format 0_1 or DCI format 0_2) for scheduling of the PUSCH overlapping with the SFN PUCCH, rather than DCI for scheduling of the SFN PUCCH, so as to indicate whether to multiplex the UCI on the overlapping PUSCH, or (if overlapping with the SFN PUCCH) whether to transmit only the scheduled PUSCH without transmitting the overlapping SFN PUCCH.

(Method 4: An Uplink Channel to be Transmitted May be Determined and UCI May be Multiplexed According to a New Higher-Layer Parameter (RRC Parameter) for Indicating UCI Multiplexing.)

In the method 4, an RRC parameter for the same indication as that described in Method 3 may be added in an RRC configuration (eh PUCCH-Config, PUCCH-Resource, or the like) related to an SFN PUCCH. For example, the base station may configure, for the terminal, a new RRC parameter (which may be, for example, “enableMultplexingInPUSCH” or a similar RRC parameter with a different name) or configure an indication value (e.g., “enable”, “true”, “1”, or the like) indicating that multiplexing on an overlapping PUSCH is possible, for the terminal via a value for a corresponding RRC parameter. If the parameter is configured, the terminal may multiplex UCI in an SFN PUCCH on an overlapping PUSCH, and if the parameter is not configured, the terminal may transmit only the SFN PUCCH without multiplexing on the overlapping PUSCH and without transmitting the overlapping PUSCH (or may transmit only the PUSCH without transmitting the SFN PUCCH).

(Method 5: The Terminal May Determine an Uplink Channel to be Transmitted and Multiplex UCI According to a Sequence of Received Scheduling DCI.)

According to the method 5, based on a time point at which reception of DCI (hereinafter, DCI1) for scheduling of an SFN PUCCH and DCI (hereinafter, DCI2 or second DCI) for scheduling of a PUSCH overlapping with the SFN PUCCH is completed, the terminal may determine whether to multiplex UCI in the SFN PUCCH on the overlapping PUSCH or whether to transmit only one uplink channel. For example, if the DCI for scheduling of the SFN PUCCH is received later than the DCI for scheduling of the overlapping PUSCH (in this case, it is assumed that the conditions for UCI multiplexing are satisfied, and it is also assumed that the conditions for UCI multiplexing are satisfied in all cases described below), SFN PUCCH transmission is prioritized, and therefore the terminal may transmit only the SFN PUCCH without performing UCI multiplexing. If the DCI for scheduling of the overlapping PUSCH is received later than the DCI for scheduling of the SFN PUCCH, PUSCH transmission is prioritized, and therefore the terminal may transmit only the PUSCH without multiplexing the UCI. Alternatively, if the DCI for scheduling of the overlapping PUSCH is received later than the DCI for scheduling of the SFN PUCCH, and PUSCH transmission is thus prioritized, but if the UCI in the SFN PUCCH is able to be multiplexed on the PUSCH, the terminal may multiplex the UCI in the SFN PUCCH on the PUSCH and may transmit only the PUSCH.

Alternatively, an example is provided in which an uplink channel scheduled with DCI received later is transmitted, but an uplink channel scheduled with DCI received earlier may be transmitted, instead of a case where an uplink channel scheduled with a DCI received later is transmitted. For example, if the DCI for scheduling of the SFN PUCCH is received later than the DCI for scheduling of the overlapping PUSCH, PUSCH transmission is prioritized, and therefore the terminal may transmit only the PUSCH without multiplexing the UCI. Alternatively, if the DCI for scheduling of the SFN PUCCH is received later than the DCI for scheduling of the overlapping PUSCH, and PUSCH transmission is thus prioritized, but if the UCI in the SFN PUCCH is able to be multiplexed on the PUSCH, the terminal may multiplex the UCI in the SFN PUCCH on the overlapping PUSCH and may transmit only the PUSCH. If the DCI for scheduling of the overlapping PUSCH is received later than the DCI for scheduling of the SFN PUCCH, SFN PUCCH transmission is prioritized, and therefore the terminal may transmit only the SFN PUCCH without performing UCI multiplexing.

Alternatively, for semi-persistent or configured grant-based transmission, whether to perform UCI multiplexing or whether to transmit only one uplink channel without performing UCI multiplexing may be determined by a method (applying by substituting described time points for the DCI reception time points) similar to the above method described based on the DCI reception time points from a specific time point (e.g., for the PUCCH, a point in time at which SPS PDSCH reception is completed or a time point after T_{proc,1}^{mux} from the point in time at which reception is completed, and for the PUSCH, a first transmission symbol of transmission occasion i, or processing time T_{proc,2}^{mux} from the first transmission symbol) for determination of whether to perform scheduling based on corresponding transmission occasion i.

(Method 6: An Uplink Channel to be Transmitted May be Determined and UCI May be Multiplexed According to an Uplink Channel Scheduling Method.)

In the method 6, if a PUSCH overlapping with an SFN PUCCH operates in an operation method (aperiodic, semi-persistent, or periodic) in a different time domain, the priority is defined in a sequence of aperiodic->semi-persistent->periodic, and based on this, whether to perform UCI multiplexing or whether to transmit only one uplink channel without performing UCI multiplexing may be determined. For example, if a time domain operation of the SFN PUCCH is aperiodic, and a time domain operation of the overlapping PUSCH is semi-persistent (or configured grant Type2), SFN PUCCH transmission is prioritized, and thus the terminal may transmit only the SFN PUCCH without performing UCI multiplexing. Similarly, if the time domain operation of the SFN PUCCH is semi-persistent, and the time domain operation of the overlapping PUSCH is aperiodic, PUSCH transmission is prioritized, and thus the terminal may transmit only the PUSCH without multiplexing UCI. Alternatively, if the time domain operation of the SFN PUCCH is semi-persistent, and the time domain operation of the overlapping PUSCH is aperiodic, so that PUSCH transmission is prioritized, but if UCI in the SFN PUCCH is able to be multiplexed on the PUSCH, the terminal may multiplex the UCI in the SFN PUCCH on the overlapping PUSCH, and may transmit only the PUSCH.

If the SFN PUCCH and the PUSCH overlapping in the time domain have different priority indexes, an uplink channel to be transmitted and whether to perform UCI multiplexing/a method of performing UCI multiplexing may be determined by considering one of or a combination of a plurality of the following items. Similarly, it is assumed that both uplink channels satisfy the conditions for UCI multiplexing.
When the SFN PUCCH has a higher priority index than the overlapping PUSCH, SFN PUCCH transmission is prioritized, and only the SFN PUCCH may be transmitted without performing UCI multiplexing.
When the SFN PUCCH has a lower priority index than the overlapping PUSCH, PUSCH transmission is prioritized, and only the PUSCH may be transmitted without performing UCI multiplexing.
Since the SFN PUCCH has a lower priority index than the overlapping PUSCH, PUSCH transmission is prioritized, but if UCI in the SFN PUCCH is able to be multiplexed on the PUSCH, the UCI in the SFN PUCCH may be multiplexed on the overlapping PUSCH, and only the PUSCH may be transmitted.

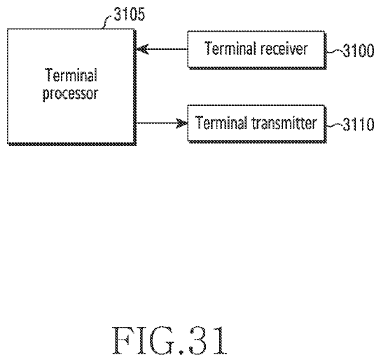

FIG. 31 is a diagram illustrating a structure of a terminal in the wireless communication system, according to an embodiment.

Referring to FIG. 31, a terminal may include a transceiver which refers to a terminal receiver 3100 and a terminal transmitter 3110, a memory, and a terminal processor 3105 (or a terminal controller or processor). According to the communication method of the terminal described above, the transceiver 3100 or 3110, the memory, and the terminal processor 3105 of the terminal may operate. However, the elements of the terminal are not limited to the aforementioned examples. For example, the terminal may include more or fewer elements compared to the aforementioned elements. In addition, the transceiver, the memory, and the processor may be implemented in the form of one chip.

The transceiver may transmit a signal to or receive a signal from a base station. Here, the signal may include control information and data. To this end, the transceiver may include an RF transmitter configured to perform up-conversion and amplification of a frequency of a transmitted signal, an RF receiver configured to perform low-noise amplification of a received signal and down-conversion of a frequency, and the like. However, this is only an embodiment of the transceiver, and the elements of the transceiver are not limited to the RF transmitter and the RF receiver.

In addition, the transceiver may receive a signal via a radio channel and output the signal to the terminal processor 3105, and may transmit, via a radio channel, a signal output from the terminal processor 3105.

The memory may store a program and data necessary for operation of the terminal. The memory may store control information or data included in a signal transmitted or received by the terminal. The memory may include a storage medium or a combination of storage media, such as ROM, RAM, a hard disk, a CD-ROM, and a DVD. There may be multiple memories.

In addition, the terminal processor 3105 may control a series of procedures so that the terminal is able to operate according to the aforementioned embodiments. For example, the processor may receive DCI including two layers and control the elements of the terminal to simultaneously transmit multiple PUSCHs. There may be multiple processors, and the processors may control the elements of the terminal by executing programs stored in the memory.

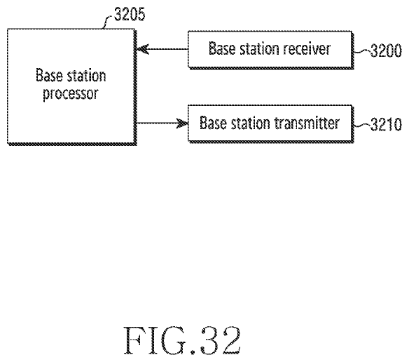

FIG. 32 is a diagram illustrating a structure of a base station in the wireless communication system, according to an embodiment. A base station of FIG. 32 may refer to a specific TRP described above.

Referring to FIG. 32, a base station may include a transceiver, which refers to a base station receiver 3200 and a base station transmitter 3210, a memory, and a base station processor 3205 (or a base station controller or processor). According to the communication method of the base station described above, the transceiver 3200 or 3210, the memory, and the base station processor 3205 of the base station may operate. However, the elements of the base station are not limited to the above examples. For example, the base station may include more or fewer elements compared to the aforementioned elements. In addition, the transceiver, the memory, and the processor may be implemented in the form of one chip.

The transceiver may transmit a signal to or receive a signal from a terminal. Here, the signal may include control information and data. To this end, the transceiver may include an RF transmitter configured to perform up-conversion and amplification of a frequency of a transmitted signal, an RF receiver configured to perform low-noise amplification of a received signal and down-conversion of a frequency, and the like. However, this is only an embodiment of the transceiver, and the elements of the transceiver are not limited to the RF transmitter and the RF receiver.

Further, the transceiver may receive a signal via a radio channel, may output the signal to the base station processor 3205, and may transmit the signal output from the base station processor 3205 via the radio channel.

The memory may store a program and data necessary for operation of the base station. The memory may store control information or data included in a signal transmitted or received by the base station. The memory may include a storage medium or a combination of storage media, such as ROM, RAM, a hard disk, a CD-ROM, and a DVD. There may be multiple memories.

The processor may control a series of procedures so that the base station operates according to the aforementioned embodiments of the disclosure. For example, the processor may configure DCI of two layers including allocation information for multiple PUSCHs, and may control each element of the base station to transmit the DCI. There may be multiple processors, and the processors may control the elements of the base station by executing programs stored in the memory.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other systems such as TDD LTE, 5G, and NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

Various embodiments of the disclosure have been described above. The above description of the disclosure is merely for the purpose of illustration, and embodiments of the disclosure are not limited to the embodiments set forth herein. Those skilled in the art will appreciate that other particular modifications and changes may be easily made without departing from the technical idea or the essential features of the disclosure. The scope of the disclosure should be determined not by the above description but by the appended claims, and all modifications or changes derived from the meaning and scope of the claims and equivalent concepts thereof shall be construed as falling within the scope of the disclosure.

What is claimed is:

1. A method performed by a terminal in a wireless communication system, the method comprising:
receiving first downlink control information (DCI);
identifying a first physical uplink shared channel (PUSCH) based on the first DCI;
receiving a second DCI;
identifying a second PUSCH based on the second DCI;
receiving a third DCI;
identifying a physical uplink control channel (PUCCH) for hybrid automatic repeat request acknowledgement (HARQ-ACK) information based on the third DCI, wherein the PUCCH overlap with the first PUSCH and the second PUSCH; and
in case that simultaneous transmissions across multi panels (STxMP) are enabled, identifying a PUSCH, among the first PUSCH and the second PUSCH, for multiplexing uplink control information (UCI) including the HARQ-ACK information,
wherein the PUSCH and the PUCCH are associated with same control resource set (CORESET).

2. The method of claim 1, wherein the first DCI is associated with a first CORESET pool index, and the second DCI is associated with a second CORESET pool index different from the first CORESET pool index.

3. The method of claim 1, wherein the HARQ-ACK information is for a physical downlink shared channel (PDSCH) scheduled by the third DCI.

4. The method of claim 1, wherein a beta offset for STxMP is applied for the PUSCH multiplexed with the UCI, and the beta offset for STxMP is different from a beta offset for UCI.

5. The method of claim 1, wherein, in case that the PUCCH is based on a single frequency network (SFN) scheme:
the PUCCH is considered as a PUCCH repetition and the first PUSCH and the second PUSCH are dropped; or
the PUCCH is not considered as the PUCCH repetition and the UCI is multiplexed in the PUSCH.

6. A method performed by a base station in a wireless communication system, the method comprising:
transmitting first downlink control information (DCI) for a first physical uplink shared channel (PUSCH);
transmitting a second DCI for a second PUSCH;
transmitting a third DCI for a physical uplink control channel (PUCCH) for hybrid automatic repeat request acknowledgement (HARQ-ACK) information, wherein the PUCCH overlap with the first PUSCH and the second PUSCH; and
in case that simultaneous transmissions across multi panels (STxMP) are enabled, receiving a PUSCH, among the first PUSCH and the second PUSCH, to which uplink control information (UCI) including the HARQ-ACK information is multiplexed,
wherein the PUSCH and the PUCCH are associated with same control resource set (CORESET).

7. The method of claim 6, wherein the first DCI is associated with a first CORESET pool index, and the second DCI is associated with a second CORESET pool index different from the first CORESET pool index.

8. The method of claim 6, wherein the HARQ-ACK information is for a physical downlink shared channel (PDSCH) scheduled by the third DCI.

9. The method of claim 6, wherein a beta offset for STxMP is applied for the PUSCH multiplexed with the UCI, and the beta offset for STxMP is different from a beta offset for UCI.

10. The method of claim 6, wherein, in case that the PUCCH is based on a single frequency network (SFN) scheme:
the PUCCH is considered as a PUCCH repetition and the first PUSCH and the second PUSCH are dropped; or
the PUCCH is not considered as the PUCCH repetition and the UCI is multiplexed in the PUSCH.

11. A terminal in a wireless communication system, the terminal comprising:
a transceiver; and
a controller coupled with the transceiver and configured to:
receive first downlink control information (DCI),
identify a first physical uplink shared channel (PUSCH) based on the first DCI,
receive a second DCI,
identify a second PUSCH based on the second DCI,
receive a third DCI,
identify a physical uplink control channel (PUCCH) for hybrid automatic repeat request acknowledgement (HARQ-ACK) information based on the third DCI, wherein the PUCCH overlap with the first PUSCH and the second PUSCH, and
in case that simultaneous transmissions across multi panels (STxMP) are enabled, identify a PUSCH, among the first PUSCH and the second PUSCH, for multiplexing uplink control information (UCI) including the HARQ-ACK information,
wherein the PUSCH and the PUCCH are associated with same control resource set (CORESET).

12. The terminal of claim 11, wherein the first DCI is associated with a first CORESET pool index, and the second DCI is associated with a second CORESET pool index different from the first CORESET pool index.

13. The terminal of claim 11, wherein the HARQ-ACK information is for a physical downlink shared channel (PDSCH) scheduled by the third DCI.

14. The terminal of claim 11, wherein a beta offset for STxMP is applied for the PUSCH multiplexed with the UCI, and the beta offset for STxMP is different from a beta offset for UCI.

15. The terminal of claim 11, wherein, in case that the PUCCH is based on a single frequency network (SFN) scheme:
the PUCCH is considered as a PUCCH repetition and the first PUSCH and the second PUSCH are dropped; or
the PUCCH is not considered as the PUCCH repetition and the UCI is multiplexed in the PUSCH.

16. Abase station in a wireless communication system, the base station comprising:
a transceiver; and
a controller coupled with the transceiver and configured to:
transmit first downlink control information (DCI) for a first physical uplink shared channel (PUSCH),
transmit a second DCI for a second PUSCH,
transmit a third DCI for a physical uplink control channel (PUCCH) for hybrid automatic repeat request acknowledgement (HARQ-ACK) information, wherein the PUCCH overlap with the first PUSCH and the second PUSCH, and
in case that simultaneous transmissions across multi panels (STxMP) are enabled, receive a PUSCH, among the first PUSCH and the second PUSCH, to which uplink control information (UCI) including the HARQ-ACK information is multiplexed,
wherein the PUSCH and the PUCCH are associated with same control resource set (CORESET).

17. The base station of claim 16, wherein the first DCI is associated with a first CORESET pool index, and the second DCI is associated with a second CORESET pool index different from the first CORESET pool index.

18. The base station of claim 16, wherein the HARQ-ACK information is for a physical downlink shared channel (PDSCH) scheduled by the third DCI.

19. The base station of claim 16, wherein a beta offset for STxMP is applied for the PUSCH multiplexed with the UCI, and the beta offset for STxMP is different from a beta offset for UCI.

20. The base station of claim 16, wherein, in case that the PUCCH is based on a single frequency network (SFN) scheme:
the PUCCH is considered as a PUCCH repetition and the first PUSCH and the second PUSCH are dropped; or
the PUCCH is not considered as the PUCCH repetition and the UCI is multiplexed in the PUSCH.
